(19) United States
(12) Patent Application Publication
(10) Pub. No.: US 2016/0321594 A1
(43) Pub. Date: Nov. 3, 2016

(54) CORRELATION BETWEEN MANUFACTURING SEGMENT AND END- USER DEVICE PERFORMANCE

(71) Applicant: Optimal Plus Ltd., Holon (IL)

(72) Inventors: Reed LINDE, El Dorado Hills, CA (US); Michael SCHULDENFREI, Petach Tikva (IL); Dan GLOTTER, Moshav Shadma (IL); Bruce Alan Phillips, Jerusalem (IL)

(21) Appl. No.: 14/810,849

(22) Filed: Jul. 28, 2015

Related U.S. Application Data
(60) Provisional application No. 62/154,842, filed on Apr. 30, 2015.

(51) Int. Cl. G06Q 10/06

(52) U.S. Cl. CPC G06Q 10/06395

(57) ABSTRACT

Disclosed are methods, systems and computer program products for concluding whether or not there is a correlation between a set of manufacturing condition(s) and performance of in-field end user devices. Also disclosed are methods, systems and computer program products for concluding whether or not there is an inconsistency in in-field end user devices data and/or manufacturing data associated with electronic elements included in end-user devices. In one example, a method includes analyzing received in-field data and/or data computed based on received in-field data, in order to determine whether or not there is a statistically significant difference in in-field performance between end-user devices including elements from a first population and end-user devices including elements from a second population, where manufacturing of the first population corresponds to a set of one or more manufacturing conditions, but manufacturing of the second population does not correspond to the set.

### CROSS REFERENCE TO RELATED APPLICATIONS

This application claims the benefit of U.S. Provisional Application No. 62/154,842 filed Apr. 30, 2015, which is hereby incorporated by reference herein.

### TECHNICAL FIELD

The disclosure relates to the field of electronics.

### BACKGROUND

As the cost of electronics has decreased, and the performance and capabilities of electronic modules and components have increased, the integration of electronics in some form in end-user devices has become routine. From the simplest to the most sophisticated manufactured end-user devices, it is now commonplace to find a complex hierarchy of electronic modules and components within, supporting various device functions, usually hidden from view of the end-user of the device but whose reliability is critically important to end-user satisfaction. As such, the reliability of the electronic modules and components within an end-user device is key to the reliability of the device itself.

In fact, the failure of many types of manufactured end-user devices containing electronics may have dire consequences, possibly even jeopardizing the safety or security of the end-user. End-user devices produced by automotive, aeronautics, and medical device manufacturers are prime examples of this. For such end-user devices, even a relatively small number of failures may have huge direct impact on the safety or health of end-users, and therefore, constitute a business concern to manufacturers due to the risk of financial and public relations problems related to device recalls and/or lawsuits. An example found in a Reuter's news report from Jan. 30, 2013 describes a recall of 1.3 million vehicles prone to inadvertent airbag inflation. According to a Toyota spokesman quoted in the article “an IC chip in the airbag control unit may malfunction when it receives electrical interference from other parts in the car, causing the airbags to deploy when it is not necessary”. At the time of publication, the spokesman attributed the problem to minor injuries in 18 cases that had been reported at that point, and estimated the financial impact from the airbag recall costing about 5 billion yen ($55 million), which Toyota was considering seeking in compensation from the supplier of the problematic chip.

Failure of end-user devices that are unlikely to impact end-user safety or security is also a concern, particularly if those devices are being manufactured and distributed in very high volumes, such as cell phone and laptop computer devices, since the negative impact on a manufacturer's reputation, and the cost of a widespread recall, will tend to be proportional to the number of units already in the field when a problem is identified. A class action lawsuit currently brought against Apple Inc., related to a defect in the 2011 MacBook Pro laptops, is such an example. The lawsuit attributes intermittent device failure to degradation of the signal path between a device logic board and the Graphics Processing Unit (GPU), supplied by Advanced Micro Devices, related to the use of lead-free solder to connect the GPU to the laptop's logic board. Per the lawsuit, “Lead-free solder, which is typically composed of a combination of tin and silver, suffers from two well-known problems. First, it tends to develop microscopic “tin whiskers,” which cause short circuiting and other problems . . . . Additionally, lead-free solder tends to crack when exposed to rapid changes in temperature. The 2011 MacBook Pros run very hot when performing graphically demanding tasks due to a confluence of high-performance hardware, poor ventilation, and the overuse of thermal paste within the laptop. The high temperatures and large temperature swings inside the computer, known as “stress cycles,” cause the brittle, lead-free solder connecting the AMD GPU to the logic board to crack. Both of these shortcomings with lead-free solder are well known and are preventable with the use of standard solder. When the lead-free solder cracks it degrades the data flow between the GPU and the logic board.”

Evidently, it is in the best interest of the end-user device manufacturer and the manufacturers of the device's electronic modules and/or components to work as partners in ensuring that the end-user devices in service in the field are reliable, and that end-users of the devices are satisfied. However, it is often a series of negative end-user experiences with a device that trigger initial investigation of a problem, and eventual corrective action. Typically, it is the end-user device manufacturer that first receives notice that a problem exists based on returned material, and it is the device manufacturer that drives determination of the problem root cause and scope, even when the problem is at least partly attributable to the electronic modules and/or components supplied to the device manufacturer by the manufacturers of the modules and/or components. Depending on the problem characteristics, scope, and impact to end-users, a decision is made by the device manufacturer as to whether or not to recall suspect devices (if scope and delineation of the problem is well understood) or alternatively, to continue to manage the problem on an end-user-by-end-user (failure-by-failure) basis. By this stage, many months have typically passed since the problematic electronic modules and/or components have been incorporated by the end-user device manufacturer within their devices, and irrevocable damage has been done to the profits and reputation of the device manufacturer.

Similarly, problems occurring in component or module manufacturing processes are generally recognized and addressed solely on the basis of data being monitored within the component or module manufacturing line. Usually, monitors are sufficient to detect a problem and to eventually suggest a root cause when an excursion occurs. The data, however, usually suggest little about the impact to end-user device performance of material passed on during such episodes. Worse, in some cases a problem with a component or module may not be manifested in routinely monitored data, and a problem may go undetected for an extended time. Therefore a relatively small problem in element manufacturing (e.g. an excursion of a piece of testing equipment) may lead to very large-scale performance problems for end-users.

### SUMMARY

In accordance with the presently disclosed subject matter, there is provided a system for concluding whether or not there is a correlation between a set of one or more manufacturing conditions and performance of in-field end-user devices, the system comprising at least one processor configured to: receive data relating to manufacturing of electronic elements; receive in-field data for end-user devices that include the elements; analyze at least one of received data, or data computed based on received data, relating to manufacturing of electronic elements, in order to identify at least two populations among the elements, wherein manufacturing of a first population of the at least two populations corresponds to a set of one or more manufacturing conditions, but manufacturing of a second population of the at least two populations does not correspond to the set; analyze at least one of received in-field data, or data computed based on received in-field data, in order to determine whether or not there is a statistically significant difference in in-field performance between end-user devices including elements from the first population and end-user devices including elements from the second population; and conclude that there is a correlation between the set and the in-field performance when it is determined that there is a statistically significant difference, or concluding that there is not a correlation between the set and the in-field performance when it is determined that there is not a statistically significant difference.

In some embodiments of the system the in-field performance includes in-field reliability.

In some embodiments of the system, at least one of the populations includes elements whose analyzed data relating to manufacturing are similarly abnormal.

In some embodiments of the system, the received data relating to manufacturing of electronic elements include at least data relating to manufacturing of electronic components.

In some embodiments of the system, the received data relating to manufacturing of electronic elements include at least data relating to manufacturing of electronic modules.

In some embodiments of the system, the at least one processor is further configured to: determine the set. In some examples of these embodiments, the system further comprises: a client configured to provide at least one criterion, inputted by an operator, for determining the set.

In some embodiments of the system, the at least one processor is further configured to generate a report.

In some embodiments of the system, the at least one processor is further configured to generate and transmit a query for data for the in-field end-user devices. In some examples of these embodiments, the system further comprises: an aggregator configured to aggregate queries from the at least one processor.

In some embodiments, the system further comprises: at least one collector configured to collect data relating to manufacturing of one or more of the elements at least from manufacturing equipment of one or more element manufacturers or at least from one or more manufacturing execution databases of the one or more element manufacturers or at least from one or more factory information systems of the one or more element manufacturers.

In some embodiments, the system further comprises: a client that is used by an operator affiliated with a manufacturer of elements, configured to: provide a request for in-field data; and obtain in response, received in-field data for end-user devices that include elements manufactured by the manufacturer, but not obtain received in-field data for end-user devices that do not include elements manufactured by the manufacturer.

In some embodiments, the system further comprises: a client that is used by an operator affiliated with a manufacturer of end-user devices, configured to: provide a request for data relating to element manufacturing; and obtain in response received data relating to manufacturing of elements included in end-user devices manufactured by the manufacturer but not obtain received data relating to manufacturing of elements not included in end-user devices manufactured by the manufacturer.

In some embodiments of the system, a metric of the in-field performance is a drift metric.

In some embodiments, the system further comprises: a client configured to: provide at least one criterion for any of the analyzing, inputted by an operator, thereby enabling the at least one processor to analyze at least partly in accordance with the at least one criterion.

In some embodiments of the system, the set includes at least one manufacturing condition which is different than a nominal manufacturing condition.

In some embodiments of the system, for each of the first and second populations, elements included in the population are grouped into two or more groups of elements, and wherein the set is a combination of at least two subsets of one or more manufacturing conditions each, and wherein each one of the subsets corresponds to manufacturing of at least one of the groups included in the first population, but at least one of the subsets does not correspond to manufacturing of any group included in the second population.

In some embodiments of the system, at least some of the elements included in the first population and at least some of the elements included in the second population have similar usage in end-user devices.

In some embodiments of the system, the at least one processor is further configured to: receive or create one or more rules.

In some embodiments, the system further comprises: a client configured to receive from an operator input indicative that the correlation is determined to be spurious and to provide indication that the correlation is determined to be spurious to the at least one processor.

In accordance with the presently disclosed subject matter, there is also provided a system for enabling a conclusion of whether or not there is a correlation between a set of one or more manufacturing conditions and performance of in-field end-user devices, the system comprising at least one processor configured to: receive from one or more operators at least one criterion including at least one analysis specification relating to a set of one or more manufacturing conditions; and provide the at least one criterion to at least one other processor, thereby enabling the at least one other processor to: analyze at least one of received data, or data computed based on received data, relating to manufacturing of electronic elements, in order to identify at least two populations among the elements, wherein manufacturing of a first population of the at least two populations corresponds to the set, but manufacturing of a second population of the at least two populations does not correspond to the set, analyze at least one of received in-field data for end-user devices that include the elements, or data computed based on received in-field data, in order to determine whether or not there is a statistically significant difference in in-field performance between end-user devices including elements from the first population and end-user devices including elements from the second population, and conclude that there is a correlation between the set and the in-field performance when it is determined that there is a statistically significant difference, or conclude that there is not a correlation between the set and the in-field performance when it is determined that there is not a statistically significant difference.

In some embodiments of the system, the at least one criterion includes at least one other analysis specification.

In some embodiments of the system, the at least one processor is further configured to receive from the one or more operators input indicative that the correlation is determined to be spurious and to provide indication that the correlation is determined to be spurious to the at least one other processor.

In some embodiments of the system, at least one of the one or more operators is affiliated with a manufacturer of elements, and one or more of the at least one processor which is used by the at least one operator is further configured to: provide a request for in-field data; and obtain in response, in-field data received from end-user devices that include elements manufactured by the manufacturer, but not obtain in-field data received from end-user devices that do not include elements manufactured by the manufacturer.

In some embodiments of the system, at least one of the one or more operators is affiliated with a manufacturer of end-user devices, and one or more of the at least one processor which is used by the at least one operator is further configured to: provide a request for data relating to element manufacturing; and obtain in response received data relating to manufacturing of elements included in end-user devices manufactured by the manufacturer but not obtain received data relating to manufacturing of elements not included in end-user devices manufactured by the manufacturer.

In accordance with the presently disclosed subject matter, there is further provided a system for enabling a conclusion of whether or not there is a correlation between a set of one or more manufacturing conditions and performance of in-field end-user devices, the system comprising at least one processor configured to: collect data relating to manufacturing of electronic elements at least from manufacturing equipment of one or more element manufacturers or at least from one or more manufacturing execution databases of the one or more element manufacturers or at least from one or more factory information systems of the one or more element manufacturers; and provide the data relating to manufacturing of electronic elements to at least one other processor, thereby enabling the at least one other processor to: analyze at least one of provided data, or data computed based on provided data, relating to manufacturing of the electronic elements, in order to identify at least two populations among the elements, wherein manufacturing of a first population of the at least two populations corresponds to a set of one or more manufacturing conditions, but manufacturing of a second population of the at least two populations does not correspond to the set, analyze at least one of received in-field data received for end-user devices that include the elements, or data computed based on received in-field data, in order to determine whether or not there is a statistically significant difference in in-field performance between end-user devices including elements from the first population and end-user devices including elements from the second population, and conclude that there is a correlation between the set and the in-field performance when it is determined that there is a statistically significant difference, or conclude that there is not a correlation between the set and the in-field performance when it is determined that there is not a statistically significant difference.

In some embodiments of the system, the at least one processor is further configured to aggregate the data relating to manufacturing prior to providing the data relating to manufacturing to the at least one other processor.

In accordance with the presently disclosed subject matter, there is further provided a method of concluding whether or not there is a correlation between a set of one or more manufacturing conditions and performance of in-field end-user devices, comprising: receiving data relating to manufacturing of electronic elements; receiving in-field data from for end-user devices that include the elements; analyzing at least one of received data, or data computed based on received data, relating to manufacturing of electronic elements, in order to identify at least two populations among the elements, wherein manufacturing of a first population of the at least two populations corresponds to a set of one or more manufacturing conditions, but manufacturing of a second population of the at least two populations does not correspond to the set; analyzing at least one of received in-field data, or data computed based on received in-field data, in order to determine whether or not there is a statistically significant difference in in-field performance between end-user devices including elements from the first population and end-user devices including elements from the second population; and concluding that there is a correlation between the set and the in-field performance when it is determined that there is a statistically significant difference, or concluding that there is not a correlation between the set and the in-field performance when it is determined that there is not a statistically significant difference.

In some embodiments, the method further comprises: receiving identifier data along with at least one of received manufacturing data or received in-field data; if the received identifier data need to be prepared for storage, preparing the received identifier data for storage; and storing the at least one of received manufacturing data or in-field data, indexed to at least one of the received or prepared identifier data.

In some embodiments, the method further comprises: receiving identifier data, including at least one identifier of an end-user device in association with at least one identifier of at least one element that is included in the end-user device, or including at least one identifier of a first element in association with at least one identifier of at least one other element included in the first element; if the received identifier data need to be prepared for storage, preparing the received identifier data for storage; and storing at least associations between identifier data.

In some embodiments, the method further comprises: receiving data relating to manufacturing of the end-user devices; and linking received in-field data to received end-user device manufacturing data.

In some embodiments, the method further comprises: for each of one or more of the end-user devices, linking received in-field data for the end-user device with received data relating to manufacturing of elements included in the end-user device. In some examples of these embodiments, at least one of the analyzing uses linked data, or wherein at least one of the analyzing is performed prior to the linking.

In some embodiments, the method further comprises: for at least one element which includes at least one other element, linking received data relating to manufacturing of the element with received data relating to manufacturing of the at least one other element.

In some embodiments, the method further comprises: repeating for in-field data received over time for the same in-field end-user devices, and determining whether or not a determination of whether or not there is a statistically significant difference continues to hold.

In some embodiments, the method further comprises: repeating, with at least one other population substituting for at least one of the first population or second population.

In some embodiments, the method further comprises: repeating for at least one other set of one or more manufacturing conditions each, wherein none of the at least one other set includes exactly identical one or more manufacturing conditions as the set nor as any other of the at least one other set.

In some embodiments, the method further comprises: receiving out of service data for end-user devices that include the elements; and using received out of service data when performing any of the analyzing.

In some embodiments, the method further comprises: receiving adjunct data; and using the adjunct data when performing any of the analyzing.

In some embodiments of the method, the receiving includes at least one of collecting or aggregating.

In some embodiments, the method further comprises: receiving at least one analysis specification relating to the set, inputted by an operator.

In accordance with the presently disclosed subject matter, there is further provided a method of enabling a conclusion of whether or not there is a correlation between a set of one or more manufacturing conditions and performance of in-field end-user devices, comprising: receiving from one or more operators at least one criterion including at least one analysis specification relating to a set of one or more manufacturing conditions; and providing the at least one criterion, thereby enabling: analyzing at least one of received data, or data computed based on received data, relating to manufacturing of electronic elements, in order to identify at least two populations among the elements, wherein manufacturing of a first population of the at least two populations corresponds to the set, but manufacturing of a second population of the at least two populations does not correspond to the set, analyzing at least one of received in-field data for end-user devices that include the elements, or data computed based on received in-field data, in order to determine whether or not there is a statistically significant difference in in-field performance between end-user devices including elements from the first population and end-user devices including elements from the second population, and concluding that there is a correlation between the set and the in-field performance when it is determined that there is a statistically significant difference, or conclude that there is not a correlation between the set and the in-field performance when it is determined that there is not a statistically significant difference.

In accordance with the presently disclosed subject matter, there is further provided a method of enabling a conclusion of whether or not there is a correlation between a set of one or more manufacturing conditions and performance of in-field end-user devices, comprising: collecting data relating to manufacturing of electronic elements at least from manufacturing equipment of one or more element manufacturers or at least from one or more manufacturing execution databases of the one or more element manufacturers, or at least from one or more factory information systems of the one or more element manufacturers; and providing the data relating to manufacturing of electronic elements, thereby enabling: analyzing at least one of provided data, or data computed based on provided data, relating to manufacturing of the electronic elements, in order to identify at least two populations among the elements, wherein manufacturing of a first population of the at least two populations corresponds to a set of one or more manufacturing conditions, but manufacturing of a second population of the at least two populations does not correspond to the set, analyzing at least one of received in-field data received for end-user devices that include the elements, or data computed based on received in-field data, in order to determine whether or not there is a statistically significant difference in in-field performance between end-user devices including elements from the first population and end-user devices including elements from the second population, and concluding that there is a correlation between the set and the in-field performance when it is determined that there is a statistically significant difference, or conclude that there is not a correlation between the set and the in-field performance when it is determined that there is not a statistically significant difference.

In accordance with the presently disclosed subject matter, there is further provided a computer program product comprising a computer useable medium having computer readable program code embodied therein for concluding whether or not there is a correlation between a set of one or more manufacturing conditions and performance of in-field end-user devices, the computer program product comprising: computer readable program code for causing a computer to receive data relating to manufacturing of electronic elements; computer readable program code for causing the computer to receive in-field data from for end-user devices that include the elements; computer readable program code for causing the computer to analyze at least one of received data, or data computed based on received data, relating to manufacturing of electronic elements, in order to identify at least two populations among the elements, wherein manufacturing of a first population of the at least two populations corresponds to a set of one or more manufacturing conditions, but manufacturing of a second population of the at least two populations does not correspond to the set; computer readable program code for causing a computer to analyze at least one of received in-field data, or data computed based on received in-field data, in order to determine whether or not there is a statistically significant difference in in-field performance between end-user devices including elements from the first population and end-user devices including elements from the second population; and computer readable program code for causing the computer to conclude that there is a correlation between the set and the in-field performance when it is determined that there is a statistically significant difference, or concluding that there is not a correlation between the set and the in-field performance when it is determined that there is not a statistically significant difference.

In accordance with the presently disclosed subject matter, there is further provided a computer program product comprising a computer useable medium having computer readable program code embodied therein for enabling a conclusion of whether or not there is a correlation between a set of one or more manufacturing conditions and performance of in-field end-user devices, the computer program product comprising: computer readable program code for causing a computer to receive from one or more operators at least one criterion including at least one analysis specification relating to a set of one or more manufacturing conditions; and computer readable program code for causing the computer to provide the at least one criterion, thereby enabling: analyzing at least one of received data, or data computed based on received data, relating to manufacturing of electronic elements, in order to identify at least two populations among the elements, wherein manufacturing of a first population of the at least two populations corresponds to the set, but manufacturing of a second population of the at least two populations does not correspond to the set, analyzing at least one of received in-field data for end-user devices that include the elements, or data computed based on received in-field data, in order to determine whether or not there is a statistically significant difference in in-field performance between end-user devices including elements from the first population and end-user devices including elements from the second population, and concluding that there is a correlation between the set and the in-field performance when it is determined that there is a statistically significant difference, or conclude that there is not a correlation between the set and the in-field performance when it is determined that there is not a statistically significant difference.

In accordance with the presently disclosed subject matter, there is further provided a computer program product comprising a computer useable medium having computer readable program code embodied therein of enabling a conclusion of whether or not there is a correlation between a set of one or more manufacturing conditions and performance of in-field end-user devices, the computer program product comprising: computer readable program code for causing a computer to collect data relating to manufacturing of electronic elements at least from manufacturing equipment of one or more element manufacturers or at least from one or more manufacturing execution databases of the one or more element manufacturers, or at least from one or more factory information systems of the one or more element manufacturers; and computer readable program code for causing the computer to provide the data relating to manufacturing of electronic elements, thereby enabling: analyzing at least one of provided data, or data computed based on provided data, relating to manufacturing of the electronic elements, in order to identify at least two populations among the elements, wherein manufacturing of a first population of the at least two populations corresponds to a set of one or more manufacturing conditions, but manufacturing of a second population of the at least two populations does not correspond to the set, analyzing at least one of received in-field data received for end-user devices that include the elements, or data computed based on received in-field data, in order to determine whether or not there is a statistically significant difference in in-field performance between end-user devices including elements from the first population and end-user devices including elements from the second population, and concluding that there is a correlation between the set and the in-field performance when it is determined that there is a statistically significant difference, or conclude that there is not a correlation between the set and the in-field performance when it is determined that there is not a statistically significant difference.

### BRIEF DESCRIPTION OF THE DRAWINGS

In order to understand the subject matter and to see how it may be carried out in practice, some examples will be described, with reference to the accompanying drawings, in which:

FIG. 1 illustrates an example of a NAND flash manufacturer in accordance with some embodiments of the presently disclosed subject matter;

FIG. 2 is a block diagram of a system, in accordance with some embodiments of the presently disclosed subject matter;

FIG. 3 (comprising FIGS. 3A and 3B) is a flowchart of a method, in accordance with some embodiments of the presently disclosed subject matter;

FIG. 4 is a flowchart of a method for defining or redefining analysis specifications, in accordance with some embodiments of the presently disclosed subject matter;

FIG. 5 (comprising FIG. 5A and FIG. 5B) is a flowchart of a method of analysis definition or redefinition that includes input that is provided through collaboration of machine and human, in accordance with some embodiments of the presently disclosed subject matter;

FIG. 6A (comprising FIG. 6A and FIG. 6A Continued) is a flowchart of a method of analyzing at least in-field data for end-user devices and data relating to manufacturing of elements included in the devices, in accordance with some embodiments of the presently disclosed subject matter;

FIG. 6B (comprising FIG. 6B and FIG. 6B Continued) is a flowchart of a another method of analyzing at least in-field data for end-user devices and data relating to manufacturing of elements included in the devices, in accordance with some embodiments of the presently disclosed subject matter;

FIG. 6C (comprising FIG. 6C and FIG. 6C Continued) is a flowchart of a another method of analyzing at least in-field data for end-user devices and data relating to manufacturing of elements included in the devices, in accordance with some embodiments of the presently disclosed subject matter; and

FIG. 7 (comprising FIG. 7A and FIG. 7B) is a flowchart of a method for acting on the results of an analysis, in accordance with some embodiments of the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate identical or analogous elements.

### DETAILED DESCRIPTION

It may be in the best interest of both end-user device manufacturer(s) and the manufacturer(s) of electronic modules and components included in the devices to adopt methods to minimize the impact of problems in device performance. Some embodiments of the current subject matter present a systematic approach for analyzing data from the manufacturing of electronic elements (including electronic modules and/or electronic components) and in-field data for devices of end-users that include these elements.

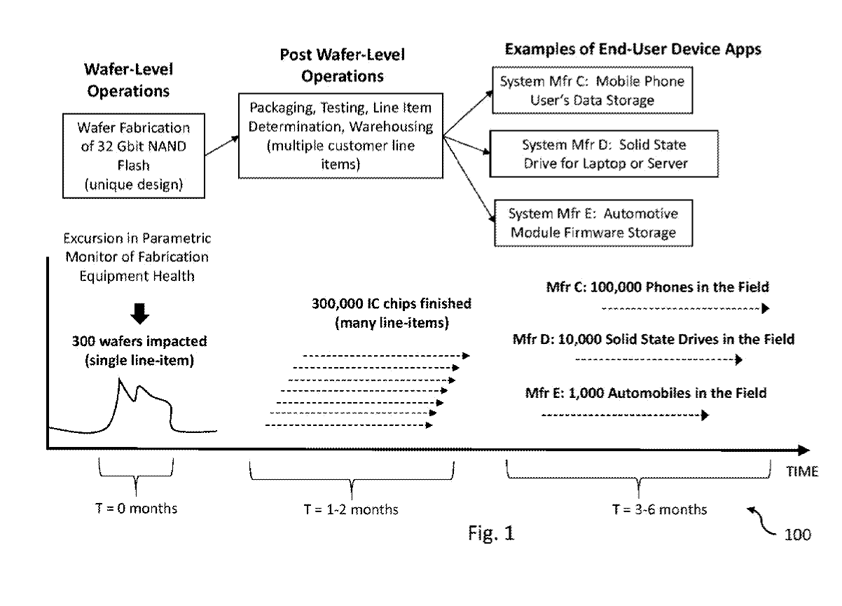

In some embodiments, problems suspected or actually identified in the electronics manufacturing process may be used to determine if these problems have actually affected responses exhibited in data generated by end-user devices in the field. Additionally or alternatively such problems may be used in some embodiments to anticipate and/or delineate the scope of potentially related responses exhibited in data generated by end-user devices in the field, as opposed to relying on incidental end-user field failures and returned material as the means to monitor and indicate upstream electronic module and component manufacturing problems. In either case, there may be a conclusion of whether or not the problems in the manufacturing process (as represented in a set of one or more manufacturing conditions) may correlate to in-field performance. Refer to FIG. 1, which illustrates an example of a NAND flash manufacturer in accordance with some embodiments of the presently disclosed subject matter. The NAND flash manufacturer in this example experiences a short excursion in a monitored piece of equipment, resulting in a 300 wafer segment of WIP with unknown end-customer reliability risk. In this example, the components (NAND flash) that are produced may eventually go into many thousands of cell phones, solid state drives (laptops/servers), and automobiles, etc. involving, say, three different device manufacturers. Each of these applications (cell phones, solid state drives, automobiles, etc.) may have a different risk profile than the others, from a reliability standpoint, and each may respond differently to the material produced under the fabrication excursion. Even though the root cause of the problem may have already been addressed, the NAND flash manufacturer may benefit from having data related to end-user device in-field performance, to establish whether or not there is evidence of quality or reliability problems, both in order to alert the device manufacturers to the issue and also to improve procedures in component manufacturing to better recognize and contain such excursions in the future. See below for additional details regarding such embodiments.

Additionally or alternatively, in some embodiments, performance differences detected in in-field end-user device data may be correlated to one or more manufacturing segments. (A manufacturing segment is also referred to herein as a set of one or more manufacturing conditions). For instance, there may be no known/recognized component excursion, but if an end-user device performance problem (e.g. reliability problem) is manifested, the manufacturer of components or another party may use in-field data from the faulty devices that include the manufactured components and original component manufacturing data to conclude, whether or not, say, there is a correlation between a part of the line that may have processed the suspect components to the identified problematic device performance. See below for additional details regarding such embodiments.

Additionally or alternatively, in some embodiments, a data correlation may be performed between in field data and manufacturing data in order to determine a relationship. Depending on a comparison between the relationship and a reference relationship it may be concluded whether in-field and/or manufacturing data are inconsistent. See below for additional details regarding such embodiments.

In the description herein, numerous specific details are set forth in order to provide a thorough understanding of the subject matter. However, it will be understood by those skilled in the art that some examples of the subject matter may be practiced without these specific details. In other instances, well-known feature(s), structure(s), characteristic(s), stage(s), action(s), process(es), function(s), functionality/ies, procedure(s), method(s), box(es), entity/ies and/or system(s) have not been described in detail so as not to obscure the subject matter. Usage of the terms “typically although not necessarily”, “not necessarily so”, “such as”, “e.g.”, “possibly”, “potentially”, “it is possible”, “it is possible”, “it is plausible”, “optionally”, “say”, “for example,” “for instance”, “an example” “one example”, “illustrated example”, “illustrative example”, “some examples”, “another example”, “other examples, “various examples”, “examples”, “some embodiments”, “some of these embodiments” “other embodiments”, “many embodiments”, “one embodiment”, “illustrative embodiment”, “another embodiment”, “some other embodiments”, “illustrated embodiments”, “embodiments”, “instances”, “one instance”, “some instances”, “another instance”, “other instances”, “one case”, “some cases”, “another case”, “other cases”, “cases”, or variants thereof means that a particular described feature, structure, characteristic, stage, action, process, function, functionality, procedure, method, box, entity, or system is included in at least one example of the subject matter, but not necessarily in all examples. The appearance of the same term does not necessarily refer to the same example(s).

The term “illustrated example”, “illustrated embodiments”, or variants thereof, may be used to direct the attention of the reader to one or more of the figures, but should not be construed as necessarily favoring any example over any other.

Usage of conditional language, such as “may”, “might”, “could”, or variants thereof should be construed as conveying that one or more example(s) of the subject matter may include, while one or more other example(s) of the subject matter may not necessarily include, certain feature(s), structure(s), characteristic(s), stage(s), action(s), process(es), function(s), functionality/ies, procedure(s), method(s), box(es), entity/ies and/or system(s). Thus such conditional language is not generally intended to imply that a particular described feature, structure, characteristic, stage, action, process, function, functionality, procedure, method, box, entity or system is necessarily included in all examples of the subject matter.

The term “including”, “comprising”, and variants thereof should be construed as meaning “including but not limited to”.

The term “based on”, “on the basis of”, and variants thereof should be construed as meaning “at least partly based on”.

The term “non-transitory” or variants thereof may be used to exclude transitory, propagating signals, but to otherwise include any volatile or non-volatile computer memory technology suitable to the application.

The term “device” or variants thereof and “end-user device” or variants thereof may be used interchangeably to refer to a device that an end-user uses and that includes electronic elements that have been manufactured prior to and separately from the manufacturing of the end-user device.

The term “end-user” or variants thereof may refer to a user who uses an (end-user) device, after the device has been manufactured.

The terms “element” and “electronic element” may be used interchangeably herein. Electronic elements may include electronic modules and/or electronic components. The terms “component” and “electronic component” may be used interchangeably herein. The terms “module” and “electronic module” may be used interchangeably herein.

The term “elements”, “electronic elements”, or variants thereof may refer to components and/or modules constructed or working by the methods or principles of electronics, whereby an electronic module may include an assembly of electronic components, associated wiring, and optionally other modules. Examples of such electronic elements may include active components such as integrated circuits, VLSI microchips, systems-on-a-chip (SOC), arrays of semiconductor memory and/or logic circuits, bipolar transistors, field effect transistors (FETs), thyristors, diodes, vacuum tubes and modules at least partly comprised of such active components, etc. and/or passive components such as resistors, capacitors, inductors, memristors, thermistors, thermocouples, antennas, coils, fuses, relays, switches, conducting wires and connectors and modules at least partly comprised of such passive components, etc. Included are active and passive elements included within or integrated with electronic modules and circuit fixtures of various types such as printed circuit (PC) boards, motherboards, daughterboards, plug-ins, expansion cards, assemblies, multi-chip packages (MCPs), multi-chip modules (MCMs), potted and encapsulated modules, interposers, sockets, and the like, including those elements listed above as well as integrated electrical connections such as pads, bond wires, solder balls, solder bumps, leads, traces, jumpers, plugs, pins, connectors, vias, and any of a myriad variety of other means of providing electrical continuity where needed. Additionally or alternatively the term “elements”, “electronic elements” or variants thereof may refer to components and/or modules based on applications of photonic radiation of any wavelength that generate, detect, receive, transmit, convert and control such radiation, for example lasers, masers, light emitting diodes (LEDs), microwave klystron tubes, various light generation sources using electricity, photovoltaic cells, liquid crystal displays (LCDs), charged coupled devices (CCDs), CMOS sensors, optical connectors, waveguides, including any of various devices from the field of optoelectronics, etc. Additionally or alternatively the term “elements”, “electronic elements” or variants thereof may refer to components and/or modules based on applications of magneto-electronics that utilize magnetic phenomena, such as the magnetic medium of computer hard drives and spintronic applications that utilize electron spin in their functionality, for example magnetoresistive random-access memory (MRAM), and giant magnetoresistance (GMR) components such as those used in the read heads of computer hard drives, etc. Additionally or alternatively the term “elements”, “electronic elements”, or variants thereof may refer to components and/or modules based on electro-mechanical applications such as electric motors and generators, microelectromechanical systems (MEMS) of various functions, transducers and piezoelectric components, and crystals as used in resonant electronic circuits and the like. Additionally or alternatively the term “elements”, “electronic elements”, or variants thereof may refer to components and/or modules based on electrochemical applications generating electricity, such as batteries used to provide power to electric or hybrid vehicles and batteries used in mobile electronic consumer products, including various forms of chemical batteries, and also including various forms of fuel cells. Also included are applications generating electrical responses to chemical conditions, such as the detection components of various gas sensors, ion-sensitive field-effect transistor (ISFET) sensors, biosensors, pH sensors, conductivity sensors, and the like.

Usage of terms such as “receiving”, “allowing”, “enabling” “accessing”, “outputting”, “inputting”, “correlating”, “aggregating”, “grouping”, “substituting”, “feeding back”, “presenting”, “reporting”, “causing”, “analyzing”, “associating”, “storing”, “providing”, “indicating”, “sending”, “transmitting”, “writing”, “reading” “executing”, “performing”, “implementing”, “generating”, “transferring”, “examining”, “analyzing”, “notifying”, “checking”, “establishing”, “enhancing”, “storing”, “computing”, “obtaining” “communicating”, “requesting”, “responding”, “answering”, “determining”, “deciding”, “concluding”, “displaying”, “using”, “identifying”, “predicting”, “querying”, “preparing”, “indexing”, “linking”, “encrypting”, “unencrypting”, “classifying”, “parsing”, “organizing”, “formatting”, “reformatting”, “collecting” “repeating”, “defining”, “recognizing”, “verifying, or variants thereof, may refer to the action(s) and/or process(es) of any combination of software, hardware and/or firmware. For instance, such term(s) may refer in some cases to action(s) and/or process(es) of one or more electronic machine(s) each with at least some hardware and data processing capabilities that manipulates and/or transforms data into other data, the data represented as physical quantities, e.g. electronic quantities, and/or the data representing the physical objects. In these cases, one or more of the action(s) and/or process(es) in accordance with the teachings herein may be performed by one or more such electronic machine(s) each specially constructed and thus configured for the desired purposes, by one or more such general purpose electronic machine(s) each specially configured for the desired purposes by computer readable program code, and/or by one or more such electronic machine(s) each including certain part(s) specially constructed for some of the desired purposes and certain part(s) specially configured for other desired purposes by computer readable program code. Terms such as “computer”, “electronic machine”, “machine, “processor”, “processing unit”, and the like should be expansively construed to cover any kind of electronic machine with at least some hardware and with data processing capabilities (whether analog, digital or a combination), including, by way of example, a personal computer, a laptop, a tablet, a smart-phone, a server, any kind of processor (e.g. digital signal processor (DSP), a microcontroller, a field programmable gate array (FPGA), an application specific integrated circuit (ASIC), any known architecture of processor whether single or multi parallel distributed and/or any other, etc.), any other kind of electronic machine with at least some hardware and with data processing capabilities, and/or any combination thereof.

It should be appreciated that certain feature(s), structure(s), characteristic(s), stage(s), action(s), process(es), function(s), functionality/ies, procedure(s), method(s), box(es), entity/ies and/or system(s) disclosed herein, which are, for clarity, described in the context of separate examples, may also be provided in combination in a single example. Conversely, various feature(s), structure(s), characteristic(s), stage(s), action(s), process(es), function(s), functionality/ies, procedure(s), method(s), box(es), entity/ies and/or system(s) disclosed herein, which are, for brevity, described in the context of a single example, may also be provided separately or in any suitable sub-combination.

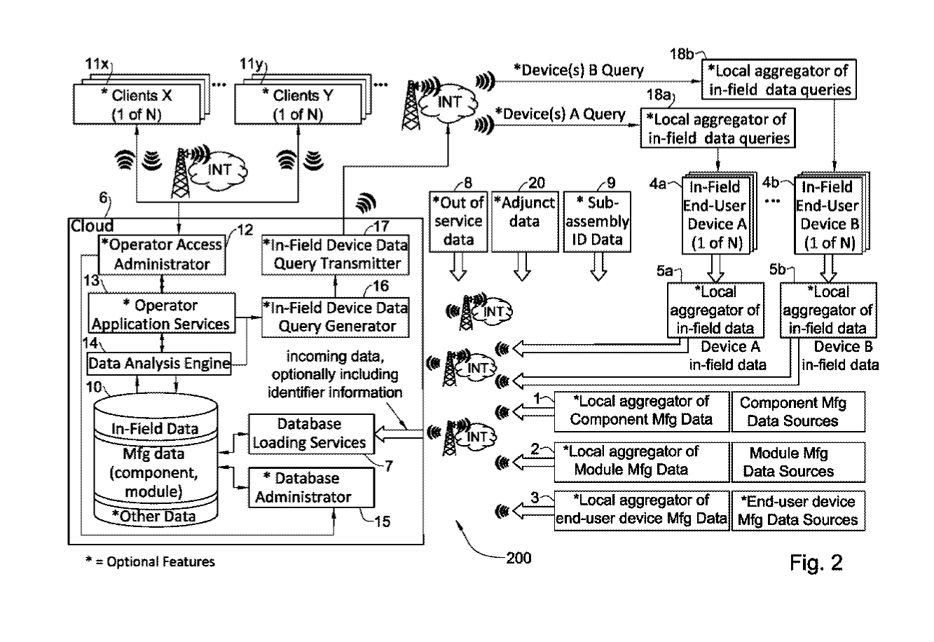

FIG. 2 is a block diagram of a system 200, in accordance with some embodiments of the presently disclosed subject matter. System 200 may be made up of any combination of software, hardware and/or firmware that performs the function(s) as described and explained herein. Similarly, any of the boxes shown in FIG. 2 may be made up of any combination of software, hardware and/or firmware that performs the function(s) as described and explained herein. Possibly the combination of software, hardware and/or firmware which makes up system 200 may include one or more processors, for performing at least part of the function(s) described herein. It is noted that when referring to a system herein, the reference may be to a system including one or more box(es) illustrated in FIG. 2. For instance a system may include only box 6 or a part thereof, a system may include one or more boxes illustrated in FIG. 2 (which may or may not include box 6 or a part thereof), a system may include at least all the non-optional boxes shown in FIG. 2, a system may include all of the boxes shown in FIG. 2, a system may or may not include boxes not illustrated in FIG. 2, etc. A system may be concentrated in a single location or dispersed over a plurality of locations.

In the illustrated embodiments, an exemplary collection of electronic elements are included within multiple instances of devices that are in use in the field by the device end-users. The exemplary elements may include electronic components and/or electronic modules. See list of examples detailed above. In some cases, a particular module may include one or more other modules, which for simplicity may be referred to as “sub-modules” but it should be understood that a sub-module is also a module. Typically although not necessarily, an electronic component or electronic module may not be sold to or used by an end-user except as part of an end-user device. An end-user device, however, may be an item that may be sold to and/or used by an end-user without undergoing additional assembly during manufacturing (although the end-user may be required to perform certain tasks and/or a technician may be required to install or activate the device before the initial operation of the device). Besides electronic component(s) and/or module(s), an end-user device may optionally include wiring, and/other non-electronic component(s) and/or module(s).

For simplicity of illustration, it is assumed in FIG. 2 that there are two collections of devices, although there may alternatively be one collection, or more than two collections. The two different collections of exemplary devices shown in the figure will simply be referred to as “Device A” and “Device B”. In the illustrated embodiments, it is intended that Device A and Device B be distinct from one another in design, form and/or function, but have in common one or more of the exemplary device elements in their construction. It should be understood that although the embodiment shown in the figure includes only two different types of devices and two different sources of elements, the subject matter is not limited with regard to the number or types of devices or elements involved.

The subject matter does not limit how the collections of devices may be different from each other. For instance, each collection of devices may represent a different type of device (e.g. different product and/or different model of the same product), and/or may represent a different manufacturer. Different products may include for instance, high volume low impact failure products (e.g. cell phones, set-top boxes, tablets/laptop computers, etc.), low volume high impact failure products (e.g. servers or disk drives in server farms, factory equipment, etc.), mission critical health safety products (e.g. avionics, electronic control unit of a car or other automotive, military, medical applications, etc.), and infrastructure products (e.g. traffic lights, power grid control, etc.), etc. Different models for the same product may include different models of laptops, which may or may not be manufactured by the same manufacturer. For instance, ten thousand Samsung phones of one model versus twenty thousand Samsung phones of a different model or twenty thousand Apple phones of a different model. Different types of devices may possibly be for entirely different applications and/or markets, or not necessarily so.

However, as mentioned above, it is also possible to benefit from a system in accordance with the currently disclosed subject matter, even if the devices are of the same type (same product and same model) and manufactured by the same manufacturer.

In the illustrated embodiments, various data related to the manufacturing process of the illustrated device elements are referred to for each of component manufacturing operation 1, and module manufacturing operation 2. This manufacturing data may be generated by manufacturing equipment involved in the physical construction (“fabrication”) or testing of the element, or may be derived from a Manufacturing Execution (MES) database containing operational information regarding the history of the manufacturing that is being performed. Note that the manufacturing data for a given type of element may possibly span several processing steps and may occur in various geographical locations, and therefore the individual boxes 1 and 2 shown in the figure do not necessarily imply a single process step at a single geographical location. For instance, in the manufacturing of components, box 1 may include fabrication of the component, wafer-level electrical parametric testing of WAT structures, electrical testing of product die performed on wafers (“wafer sort”), wafer assembly (packaging product die into “units”), unit-level burn-in, unit-level final testing, system-level testing, etc. These various steps in the manufacture of a finished component may occur in various facilities in various geographies or in the same facility. Similarly, for instance in module manufacturing, box 2 may include similar fabrication, processing, monitoring, and electrical testing steps as described above for component manufacturing in addition to steps often associated with module manufacturing such as In-Circuit Testing (ICT), Automated Optical Inspection (AOI), X-Ray Inspection (AXI), Conformal Coat Inspection, etc. These steps may be performed in various facilities in various geographies or in the same facility.

These data from box 1 and box 2 may be collected (or in other words compiled) for instance from manufacturing equipment (e.g. fabrication equipment, testing equipment, etc), from a factory information system(s) and/or from manufacturing execution database(s) of an element manufacturer, and may be transmitted (e.g. as collected) or after local aggregation. The collection of the data from a tester, for example, may be performed by software during testing, and/or the collection of a data from an MES database may be performed, for example, by software that provides an interface to extract the data from the database.

In the illustrated embodiments, device manufacturing data (box 3), generated by manufacturing equipment (e.g. fabrication equipment, testing equipment, etc), generated by a factory information system, and/or derived from an MES database of a device manufacturer may also be used in system 200. However, in other embodiments, device manufacturing data may not be used.

For simplicity of description, the illustrated embodiments assume that device manufacturing data 3 relates to one or more sources of manufacturing data for device collections A and B. Further assume that component manufacturing data 1 relates to one or more sources of manufacturing data for elements included in device collections A and B. Also, assume that module manufacturing data 2 relates to one or more sources of manufacturing data for modules included in device collections A and B. It is possible that in some embodiments manufacturing data may relate to components and/or modules in devices other than device collections A and B, and/or may relate to components and/or modules included in only a sub-collection of devices A and B. It is further possible that in some embodiments, the devices of interest may be devices in only one of the collections, only a sub-collection of devices A and B, and/or devices in other collection(s).

Referring to manufacturing data (also termed herein “data relating to manufacturing”) of 1, 2, and possibly 3, the data acquired may optionally be aggregated locally at the location of the data source(s), as shown in the exemplary embodiment of FIG. 2, and may then be transmitted (e.g. via the Internet) to box 6. (Although separate local aggregators, are optionally shown for component, module, and device manufacturing data, in some embodiments aggregators may be combined, for instance closer to the transmitting end if the data sources are at the same location, and/or closer to the receiving end (box 6).) For example, aggregated data may be transferred as an encrypted file to the receiving box 6 using an FTP protocol, via HTTP Web Services, through a RESTful implementation or any other standard or proprietary method of digital communication. In some embodiments a given manufacturing data source (e.g. one of boxes 1-3) may be distributed across multiple locations, and aggregation of data may occur at those locations independent of one another. In some of these embodiments, such data may arrive from the various data sources to be then queued and prepared for transmission at a later time (e.g. once per hour, once per day, etc.), or may be transmitted immediately after preparation. Transmitted data may occur individually for each of the available data sources, or in combination after aggregation. In other embodiments, the data may not be aggregated before transmission, but may be streamed (encrypted or unencrypted) from the data source as it is collected. In other embodiments, data may be aggregated and streamed (encrypted or not).

The data from boxes 1, 2, and/or 3 may be collected and/or aggregated for example by one or more collector(s) and/or aggregators. The collector(s) and/or aggregator(s) may include for instance at least one processor.

The subject matter does not limit the type of manufacturing data, but for the sake of further illustration to the reader some examples are now provided. Element manufacturing data may include logistical data (also referred to as attribute data), physical measurements (taken during component fabrication phase, during assembly packaging, during PC board manufacturing, etc.), fabrication data generated by fabrication equipment, testing data, manufacturing equipment maintenance data, monitor data, etc.

These examples of manufacturing data may be categorized into parametric data, function data and/or attribute data. The subject matter is not bound by these categories and in some embodiments there may be fewer, more and/or different categories. Additionally or alternatively the categorization of data into a particular category may vary depending on the embodiment.

For instance, parametric data may include numerical data resulting and/or derived from various physical measurements, fabrication, monitoring, maintenance, and/or testing, often times (but not always) represented as non-integer. The subject matter does not limit the parametric data, but for the sake of illustration some examples are now presented. For example, these data may be in any format representing a numerical value, or range or set of numerical values. Parametric data may, for example, quantify some aspect of the element's processing or performance, such as power consumption, maximum clock frequency, calibration setting for an on-chip digital to analog converter (DAC) circuit, final test operation time, etc.

For instance, function data may include data indicating some aspect of the functionality, configuration, status, classification, or non-parametric condition of an element. Function data may result and/or be derived from various physical measurements, fabrication, monitoring, maintenance, and/or testing. The subject matter does not limit the function data, but for the sake of illustration some examples are now presented. For example, these data may be in any data format representing a functionality or operational state, configuration, status, classification, or non-parametric condition. For example function data may be represented in binary format, e.g., by 1=passing/functional and 0=failing/non-functional. Continuing with this example, in some embodiments such function data may result from execution of an element's native end-usage functions, for example, the result of a read-write-read pattern executed on a memory element, or the result of execution of a series of user instructions on a CPU element. Additionally or alternatively, in some embodiments such function data may result from execution of non-user functions, designed into an element for the purposes, for example, of enhancing test coverage, reducing test time, or gathering information regarding the element's condition or behavior. For example, a result of testing performed using Built-In Self-Test (BIST), Programmable Built-In Self-Test (PBIST), Memory Built-In Self-Test (MBIST), Power-Up Built-In Test (PBIT), Initialization Built-In Test (IBIT), Continuous Built-In Test (CBIT), and/or Power-On Self-Test (POST) circuitry, or of testing performed using structural scan circuitry, or of reading an element's configuration or status using engineering readout circuitry may be represented by function data.

Attribute data may refer to qualitative data indicating some aspect of the processing of an element such as a characteristic of the element or the processing of the element that may not necessarily be measured but may be inherent. The subject matter does not limit the attribute data, but for the sake of illustration some examples are now presented. For example, these data may be in any format. Examples of attribute data may include name of manufacturer, manufacturing environmental conditions, design revision used, fabrication equipment used, test equipment used, process materials used, plant/geographic information, time of manufacture, test software revision used, manufacturing conditions deliberately or inadvertently applied, equipment maintenance events/history, processing flow and manufacturing event history, classification data, disposition data (including scrap disposition), configuration data, construction data, state of plant where manufactured, operations personnel information, probecard used, whether the element was retested, data regarding physical placement within substrates, packages or wafers (e.g. center vs. edge or reticle location, die x, y coordinates, board position of component on PC board, position of component in multichip module, etc.), and processing batch data (e.g., die identifiers, wafer numbers, lot numbers, etc.), etc.

If device manufacturing data are collected, such device manufacturing data may include: logistical data (e.g. name of device manufacturer, time of manufacture, end-user, device application information, configuration information (e.g. firmware revision), electrical element identifier information, design revision used, test equipment used, time of manufacture, test software revision used, when equipment maintenance was performed, operations personnel, batch, processing flow and conditions, manufacturing event history, classification and disposition data (including scrap disposition), construction data, placement of elements in device, whether the device was retested, etc.), function data (e.g. using BIST PBIT, IBIT, CBIT, POST, structural scan test, etc.), and/or parametric data.

Optionally, manufacturing data for a particular element or manufacturing data for a specific device may additionally or alternatively include manufacturing data on other element(s) or device(s) which may have a bearing on the particular element or specific device, respectively. For instance if other elements or devices were scrapped, this may reflect poorly on a particular element or specific device, even if the particular element or specific device was not scrapped. In some embodiments, the elements scrapped may share some commonality in the manufacturing process or commonality in their construction with the particular element or specific device that was not scrapped, for example, commonality in wafer or lot origin, commonality in the time of processing, commonality in the processing equipment used for fabrication and/or testing, commonality in fabrication and/or test recipes used, commonality in manufacturing measurement results, and so on. In some embodiments a combination of common factors may have a bearing on the particular element or device, for example, an element manufactured in a wafer from which many die were scrapped during a period of time when the manufacturing process had a known quality issue may be a concern, while one manufactured in a wafer without scrapped die during the same period of time may not be a concern. Therefore data on the scrapping may optionally be included in manufacturing data for the particular element or specific device. For another instance, due to sampling during testing, there may not be an actual test result for a particular element or specific device, but a sampled test result of another element or device may be useful. Therefore, the sampled test result may be included in the manufacturing data for the particular element or specific device. For another, instance, yield data may not necessarily include the particular element or specific device (for instance only including scrapped elements or devices) but may in any event be relevant to the particular element or specific device and therefore may optionally be included in the manufacturing data for the particular element or specific device.

In some embodiments, a given manufacturing data point may need to be traceable to a specific set of one or more manufacturing conditions. Traceability may be desirable in order to analyze manufacturing data of device elements vis-à-vis data produced in the field by end-users of a device including such elements. For example, if a parametric test measurement generated during wafer sort is known to originate from a specific die on a specific wafer, and that same die may be identified as a component within an end-user device, a relationship between the parametric wafer sort test measurement and the behavior of the end-user device may potentially be found. Similarly, if a parametric measurement from a PC board manufacturing process is known to have been generated on a specific tester during a specific manufacturing time interval, and it is also known that a PC board contained within an end-user device was tested on the same specific tester during the time interval, then a relationship between the behavior of the PC board tester during the time interval and the behavior of the end-user device may potentially be found. In these examples, the ability to trace the parametric measurement to a specific set of manufacturing condition(s) may allow for a correlation between the manufacturing set of condition(s) and the end-user device behavior to be found.

In some instances, manufacturing data for a component may be automatically received in box 6 (e.g. by loading service 7) along with an identifier (ID) of the component. The manufacturing data may then be loaded (e.g. by loading service 7) into database 10, indexed to the identifier. In some of these instances, the identifier of a component may include for instance an identifier of the manufacturer, an identifier of the type of component, and/or identifier of factory. Additionally or alternatively, an identifier of a component may include a lot identifier, wafer identifier, wafer sector identifier (e.g. edge sector, center sector, etc.), and/or die identifier (x, y coordinates). In other instances, the identifier of the component may include a serial number that is the basis for indirect reference to, say, wafer/die of origin, such as via a look up table or similar mechanism.

Optionally, when a component is being fabricated, the lot identity and wafer identity may be databased (e.g. in MES and/or in database 10) with the manufacturing data being collected (e.g., which etcher was used, along with the etcher measurements on a particular lot and wafer). The individual die on each wafer may also be in known positions on the wafer until the time the wafer is assembled/packaged. At wafer sort, after the component has completed physical fabrication, electronic component ID (ECID) data—or, equivalently, unit level traceability (ULT) data—may be programmed into on-component fuses, which may be electrically read out at any/all following electrical test operations, even after die are separated from the wafer. Those data might be then decoded to indicate the source of the device, for example in an ASCII format such as lotnumber_wafernumber_dieX_dieY. At final test (for example) of the component, the ECID data may be read out and stored with the final test data.

It is noted that depending on the example, a component identifier may or may not identify the component individually from all other components. For instance, the component identifier may in some cases identify only up until a batch level (e.g. lot, wafer) and not to the die itself, whereas in other cases the component identifier may identify the actual die.

In some instances, manufacturing data for a module may be automatically received in box 6 (e.g. by loading service 7) along with an identifier of the module. The manufacturing data may then be loaded (e.g. by loading service 7) into database 10, indexed to the identifier. In some of these instances, a module identifier for a PC board may include any of the following: ECID (fuses) of the components on board, media access control (MAC) addresses of the Wi-Fi (sub) modules on board, barcodes, radio frequency ID (RFID) (active/passive), direct part marking (laser etch, ink print, and/or other techniques [datamark]), board identifier, serial number etc. For example, for a multichip module, the identifier may be the ECID (fuses) of the components in the module, a serial number, etc.

In some instances where device manufacturing data are collected, manufacturing data for a device may be automatically received in box 6 (e.g. by loading service 7) along with an identifier of the device. The manufacturing data may then be loaded (e.g. by loading service 7) into database 10, indexed to the identifier. An identifier of a device may include for example, a device serial number. Additionally or alternatively, an identifier of a device may include, for example, identifiers of all components and/or modules in the device, or identifier(s) of one or more component(s)/module(s) in the device, for instance major component(s)/module(s). Continuing with this example, the device identifier may include in some cases, the device's PC board and/or multi-chip package identifiers. Such identifiers may allow tracing of the manufacturing data to a set of manufacturing condition(s) relevant to the data.

The subject matter is not bound by any of the above identifier examples for component, module or device.

A set of manufacturing condition(s) may be distinguished from other sets of manufacturing condition(s) by one or more conditions, and such a set may thereby define the scope of elements whose manufacturing corresponds to the set. It should be noted that although manufacturing of an element that corresponds to a given set of manufacturing conditions may by definition have been manufactured under conditions at least including those defining the given set, the manufacturing conditions defining the given set may generally be only a subset of all of the myriad conditions that are typically involved in manufacturing an element, which can number in the thousands. For example, a component whose manufacturing may involve 3,000 conditions may still be considered to have been manufactured under a set of manufacturing conditions defined by only three conditions, for example, that the component come from die locations on a wafer located within 10 mm of the wafer edge, and that the component come only from wafers with a WAT contact/Metal1 chain resistance measurement of median value greater than 35 ohms, and that the component come only from wafers with wafer sort yields of less than 60%. Components whose manufacturing meets the set of all three manufacturing conditions (regardless of other conditions that may have been involved in the manufacture of those components) may be described as having manufacturing corresponding to the set, while all components whose manufacturing does not meet all three criteria may be described as having manufacturing that does not correspond to the set. The manufacturing of these latter components may be distinguished from the manufacturing of the former components by at least differing in one or more of the manufacturing conditions stipulated in the set. Examples of manufacturing conditions may include: plant, manufacturing testing equipment, manufacturing fabrication equipment, time of manufacture, batch data (e.g. lot, wafer, etc.), type of element (e.g. type of component, type of module), manufacturing operational specifications, processing flow and conditions, monitor data, manufacturing fabrication process revision, manufacturing equipment maintenance history, classification and disposition data (including scrap disposition), configuration data, construction data, design revision, software revision, manufacturing test or fabrication parametric data characteristics, manufacturing event history, operations personnel, other fabrication data, test data, physical placement data within substrates packages or wafer (e.g. center vs. edge or reticle location, die x, y coordinates, position of component on PC board, position of component in multi-chip package), manufacturing temperature, etc. For example, a set of manufacturing condition(s) may be distinguished by one or more improper or non-nominal manufacturing conditions, so that elements manufactured under these conditions may be considered to correspond with this set of manufacturing condition(s). An improper condition may be a type of non-nominal condition. For example, an improper condition may be the result of an error of some sort in the manufacturing process, or in the configuration and/or maintenance of manufacturing equipment, such as an inadvertent condition that may lead to some sort of problem in the yield or reliability or performance of the elements produced. In another example, a non-nominal condition may not necessarily be the result of an error, but may be a deliberate alteration in the manufacturing process, or in the configuration and/or maintenance of manufacturing equipment, applied for a limited time or on a limited quantity of material—for example, as an experimental condition deliberately made for evaluation of a change that is being considered to a nominal process before making the change permanent, or possibly as a change to the previous nominal process that has already been adopted, or possibly as a change made for engineering evaluation of non-nominal conditions to evaluate the behavior (such as yield, reliability, or performance) of a manufactured element at “process corners”. In some embodiments the improper or non-nominal change of the set of manufacturing conditions may include a change to the design of the element being manufactured, for example, a change to the stepping of component design, involving a change to one or more of the photolithographic masks used in its manufacturing than previously used, or a change to the packaging of an element, for example, placing a fabricated die in a new or different package type or using a different package configuration than previously used. In another example, a set of manufacturing condition(s) may be distinguished by test data indicating failure in one or more tests (and/or outlier identification data indicating outliers) or by disposition data (such as scrap disposition), which should have led to scrapping during manufacture, so manufacturing of elements with such data may be considered to correspond to this set of manufacturing condition(s). In another example, a set of manufacturing condition(s) may be distinguished by x component type and y component type and time of manufacture between Jan. 15, 2015 at 10 AM and Jan. 16, 2105 at 6 AM.

Depending on the example where there is a correspondence between manufacturing of elements and a set of manufacturing condition(s), the set may correspond to manufacturing of one, some, or all of various elements within a device. Alternatively, the set may correspond to manufacturing conditions of two or more elements within a device, for which the two or more elements are members of different groups. In the latter case, the set of manufacturing condition(s) may be distinguished for each group by a subset of one or more manufacturing conditions, which may not necessarily be the same for each group. Therefore the set in this case may be a combination of at least two subsets of one or more manufacturing conditions each, where each one of the subsets may correspond to manufacturing of at least one of the groups.

In some embodiments, manufacturing of a certain element may correspond to a plurality of sets of manufacturing conditions (e.g. one distinguished by manufacturing equipment, another by design revision and software revision, etc.). In these embodiments, each of these sets of manufacturing conditions may or may not be (statistically significantly) correlated with device performance, as will be explained below. The subject matter does not limit sets of manufacturing conditions to the specific examples described herein.

Before going into the functions within box 6, the collection of data from in-field end-user device A (4a) and device B (4b) will now be described. For illustrative purposes boxes 4a and 4b in the present embodiment represent a multitude of devices in use in the field by end-users. In some embodiments there may be fewer or more collections of devices (e.g., 4c, 4d, 4e . . . ), without restriction on the number of collections. If there is a plurality of collections of devices in the field there may be some that share one or more common types of elements, and others that have no elements in common at all. As explained above, devices 4a and 4b may have been produced by the same device manufacturer, or by different device manufacturers, unrelated to the element(s) included in each.

In the illustrated embodiments of FIG. 2, in-field data for end-user devices 4a and 4b may be produced. The in-field data for an end-user device may be produced by any element in the device (e.g. measured by a BIST circuit of the element) may be produced by the device itself (e.g. involving a measurement or function accomplished by means of a plurality of elements in the device), and/or may be produced by external sensor(s), instruments, equipment etc (e.g. environmental data, data indicative of state of device, data indicative of device performance, etc) and received by the device and/or local aggregator 5a/5b. For instance, at least some of the produced data may relate to the performance of those devices. It is noted that the performance of a device may at least partly relate to the performance of one or more of the various included elements but not necessarily.

As mentioned above, an end-user device may be an item that may be sold to or used by an end-user without undergoing additional assembly during manufacturing (although the end-user may be required to perform certain tasks and/or a technician may be required to install or activate the device before the initial operation of the device). It is noted that after initial operation of the device, the device may not always be fully operational. However, at any point in time, during or after initial operation, that the device may be capable of being operated, even minimally, and is not at that point in time undergoing maintenance or repair by a technician, nor returned (e.g. due to failure) the device may be considered to be in the field, and therefore data being produced during these times may be considered to be “in-field” data for the device (even if the data are transmitted later to box 6). For example, even if a device is not actively being used by an end-user, but is in an idle, standby, or ready/waiting state, the device may still be considered to be in the field. Also, even if a device encounters a problem and needs to be restarted by the end-user, the device may still be considered to be in the field. Similarly, if the device operates on a basic level so that the end-user may continue to use the device, even if some of the features are not present or not optimal (e.g. the device is running slower than should be, or harder to start up than should be), the device may still be considered to be in the field. As another example, the device may be updated while in the field, and whether the update is being performed by an end-user or by the device manufacturer remotely over a network connection, the device may still be considered to be in the field during the update. Similarly, a user seeking assistance with device configuration or usage may allow the device to be operated by the device manufacturer, or representative of the manufacturer or another third party, either remotely or in person, and the device may still be considered to be in the field during such an instance. It should be understood that the above examples are illustrative and the subject matter is not limited to these examples. The terms “in the field”, “in-field”, and variations thereof are used interchangeably herein.

In-field data produced by a device and/or elements in the device may include, for instance, attribute, parametric and/or function data. The subject matter does not limit the produced data but for the sake of further illustration to the reader some examples are now presented. For example, attribute data may include: name of device manufacturer, time of manufacture, software version, device performance specifications, device age, end-user, end-user type, time in service, abuse of device, device application information, device or element configuration information (e.g. firmware revision), electrical element identifier information, device and/or element environmental conditions, device and/or element use condition, device or element usage time periods (e.g. including if there is high usage), frequency of device or element events or operations deliberately or inadvertently occurring, device or element configuration details, modes of operation, date of data acquisition, information on the event triggering data acquisition, etc. For example, function data generated by a device or any element within) may include: results of BIST (and/or PBIT, IBIT, CBIT, POST, etc.), results of structural scan test readouts, error/status flag conditions, checksum data, etc., For example parametric data may include device level parametric measurements, diagnostics, etc. Parametric data (generated by a device or any element within) may relate, for instance, to the functionality provided by the device (e.g. device uptime), and/or may relate to the operational environment (e.g. temperature, overvoltage, motion detection, electromagnetic interference (EMI), etc.).

Enabled, for instance, through the design of devices 4a and 4b, and/or of the software being executed within these devices, in some instances, the generation (or in other words production) of these in-field data may be triggered by various events, such as receipt of queries and/or other data from outside the device, device conditions, environmental events, or time/frequency events. The subject matter does not limit the types of events, but for the sake of further illustration to the reader, some examples are now provided. In some examples, the triggering events may be selected so as to support the functions of box 6 (e.g. of data analysis engine 14). For example, in some cases, the trigger to data generation may be automatic so that the end-user may not have to participate in triggering the generation of the data, whereas in other cases the data generation may not necessarily be completely automated. For instance after a blue screen followed by a reboot, the device may ask the end-user if the end-user wants to generate a report that there is an issue in the field. In another instance, the end-user may use e.g. a user interface of a device to generate data by the device (e.g. relating to end-user satisfaction) which may be transmitted, as is, as in-field data and/or which may trigger the generation of other in-field data by the device (and/or by element(s) in the device). In another example, data may be generated by external sensor(s), instruments, equipment, etc., and may be received and transmitted as is, as in-field data by the device and/or may trigger the production of other in-field data by the device (and/or by element(s) in the device). In some cases, for example, the data generation may be routine, e.g. triggered at a certain frequency, whereas in other cases, the data generation may not necessarily be routine. For instance, a device may periodically run a check on the device, and “dump” the in-field data generated by the check. In some cases, for example, the data generation may be continuous, e.g. triggered at every time-point, whereas in other cases, the data generation may not necessarily be continuous. In some examples, the trigger may include any of the following: power up/down, reboot, execution of device diagnostics, execution of device mode changes, scheduled processes, encountering device faults (non-fatal error), entering/exiting operational modes, query, etc. A query, for instance may originate from box 6, or from another source external to the device (which may or may not be local to the device).

Regardless of the specific nature of the in-field data generated, or of the event, if any, causing the data to be generated, a given (in-field) data point may need to be analyzed with respect to the manufacturing data of one or more elements included in the device which generated the data point. For this to occur there may need to be traceability of the data point to one or more elements included in the device. It is noted that a device may not necessarily have full traceability for all elements included in the device.

In some examples, traceability may require that in-field data for devices 4a and 4b be transmitted along with identifying information regarding at least one of the specific device or specific device element associated with the data. The in-field data for a device may be automatically received and then loaded (e.g. by loading service 7) into database 10, indexed to the identifying information. For instance, this identifying information may enable these in-field device data to be linked in some cases in box 6 with related element manufacturing data and possibly also with device manufacturing data. Even though, some examples of identifiers for elements and devices were given above, certain identifiers are now discussed in more detail.

In some cases, the identifying information may be an identifier (e.g. ECID) associated with a particular element, generated through an electrical readout (e.g. e-fuse altered the electronic structure by programming which may then be read back) directly from the element. For instance, a device may be capable of polling one or more elements for these identifiers. Additionally or alternatively, the device may be capable of reading identifying information (e.g. serial number) associated with a particular element from where the identifying information was previously stored in the device (for example from a non-volatile memory in the device). For instance, in the event that a device receives an in-field data query, the response of the device to the query may depend on the device identifying itself as the subject of the query, based on the capability of the device to retrieve identifying information for itself or its own elements, such as device manufacturer, model or serial number, and/or possibly module or component manufacturer, serial number, or ECID.

In some cases, there may be both direct and indirect identification of elements of interest. For example, according to a hierarchy of elements within a device, an electrical readout of identifying information from a component included within a PC board (to be transmitted along with generated in-field data), may in turn be used for indirect identification of a specific PC board known to have been manufactured using the identified component. Similarly, the PC board identification may then be used for identification of the particular end-user device that is generating the present device data, based on an association between the identified PC board and the device known to have used that PC board in its manufacture. In this example, the manufacturing data of both elements (e.g. component and PC board) may be linked with the generated in-field data, based on an association between the device and its constituent elements. In some embodiments, identification of some elements may not be possible; for example, if in-field electrical readouts of one or more components of a device provide component identification, but module information is not available by any means, then the in-field data may be analyzed only with respect to the components whose identities are provided.

Therefore, in-field data which relate to a particular element in the device (e.g. BIST data from that element) may or may not be transmitted with identifying information for that particular element to box 6. For instance, this in-field data may instead be transmitted with identifying information of the device or of another element, e.g. perhaps in a situation where this in-field data are transmitted with other in-field data for the device. Similarly, in-field data which does not relate to a particular element in the device may or may not still be transmitted with identifying information for that particular element.

Optionally, in the illustrated embodiments, sub-assembly identifier data (box 9) may be transmitted (e.g. via the Internet) to box 6 and automatically received (e.g. by loading service 7). The receipt of sub-assembly identifier data at box 6 may not necessarily be synchronized with the arrival of other data at box 6. After sub-assembly identifier data 9 have been automatically received at box 6, the data may be automatically loaded by database loading services 7 into database 10, indexed to a device identifier associated with the sub-assembly identifier data and/or indexed to identifiers of one or more modules associated with the sub-assembly identifier data and/or indexed to identifiers of one or more components associated with the sub-assembly identifier data. The sub-assembly identifier data may, for instance, include identifiers of devices in association with identifiers of elements within the devices, and/or may include identifiers of modules in association with identifiers of sub-modules and/or components within the modules. It is noted that if both an identifier of a device in association with identifiers of included elements (where the elements include a certain module) is transmitted, and an identifier of the certain module in association with identifiers of included sub-modules/components is transmitted, the transmission of each may or may not be independent of the other. Associations between the identifiers may be stored in database 10 by database loading services 7, as described above. In some embodiments where sub-assembly identifier data regarding devices and elements in the devices are transmitted, a list (or any other data structure) of all (or relevant) sub-assembly elements included within the device may be made available for traceability purposes prior to or after the generated in-field data are transmitted. For example, such a data structure may be prepared at the time the device is manufactured, or may be made available at any time prior to the need to refer to manufacturing data of elements included in the device, by way of a device serial number, or any piece of data identifying the device, transmitted with the in-field data. In these embodiments, the device serial number or any piece of data identifying the device, may be transmitted with the generated in-field data rather the element identification, and may then be used for indirectly determining the identity of sub-assembly elements used in device construction, by reference to the previously received lists.

Additionally or alternatively, a list (or other data structure) of components/sub-modules may be prepared when a module including the components is manufactured. For instance, an ECID of a component may be read out during the testing of that module after the component that has been soldered onto a PC board, and then subassembly identifier data including the component identifier in association with the module identifier may be transmitted to box 6.

In the illustrated embodiments, the devices in the field producing data may optionally transmit the in-field data described above to a data aggregation node, such as shown as box 5a for devices 4a, and box 5b for devices 5a. If such an aggregation node is employed, data do not need to flow as a stream, but may be batched and uploaded in bulk. Alternatively, if such an aggregation node is not employed, in some embodiments in-use in-field data may also not necessarily flow as a stream, and may instead be accumulated over time on the end-user device and then be transmitted for processing in a batch. In some embodiments such batched data may be collected at an aggregation node in the course of in-field end-user device use, and may be uploaded in bulk at a later time while the device continues to function in the field. For example, if the data for various electronic devices within a vehicle are generated as the vehicle is being driven on the open highway, the data may be aggregated locally to non-volatile memory in the vehicle, to be eventually downloaded and transmitted as a data set to the box 6, including data generated and aggregated over many hours of vehicle use. Download and transmission of data may automatically occur, for example, when the vehicle is driven to a location within range of a usable Wi-Fi network. In another example, if the data from the vehicle's electronic device are generated every time the vehicle is started, the data may be aggregated locally to the vehicle in a non-volatile memory device, to eventually be downloaded and transmitted as an in-field data set to the box 6, say at a subsequent visit to an auto shop for service, including the results of data generated over hundreds of vehicle ignition events. A data aggregation node may be associated with only one collection of devices (as shown in FIG. 2) or with a plurality of collections of devices. Data aggregation nodes 5a and/or 5b may transfer the data to box 6 (e.g. via the Internet). For example, aggregated data may be transferred as an encrypted file to the receiving box 6 using an FTP protocol, via HTTP Web Services, through a RESTful implementation or any other standard or proprietary method of digital communication. In some embodiments, data aggregators 5a and 5b, if present, may be combined.

In embodiments in which data aggregation nodes 5a and/or 5b are not used, in-field data may be transmitted directly from the devices in the field to box 6 (e.g. via the Internet). For example, in the case of a set of cellular phone devices, each phone in the field may generate a series of device data upon power-up or power-down, and may immediately transmit those data on such an event to the box 6, without any data buffering or aggregation.

In the illustrated embodiment, out of service data (box 8) may optionally be transmitted to box 6 and automatically received at box 6 (e.g. by loading service 7). Out of service data may include maintenance data, return data, or repair data regarding devices and/or elements. It is noted that out of service data may not necessarily originate from the device manufacturer as the device manufacturer may not necessarily provide maintenance, repairs and/or receive returns. In some cases, these data may be received along with identifier data, and stored indexed to the identifier data. In some cases these out of service data may be linked to manufacturing data. The transmission of out of service data may be triggered by any event, such as changes in device status, device maintenance activity or, for example, if a device within an automobile produces diagnostic data every time the vehicle is brought to an auto shop for service (e.g. for maintenance and/or repairs), the data produced may be collected at the point of service, and then may be retransmitted to box 6, possibly aggregated with similar data from other vehicles and transmitted from the auto shop periodically as a batched set of data. Additionally or alternatively, in this example, the data generated from the vehicle's electronic device may be transmitted immediately after collection at the point of service. After out of service data have been automatically received at box 6 the data may be automatically loaded by database loading services 7 into database 10, indexed to a device identifier associated with these data, which in some embodiments may be the device identifier associated with other data in the database related to the device, such as device in-field end-user data, manufacturing data of elements within the device, etc. In some embodiments these various data may be linked before or during analysis, for example, to enable analysis of a possible relationship between device in-field data and out of service data on the one hand and manufacturing data of device elements on the other hand.

In the illustrated embodiment, adjunct data (box 20) may optionally be transmitted to box 6 and automatically received at box 6 (e.g. by loading service 7). Adjunct data may include environmental data produced by external sensors (and sent separately from in-field data), or may include data from other instruments in the field (that are external to the in-field end-user devices) indicating the state of the devices, for example, an odometer whose reading is transmitted as adjunct data to provide the mileage of an automobile within which an engine control unit (an in-field end-user device) is installed, potentially serving as the basis of an estimate of the ECU time-in-service. In some embodiments adjunct data may be generated by equipment external to the in-field end-user device that indicates something about device performance, for example, a router in a network may generate useful adjunct data on the frequency of packet retransmission for a computer on its network, which may reflect performance of a network card (an element) within the computer (an in-field end-user device, in this example). In some cases, these adjunct data may be received along with identifier data, and stored indexed to the identifier data. In some cases these adjunct data may be linked to in-field end-user device data and/or to element and/or to device manufacturing data. The transmission of adjunct data may be triggered by the generation or the transmission of in-field end-user device data, or by occurrence of events related to the generation of adjunct data (for example, the ignition of an automobile causing an odometer reading to be transmitted), or by passage of a fixed interval of time, to name a few examples. Adjunct data may possibly be aggregated with similar data and transmitted periodically as a batched set of data. Additionally or alternatively, adjunct data may be transmitted immediately after generation. After adjunct data have been automatically received at box 6 the data may be automatically loaded by database loading services 7 into database 10, indexed to a device identifier associated with these data, which in some embodiments may be the device identifier associated with other data in the database related to the device, such as device in-field end-user data, manufacturing data of elements within the device, time and/or location of generation of adjunct data, etc. In some embodiments adjunct data may be associated with device data using an element identifier of an element within a device, for example, in the example provided above of adjunct data generated by a router in communication with a network card included as an element in a computer, the element identifier may be provided with the adjunct data being transmitted by the router, and may then be used to associate those adjunct data with the computer that includes the particular network card. In some embodiments these various data may be linked before or during analysis, for example, to enable analysis of a possible relationship between device in-field data and adjunct data on the one hand and manufacturing data of device elements on the other hand.

As mentioned above, environmental data generated by one or more sensors external to a device may be received by the device, to be included and transmitted to box 6 as in-field end-user device data. Additionally or alternatively, as mentioned above, environmental data generated by one or more sensors external to any device may be cached with other in-field end-user device data locally, for example at local aggregator of in-field data 5a/5b, to be included and transmitted to box 6 with in-field end-user data of one or more associated devices. Additionally or alternatively, as mentioned above environmental data generated by one or more sensors external to any device may be transmitted to box 6 as an adjunct (box 20) data stream independent of a device in-field end-user data stream or data set. In some of these embodiments, in addition to environmental data generated by sensors external to any device, data generated by the sensors and transmitted to the device, to aggregator 5a/5b and/or to box 6, may include various data at least partly identifying the source of the environmental sensor data and/or identifying the one or more devices associated with those data, including for example, the time and location of environmental data generation, and the identity of one or more devices associated with the environmental data. In some cases, similar various identifying data may be generated and transmitted by instruments and/or equipment that are external to any device.

In some embodiments, database 10 may therefore include in-field data, component and module manufacturing data, and other data (e.g. device manufacturing data, out of service data, sub-assembly ID data, adjunct data, identifier information, etc). The included data may include the data as received and/or data computed on the basis of received data.

Although the example of transmission via the Internet was given for the transmission of data described above, the subject matter does not limit the transmission means, protocols or frequency used for transmitting data to box 6. For instance, for a particular data point the means of transmission may include: the Internet or any other wide area network(s), local area network(s) (wired and/or wireless), cellular tower(s), microwave transmitter tower(s), satellite communication(s), automotive telemetry technologies, etc. The protocols used for transferring the data may be any appropriate protocol for the means of transmission. Data may be transmitted in real time to box 6, as generated, or may be stored locally or remotely from the location of generation and then transmitted in batches, based on a time trigger (e.g. periodically) or any other trigger. For example, in-use in-field data may be accumulated over time on the end-user device and may then be transmitted for processing in a batch. Data receipt at box 6 may additionally or alternatively be semi-automatic or manual, for instance with a person (e.g. employee of the provider of box 6) indicating approval prior to data being received via any appropriate means, or for instance a person physically performing the data transfer such as via a data storage device (e.g. disk on key), an interface for manual input (e.g. keyboard), etc. Depending on the embodiment, any data that is received at box 6, may be pushed to box 6 (i.e. received without prior initiation by box 6) and/or pulled by box 6 (received after initiation by box 6).

As discussed above, manufacturing data transmitted from boxes 1-2 (and possibly 3) and in-field data transmitted from boxes 4a/4b or 5a/5b, (and optionally out of service data, and/or sub-assembly ID data) may be sent (e.g. over the Internet) to box 6. Box 6 may be made up of any combination of software, hardware and/or firmware that performs the function(s) as described and explained herein for box 6. For example, box 6 may include one or more processors for performing at least part of the function(s) described and explained herein for box 6. For the purpose of illustration, box 6 is shown in the illustrated embodiments as a cloud-based entity. The cloud based entity may include one or more servers (where the one or more servers may include one or more processors), located either in the same physical location or in multiple locations and connected through any type of wired or wireless communication infrastructure. Ownership and/or administration of these servers may be by any of the related parties or any third-party. Examples of a cloud based entity may include data centers, distributed data centers, server farms, IT departments, etc. The term cloud in this disclosure does not necessarily imply the standard implementations such as IAAS, PAAS, SAAS (respectively, Infrastructure, Platform or Software As A Service). In terms of hardware, the cloud may be implemented on any combination of types of computer hardware capable of providing the functionality required. The deployment may use physical and/or virtual servers and/or standard servers provided by cloud service companies such as Amazon LLC. This may include dedicated appliances such as in-memory databases; commodity servers such as those used for Hadoop and NoSQL solutions; storage solutions which are either built into the servers themselves or provided separately (such as NAS) and/or any other similar types of implementation. It is also possible that box 6 may not be a cloud entity. Box 6 may include one or more servers, even if box 6 is not a cloud based entity. In some cases functionality attributed to box 6 herein may additionally or alternatively be performed by other boxes shown in FIG. 2, or vice versa. Additionally or alternatively, in some cases, functionality attributed to box 6 may be performed by a “box” which may be an integration of box 6 and one or more other boxes shown in FIG. 2.

Although database 10 is shown for simplicity of illustration in box 6, in some embodiments, storage may be separate from the server(s) (e.g. SAN storage). If separate, the location(s) of the storage may be in one physical location or in multiple locations and connected through any type of wired or wireless communication infrastructure. Database 10 may rely on any kind of methodology or platform for storing digital data. Database 10 may include for example, traditional SQL databases such as Oracle and MS SQL Server, file systems, Big Data, NoSQL, in-memory database appliances, parallel computing (e.g. Hadoop clusters), etc. The storage medium of database 10 may include any standard or proprietary storage medium, such as magnetic disks or tape, optical storage, semiconductor storage, etc. Database 10 may or may not be uniform in terms of the content of the data loaded, the frequency, the methodology, and/or data usage permissions (e.g. for various operators affiliated with the various manufacturers and/or affiliated with third party/ies such as the owner(s) or manager(s) of box 6). Database administrator 15, when included in box 6, may be used to perform automatic administrative functions related to maintenance and management of the database and ensure its correct functioning. These functions may include installations, upgrades, performance monitoring and tuning and any other administrative task required. In some cases the cloud service may be used via Clients (boxes 11x and 11y of FIG. 2—collectively Clients 11) by more than one customer (e.g. element manufacturers(s), device manufacturer(s), etc.). In these cases the operator of Database administrator 15 (where the operator of Database administrator 15 is a user that may use database administrator 15) may need to be “neutral” and not be an employee of any of these customers. This requirement may ensure that access to privileged data belonging to one of the customers is not abused.

The arrival, inter-alia of manufacturing data transmitted from boxes 1-2 (and optionally 3) and in-field data transmitted from boxes 4a/4b or 5a/5b at box 6 may not be synchronous, since typically manufacturing data are generated long before end-user in-field device data are generated. When these data are automatically received (e.g. by loading service 7), the data may be processed by Database Loading Services 7. These services may prepare the arriving data for loading into database 10. The preparation of the data may include unencrypting the data, classifying a data set according to metadata included with arriving data, error checking data for integrity and completeness, parsing and organizing the data according to the desired content of the database, formatting the data to meet data input file specifications required for database loading, decoding data for human readability and/or compliance with standards, data augmentation (also referred to as data merging), and/or reformatting data for human readability and/or compliance with standards. For example, previously received data may be merged with the arriving data prior to database loading. Continuing with this example, if in-field data are to be loaded with a list of identified sub-assembly elements used in the construction of the device that has generated the arriving data, those data received from box 9 may be merged with the arriving in-field data based on the identity of the corresponding device, prior to database loading. Classifying a data set according to metadata may include, for example, identifying a manufacturing line item or part number (e.g. a specific type or model of element or device which is unique from others in terms of design, configuration, and/or manufacturing process specification) in a data stream or in a data file structure, corresponding to a given data set, and/or identifying a manufacturing operation in a data stream or in a data file structure, that was the source of data of a given data set. Continuing with this example, data may be parsed and organized according to the specific part number and/or operation identified. Error checking data for integrity and completeness may be performed, for example, in terms of the data structure received (e.g., the number of records and data fields found versus expectation), and in terms of data content, such as the consistency between the data of various fields and the expected data syntax. In some cases of this example, a range or a set of expected values may be compared to the data received; for example, for an identified element, verifying that the element ID is found in a list of known IDs, or for manufacturing equipment, verifying that IDs found in data fields identifying equipment are in a list of known equipment. Although not necessarily so, formatting or reformatting may be required to ready the data for importing to database 10, after or during other preparation activities such as parsing and validation (or in other words error checking) of the data.

In some embodiments, preparation of data may not be needed, or may only be needed for certain data. For instance, in some examples only identifier data, but not other data, may be decoded or in other words transformed into a meaningful consistent format. In other examples other data may also be decoded, and in still other examples no data may be decoded. In some embodiments, there may be a plurality of database loading services, each of which prepares and/or loads different types of data, or there may be a separate preparation but shared loading.

As the in-field data arrive they may be databased in such a way to be subsequently retrievable with previously databased manufacturing data for an element, for example by establishing a database index between the element identifier and the in-field data and/or by linking the in-field data to the element manufacturing data. For instance linking may include associating indexed identifier fields of the manufacturing data to indexed identifier fields of in-field device data, and joining records between the two domains based on the association.

As mentioned above, in some cases, functionality attributed to box 6 may be performed by a “box” which may be an integration of box 6 and one or more other boxes shown in FIG. 2. For example, the functionality of “receiving” that is attributed herein to box 6, may include functionality attributed herein to one or more other boxes shown in FIG. 2. Continuing with this example, in some cases, the receiving of data (attributed herein to box 6) may in fact include collecting and/or aggregating data, such as component, module, and/or device manufacturing data, in-field data, out-of-service data, adjunct data, sub-assembly id data, etc. For instance, assume that in some of these cases box 6 may be integrated with any of 1, 2, 3, and/or 5 (a and/or b). In these cases, if box 6 is integrated with box 1, 2, and/or 3, the receiving of component, module and/or end-user device manufacturing data may include the collecting and/or aggregating of component, module and/or end-user device manufacturing data. For another instance, if box 6 is additionally or alternatively integrated with box 5a and/or 5b, the receiving of in-field data may include the aggregating of in-field data. Similar instances may result if box 6 is additionally or alternatively integrated with boxes 8, 20 and/or 9. In any of these instances, there may be no need to transmit data from box 1, 2, 3, 5, 8, 20 and/or 9 to box 6, if box 6 is integrated with box 1, 2, 3, 5, 8, 20, and/or 9, respectively, and the data is therefore already “received”.

In the illustrated embodiments, data in database 10 of Figure A may be analyzed (e.g. by data analysis engine 14) once the data have been linked or even if not linked Consider an example of device in-field data quantifying the frequency of error correction events occurring while accessing data from a memory component of the device. This in-field data may be databased, for instance, with an index to identifying information for the particular constituent component in the device. If an index to the same identifying information is used for manufacturing data for the same constituent component, then the frequency of error correction events observed in-field for the particular memory component may be analyzed vis-a-vis any of the manufacturing data of the component, potentially enabling identification of one or more sets of manufacturing process condition(s) that relate to frequency of such error correction events. Continuing with this example, if it is known by the memory component manufacturer that a high frequency of error correction events in a device in the field is a leading indicator of component failure, and it is found that there is a correlation between a particular set of manufacturing condition(s) and a high error correction event frequency (and therefore sub-optimal performance in the field for the device), then devices in the field constructed with memory components whose manufacturing corresponds to the problematic set of manufacturing condition(s) may be recognized as being at risk, and appropriate actions may be taken e.g. to recall those devices before failure actually occurs. Additionally or alternatively, having identified such a correlation, actions may be taken, e.g. to correct the problematic manufacturing condition(s) which distinguished the set of manufacturing condition(s) from other sets of manufacturing conditions which produced components that were not found to have a high error correction event frequency.

Conversely, if the component manufacturer observes data from the manufacturing process that is believed to induce a high frequency of error correction events during in-field memory read operations, the manufacturer may set criteria for distinguishing a set of manufacturing condition(s) and in-field data arriving subsequently from multiple devices may be used as corroborative evidence that the memory components produced from a suspect set of manufacturing condition(s) are putting device reliability at risk, or not.

It should be noted that in some embodiments of the above examples, the memory components of interest may have been used in construction of several types of devices deployed to the field, illustrated in Figure A boxes 4a (In-Field End-User Device A) and 4b (In-Field End-User Device B). Although the collections of devices A and B (for example, produced by different device manufacturers for entirely different applications or markets) may be of different types, similar in-field data may be generated and databased for each device type, providing a more complete set of data for the memory component manufacturer to refer to in the above analysis than would be available if data from only a single type of device were available. For example, if a high error correction rate is seen for memory components fabricated under a given manufacturing condition in a variety of types of devices, then it may be likely that the high error correction rate is correlated to the given manufacturing condition, unrelated to device type. On the other hand, if a high error correction rate is seen for memory components fabricated under a given manufacturing condition but are always observed in devices of the same type and not in other device types, then the high error correction rate may not be simply correlated to the given manufacturing condition, but in addition or instead may likely be correlated to the given device type. In this case it may be likely that the high error correction rate is related to an issue specific to the device type (e.g. device design, software problem, incorrect usage, device environment, etc.), possibly exacerbated by or triggered by the given manufacturing condition of memory fabrication.

In the above embodiments and in the embodiments that follow, the terms “correlation”, “correlating”, “statistically significant”, “statistically significant correlation”, “statistically significant difference” and the like may be used in describing the assessment of data or data computed on the basis of data. The meaning of such terms will now be explained.

The Merriam-Webster on-line dictionary defines “correlation” as being “the state or relation of being correlated; specifically: a relation existing between phenomena or things or between mathematical or statistical variables which tend to vary, be associated, or occur together in a way not expected on the basis of chance alone”. This definition may be largely suitable for the purposes of the present subject matter, although it should be understood that in what follows the term “relationship” may often be used as an alternative to the term “relation” of this definition, where “relation” or “relationship” may be intended to mean the way two or more things are related.

The meaning of the related verb forms “to correlate” or “correlating”, as used in various ways in the present subject matter, may also be cited from the Merriam-Webster on-line dictionary, including the intransitive verb defined as “to bear” (or bearing) “reciprocal or mutual relations”, and also the transitive verb defined as “to establish” (or establishing) “a mutual or reciprocal relation between” or “to show” (or showing) “correlation or a causal relationship between”.

When an apparent correlation has been observed in the assessment of data or data computed on the basis of data, it may be frequently beneficial to determine the significance of the observation relative to a reference observation, in order to know to what degree the observation may have occurred randomly, if in fact there is no underlying “relation existing between phenomena or things or between mathematical or statistical variables” (per above definition). The significance determined may be used as the basis for concluding whether the apparent correlation is an actual correlation, or not.

A determination of significance may often be made statistically, as in the following excerpt from a standard text used in the field of experimental data analysis, which describes a process for deciding whether a result observed after modification of a process is due to chance variation or whether it is exceptional:

“To make this decision the investigator must in some way produce a relevant reference distribution that represents a characteristic set of outcomes which could occur if the modification was entirely without effect. The actual outcome may then be compared with this reference set. If it is found to be exceptional, the result is called statistically significant.” (Statistics for Experimenters. Second Edition. By G. E. P. Box, J. S. Hunter, and W. G. Hunter Copyright © 2005 John Wiley & Sons. Inc; pages 67 and 68).

An embodiment corresponding to the cited excerpt may be one in which conditions of generating a set of outcomes of an experiment may be controlled, which is included among some of the embodiments of the presently disclosed subject matter. For example, a manufacturer of electronic elements may be either considering making a change to the manufacturing process, or may have already made a change, and may want to evaluate what effect the change might have, or has had, on the performance of the devices produced by the customers of the electronic element manufacturer. In such an embodiment, the set of manufacturing condition(s) of interest may be known a priori, and the impact on in-field performance of the devices built using elements manufactured under the modified conditions may not be known. The method of significance testing may be applied to evaluate multiple in-field performance data, metrics, or indicators to assess the impact. In some embodiments the electronic element manufacturer may not have made a change to the manufacturing process deliberately, but may know of an inadvertent change, and may wish to assess its impact on in-field device performance using the method of significance testing. In some of the embodiments mentioned here, the “relevant reference distribution” referred to in the above citation from Box, Hunter, Hunter may be derived from a population of elements whose manufacturing does not correspond to this set of manufacturing condition(s). The relevant reference distribution may then be used in deciding whether or not there is a statistically significant difference in the performance of end-user devices in the field between devices including elements manufactured with a change of interest, and devices including elements whose manufacturing does not correspond to a change of interest. The calculation of the statistical significance of a difference is one application of significance testing described above, and may be performed by means of various well-established methods from the field of statistics appropriate to the observed result, for example, using Student's t-test to evaluate the null hypothesis that the means of two populations are equal to a given level of statistical significance, when the two populations follow a normal distribution and the variances of the two populations are roughly equal.

In some embodiments an electronic element manufacturer may not have made a change to the manufacturing process deliberately and also may not be aware of an inadvertent change, but may wish to assess a relationship between manufacturing data of recently manufactured elements to in-field end-user device data using the method of significance testing, using a reference relationship based on similar historical data and/or modeled data. In such embodiments the electronic element manufacturer may identify a statistically significant difference between the relationship and the reference relationship. Based on this result, the manufacturer may conclude that correlated in-field data are inconsistent, and/or correlated manufacturing data are inconsistent, relative to the data of the reference relationship. For example, if the in-field rate of laptop battery discharge has been demonstrated in historical correlation to be directly proportional to laptop CPU active power logged during component manufacturing test operations, as demonstrated by a good fit of data to a line of a given slope and Y-intercept determined by linear regression, it may be expected that the observed correlation would continue to hold in currently produced CPUs and laptops. To verify this, a similar correlation analysis could be repeated on recently produced laptops and their CPUs, and results could be statistically compared to the historically observed correlation. For example, using the two sets of data (historical data and recent data) the R-squared statistical measure of goodness-of-fit to a line of recent data could be compared to the historical R-squared value, and for the best-fit line calculated for the recent data, a statistical comparison could be done to determine the difference in its slope and Y-intercept to the slope and Y-intercept of the best-fit line based on historical data, to a given statistical significance level.

In some embodiments there may be an issue related to in-field device performance identified and reported by end-users of devices, not necessarily initially identified as correlated to any change in a set of manufacturing condition(s) of the electronic elements included in the subject in-field end-user devices. In such an instance, an operator of the system of FIG. 2 may use a client 11 to define a performance metric specifically to indicate and/or to quantify such an issue in analysis of in-field end-user device data by data analysis engine 14. For an illustrative example, some end-users of a certain model of laptop computer may report intermittent system “lock-up” events to the laptop manufacturer which may frequently occur on resuming from an operational sleep mode, motivating an operator of the system of FIG. 2, employed by the laptop manufacturer, to define a related performance metric, such as (total instances of system shutdown immediately following end-users initiating resume from sleep mode) divided by (total instances of end-users initiating sleep mode), which may then be used to search for correlating sets of manufacturing conditions, as described below in Numbered Example #1. Note that in some embodiments a performance metric may be defined in such a way that an undesirable characteristic of device performance is measured, for example with higher values of the metric corresponding to worse performance than lower values, while in some other embodiments a performance metric may be defined in such a way that a desirable characteristic of device performance is measured, for example with higher values of the metric corresponding to better performance than lower values. It should also be noted that in some embodiments a performance metric may be defined in such a way that a categorical description of performance is produced, rather than a numerical value, for example, determining device classification according to one or more performance criteria and then describing device performance by classification. In some other embodiments, an issue related to in-field device performance may be initially identified automatically or semi-automatically using data analysis engine 14 of FIG. 2 for analysis of in-field data, in conjunction with analysis of manufacturing data, for example in an analysis to determine whether or not there is a difference in correlation of device performance data (e.g., data computed based on received in-field device data) to manufacturing data (e.g., received data relating to manufacturing of elements included in devices) under differing sets of manufacturing conditions, as described below in Numbered Example #2. In some other embodiments, an issue related to in-field device performance may be initially identified automatically or semi-automatically in the course of attempting to confirm an expected relationship between device performance and manufacturing data, as described below in Numbered Example #3. For instance, a reference population of in-field end-user devices may be identified on the basis of compliance of device data to a criterion based on a performance metric, and then in-field device performance data of this reference population of devices may be used to define one or more relationships with some of the manufacturing data of elements included in the reference devices. It may then be determined whether or not there is a statistically significant difference between such a reference relationship(s) (derived from performance data of reference devices and manufacturing data of elements included in the reference devices), and a similar relationship(s) based on the data of a non-reference population of in-field end-user devices (other devices) (derived from the corresponding performance data of other devices and corresponding manufacturing data of elements included in the other devices), and therefore it may be concluded whether or not performance data are consistent to manufacturing data. Additionally or alternatively, in such an embodiment, some reference relationship(s) may be modeled rather than being derived from data of a reference population of devices, in which case it may be concluded whether or not performance data are consistent to manufacturing data by determining if there is a statistically significant difference between a relationship and a reference relationship based on a modeled version of in-field data and/or a modeled version of manufacturing data.

It should be noted that depending on the embodiment various distribution metrics and mathematical and/or logical treatments may be used in the application of the method of significance testing, for the purpose of comparing data of a subject population to that of a reference population. Determination of whether or not a difference is “statistically significant” (or whether an outcome, compared with a reference set “is found to be exceptional”, per Box, Hunter, Hunter), may be made by statistical analysis of, but not limited to, differences in population central tendencies, spreads, histograms, parametric distributions, non-parametric distributions, minima, maxima, quantiles, modalities, failure rates, failure frequencies, failure probabilities, and other related statistical descriptors.

Furthermore, it should be noted that in-field device performance may be variously determined, depending on the embodiment. In some embodiments, in-field performance may be quantified by a performance metric, which may be used as an indicator or predictor of device reliability, or of device compliance to specifications, or of any device attribute of interest, e.g., to end-users and/or to device manufacturers. Performance metrics that may be of value to the manufacturer of the device may include, for a few examples, a measure of the degree to which the manufactured device is operating in the field in a manner consistent with specifications, or the rate of occurrence of intermittent device glitches under extreme or under nominal environmental conditions, where such a glitch is a short-lived fault in the device that does not render the device permanently unusable, often in the form of a transient fault that corrects itself or may be corrected while the device remains in the field. In some embodiments in which a performance metric includes data related to the environmental conditions under which a device is operating, the environmental data may be received from a sensor external to the device itself. As an example, a performance metric may be based on the frequency of device glitches when voltage spikes occur in a power grid providing operating power to the device, based partly on data generated by a voltage spike sensor on the power grid and partly on operational data generated by the devices.

In some embodiments, a performance metric may be based on data computed on the basis of received in-field data, mathematically or logically combined as appropriate for the purposes of the particular performance metric desired. In some embodiments a performance metric may be based on one or more types of received data, applied in their raw form without mathematical manipulation. Identification of received in-field device data or data computed on the basis of received in-field device data to use as a performance metric may be defined and provided purely by human insight, or purely by execution of machine algorithms (e.g. by data analysis engine 14), or by a combination of the two. The result may be identification of a performance metric based on a single data field, or one based on a mathematical or logical combination of several data fields.

In some embodiments a performance metric may also be partly dependent on the specifications of the device, and in such embodiments the goodness of in-field performance may be a function of both in-field end-user device data and the specifications of the device generating the data, as received and/or as computed based on received data. For example, a performance metric may be at least partly defined by the degree to which a device is operating to specifications, such as whether or not the device is compliant with government specifications and regulations, and/or is compliant with industry specifications and standards, or is compliant with the device manufacturer's product specifications. In such embodiments, device data may be compared to values specified and a resulting performance metric may reflect the degree of device compliance (or deviation) to those values, for example in terms of percent deviation of a population mean or median from a central value between upper and lower spec limits, or in terms of a Cpk measure to an upper or to a lower spec limit. Any suitable statistical metric may be applied. Since device compliance to such specifications is sometimes guaranteed by compliance of elements within devices to element specifications, it is plausible that an element manufacturing test operation issue such as tester to tester calibration errors may, for example, be identified by analyzing the relationship between such a device performance metric and the tester(s) used to perform manufacturing test of elements included with devices. For example, a first population of elements may be identified whose manufacturing corresponds to use of a particular tester in manufacturing to test the elements of the first population (which is not the tester used in in manufacturing to test the elements of a second population). In this example, the set of manufacturing condition(s) may be usage of the particular tester in manufacturing. It may then be determined whether or not there is a statistically significant difference between in-field end-user performance of devices including elements of the two populations using a performance metric indicating the degree of spec compliance (as described above), to conclude whether or not a correlation between the use of a particular tester in manufacturing and the performance metric exists.

Additionally or alternatively, continuing with the above example, a criterion based on such a performance metric may be applied to in-field end-user device data to distinguish a first and a second population of devices, and then the manufacturing data of elements included in each of the two populations may be compared to determine whether or not there is a statistically significant difference between associations of the manufacturing data of the populations with the use of a particular tester in manufacturing to test the elements included in each of the populations. Again in this example, the set of manufacturing condition(s) may be usage of the particular tester in manufacturing. Depending on whether or not such a statistically significant difference exists, it may be concluded whether or not a correlation between the performance metric and the use of a particular tester in manufacturing exists. In this example, the word “association” in the phrase “associations of the manufacturing data of populations with the use of a particular tester” is used to describe the connection or relationship between a set of one or more manufacturing conditions and the manufacturing data of a defined population of elements (defined in the present example by device performance), possibly ranging from not being found in any of the manufacturing data of elements of a population (i.e., no association existing between manufacturing data of a defined population and a particular tester in the example) to being found in manufacturing data of all elements of a population (i.e., 100% association existing between manufacturing data of a defined population and a particular tester in the example), or at some level of association between these two extremes. For instance, the manufacturing data for a specific element may include the name and/or other data on any testers used for that element, and if the manufacturing data for the specific element includes the name and/or other data on the particular tester than the manufacturing data for the specific element may be considered to be associated with usage of the particular tester (and therefore associated with the set of manufacturing condition(s) defined for this example). If, for instance, 90% of the elements of the first population of this example were found (from manufacturing data thereof) to have been tested using a particular tester (strongly associated), while only 10% of the elements of the second population were found to have been tested on the particular tester (weakly associated), then one might conclude on the basis of the difference in association found between the manufacturing data of each of the two populations to the particular tester, that a correlation exists between the observed device performance problem and the use of the particular tester in the manufacture of elements included in devices.

In some embodiments, a performance metric may also be partly dependent on other data, such as out of service data and/or adjunct data, and in such embodiments the goodness of in-field performance may be a function of both in-field end-user device data and the out of service data and/or adjunct data, as received and/or as computed based on received data. For instance a performance metric that may be of value to the manufacturer of the device may include a measure of how frequently the device requires service.

In some embodiments a given performance metric may have meaning or have relevancy for one type of device but not for another type of device, and in such cases distinguishing device populations by in-field performance may be augmented by distinguishing the device populations also by one or more criteria that are not specifically performance-related, such as by date of device manufacture, location of device usage, and/or types of device usage, to name a few examples.

In some embodiments a performance metric may be defined according to prior knowledge, depending at least partly on historical data related to the device or type of device; for example, data regarding the manufacturing, service, operational, or failure history of an individual device or of a given type of device. For example, if there is a known risk to a device or given type of device based on such historical data, a performance metric for a device or similar devices in the field may be defined also based on that data in conjunction with current in-field data, as received and/or as computed based on received data. For example, if it is noted through an analysis of a series of in-field device measurements that the seek times of disk drives in some of the devices in the field of a given device type are drifting and are becoming longer over extended periods of device usage, followed eventually by disk drive failure, then a performance metric may be defined based on that analysis to target devices, prior to failure, that are exhibiting such disk drive seek time drift. In such embodiments, the appropriate performance metric may not be known a priori, but may be identified based on an analysis of historical in-field device data to identify the data fields most significantly influencing the device behavior of interest. Continuing with the example presented here, it may have not initially been known that disk drive seek time drift was often a precursor to disk drive (and device) failure, but may have only been recognized after analysis of trends of data contained in a number of device data fields generated by a large number of disk drives in the field, to determine which types of data may exhibit a trend of performance degradation over time, and based on historical data, is also likely to precede disk drive failure. The identification of such a combination of characteristics in historical data, for example in disk drive seek time data, may be motivation for using it or a degradation trend based on it, as a device performance metric.

For embodiments requiring analysis of in-field device data (and optionally other data) to identify an appropriate performance metric, such as the ones discussed above, data analysis may be performed by various techniques, including univariate analysis, bivariate analysis, multivariate analysis, design of experiments (DoE), exploratory data analysis, ordinary least squares, partial least squares regression, pattern recognition, principal component analysis (PCA), regression analysis, soft independent modeling of class analogies (SIMCA), statistical interference, and other similar approaches.

The subject matter is not bound by these embodiments regarding in-field performance and performance metrics.

Continuing with the description of box 6, after in-field end-user device data and element manufacturing data have been suitably databased, various types of analyses of the received data and/or data computed based on the received data may be performed. In some embodiments of Data Analysis Engine 14, various functions may be provided to perform data analysis. Data analysis may be instigated due to any event such as the events described below with reference to rules. Additionally or alternatively, operators may instigate on-demand data analysis based on at least one criterion provided by Clients 11x, 11y (associated with these operators). The various types of data analyses which may be performed, include the following:

1) Discovering correlation of a known device-level performance anomaly in the field to a set of manufacturing condition(s), (e.g. through systematic statistical analysis of element manufacturing data and/or in-field device data), or alternatively demonstrating the absence of correlation of device-level anomalies in the field to any such set of manufacturing condition(s). For instance, a performance anomaly may include an undesirable performance, a low performance, an unreliable performance, etc. Continuing with this instance, a low level of performance may be correlated to a flawed set of condition(s) under which the elements were manufactured. In some embodiments a flawed set of condition(s) under which elements are manufactured may result in those elements being targeted by the element manufacturer for scrapping (e.g. due to being failures or outliers). Thus, discovery that such elements have been included in in-field devices may lead to researching why they were not actually scrapped. The set of manufacturing condition(s) to which the low level of performance is correlated in this instance may include “scrap” disposition and/or the flawed conditions. For example, if poor in-field device-level performance is demonstrated for a population of particular devices that includes particular elements, it may be determined that the manufacturing data of the particular elements and/or devices are strongly associated with the set of manufacturing conditions. As an illustration, if a batch of packaged components has been processed through a manufacturing burn-in operation and has exhibited an exceptionally high failure rate in a test operation following burn-in (indicating a potential reliability problem), the batch of components may be sent to a manufacturing scrap location, and a “scrap” designation for the batch may be entered into the manufacturing database. If the material is later removed without manufacturer authorization and is fraudulently sold into component black market channels as normal material, the bad components may be included in end-user devices, where they may eventually fail.

Additionally or alternatively, identifying information may be used to determine fraud. For instance, if poor in-field device-level performance is demonstrated for a population of particular devices that includes particular elements, it may be determined based on the identifying information of the particular elements or devices that the elements or devices were dispositioned in manufacturing as scrap material. Continuing with this instance, the particular elements or devices may have been erroneously or fraudulently put back into use in spite of being dispositioned as scrap material during manufacturing. In another instance, if the identifiers of the particular elements or devices are not found at all in the available manufacturing data set, it may be an indication that the elements or devices may be counterfeit, and may not have actually been produced by the legitimate manufacturer of the nominal element or device product being used by end-users in the field.

Such an analysis may, for instance be followed by generation of an output report by data analysis engine 14 referenced by human(s) to assess and act on potentially problematic manufacturing conditions, or alternatively to seek the root cause of the device anomalies elsewhere (e.g. device design, software problem environment, usage, etc.). For example, the report may include a high level description of a grouping of elements whose manufacturing corresponds to the set of manufacturing condition(s) (e.g. elements from a certain lot), a list of the elements (e.g. ECIDs), etc.

The problem described in the background of this application, involving a 2011 Apple MacBook Pro manufacturing issue, may be useful as an example of the potential application of analysis of in-field data to distinguish device populations for determining element manufacturing differences between populations. In the class-action lawsuit stemming from this problem it was stated that device failures were the result of using lead-free solder to connect the laptop GPU to the motherboard, which in conjunction with repeated large temperature swings (so called, “stress cycles”) caused intermittent failure occurrences when laptops were in use by end-users. In this example, in-field performance may be quantified by a performance metric. The performance metric may usefully be defined by the frequency of a laptop glitch—for example by dividing data of the logged number of glitch occurrences by data of the logged number of hours of laptop use. To further refine the metric, the glitch frequency calculation may be multiplied by the average peak GPU operating temperature to weight failures associated with GPUs operating at higher temperatures more heavily than failures associated with GPUs operating at normal/lower temperatures. For such a performance metric a high calculated value based on the in-field data of a given laptop may be indicative of the particular problem described in the lawsuit. Continuing with this example, after distinguishing two populations of laptops by high or low values of this performance metric, it might be expected (based on the assertions of the lawsuit) that a statistically significant difference between the two populations of laptops may be found in the association of their wave solder processing data to lead-free solder use (in this case the manufacturing condition of interest), with strong association of laptops with high performance metric values to the use of lead-free solder processing, and weak association of laptops with low performance metric values to the use of lead-free solder processing.

2) Identifying correlation of a defined set of manufacturing condition(s) to device performance anomalies in the field. Such analysis may, for instance, be followed by generation of an output report by data analysis engine 14, referenced by, say a manufacturer, to assess and act on potential device reliability issues (e.g. remove from use devices with potential device reliability issues through proactive recall and/or retirement, remove from use problematic element by purging stores of these elements so these elements will not be placed in devices, performing reconfiguration of devices to avoid issues such as through in-field firmware updates, etc.). For example, the report may include a high level description of a grouping of devices at risk (e.g. devices including elements from a particular manufacturer), a list of devices at risk (e.g. serial numbers), etc. Also, in such cases where no device-level anomalies are found to correlate, unnecessary or misdirected action by the element manufacturer may be avoided.

For instance, a module builder may switch to using lead-free solder, and after converting the manufacturing process, may want to confirm that over an extended period of time that there is no observed impact to in-field performance attributable to the change. A product engineer, for instance may make a change to a component test program, for example to eliminate several tests, or to change test limits Following this, the engineer making the change may want to confirm that there is no observed impact on in-field performance attributable to the change. A test factory engineer, for instance may discover that a particular tester has been running with an inadvertent measurement offset between test sites over a period of time, and may want to confirm that there is no statistically significant difference between elements processed on the two test sites in terms of in-field performance of devices containing the elements from the two test sites. A component Q&R engineer, for instance, may want to determine, based on in-field performance, whether or not there is a statistically significant difference in devices constructed using components from die near wafer-center than those built from die near wafer-edge. A component Q&R engineer, for instance, may want to determine, based on in-field performance, whether or not there is a statistically significant difference in devices constructed using components with parametric measurements very close to specification limits and components with parametric measurements far from specification limits A component Q&R engineer, for instance, may want to determine, based on in-field performance, whether or not there is a statistically significant difference in devices constructed using components with very different WAT structure test results.

In some embodiments, analysis such as described in the preceding paragraphs (with respect to 1) and 2)) may support one of five scenarios. First, an element manufacturing issue relating to a set of manufacturing condition(s) has been observed, but no (statistically significant) correlation to device performance is found. Second, device performance issue has been observed, but no (statistically significant) correlation to a set of manufacturing condition(s) is found. Third, there is no known element manufacturing issue, and no known device performance issue, and therefore correlation is irrelevant. Fourth, element manufacturing issue relating to a set of manufacturing condition(s) has been observed, and a (statistically significant correlation) to device performance is found. Fifth, device performance issue has been observed, and a (statistically significant) correlation to a set of manufacturing condition(s) is found.

Continuing with types of data analysis:

3) Comparing a relationship (determined by correlating manufacturing data and in-field data) with a reference relationship (e.g. baseline), where the reference relationship is between historical (e.g. normal/nominal) or modeled element manufacturing data (also referred to as manufacturing data modeled version) and historical (e.g. normal/nominal) or modeled in-field data (also referred to as in-field data modeled version). If, based on this comparison, it is determined that there is an inconsistency (e.g. deviation, trend, etc.) in manufacturing and/or in-field data, e.g. element manufacturers may act on the change to understand and/or fix the inconsistency. Such analysis may, for instance be followed by generation by data analysis engine 14 of an output report on a newly established reference relationship, and/or a report on the inconsistency. For instance, this type of analysis may be part of a statistical process monitoring. Examples of in-field data (that may be correlated with manufacturing data in order to determine a relationship) for statistical process monitoring may include: power consumption, latency, frequency of error correction, etc. Examples of manufacturing data (that may be correlated with in-field data in order to determine a relationship) for statistical process monitoring may include: transistor dimensions (thin film transistor) (which may affect power consumption), quality index (e.g. quality index=a*region on wafer+b*iddq+c×1/waferyield), etc. Depending on the example, the device data (e.g. parametric, function and/or attribute) and the manufacturing data (e.g. parametric, function and/or attribute) that are correlated may or may not be of the same type. Additionally or alternatively for instance, this type of analysis may be part of expanded and/or extended product validation process for newly introduced devices and/or elements, for changes to existing devices and/or elements, and/or for changes to the processes used to manufacture existing devices and/or elements. In this instance, instead of relying on testing data from testing a sample of a line of elements that are newly designed, the functioning of the elements may be followed by correlating in-field data of devices including those elements with manufacturing data of those elements. In some embodiments, the analysis may be performed for multiple sets of devices containing the given elements to determine if the inconsistency (e.g. deviation and/or trend) varies for the different sets of devices. In some embodiments, the analysis may be performed for multiple sets of devices to determine an expected consistency of correlation and/or to confirm an absence of variation in an expected relationship. It may be noteworthy, for example, if a population of elements whose manufacturing corresponds to a set of manufacturing conditions that is expected to be correlated to in-field performance data of devices including those elements, is found in analysis not to correlate as expected. Similarly, a shift in a relationship with respect to a reference relationship between element manufacturing data and in-field end-user performance data of devices including the elements may be significant. Such analysis results may be due to a change in the behavior of the elements or of the devices producing the data used in the analysis, or alternatively, may be due to an error related to the quality of the data itself. In some embodiments, for example, the identifiers of the elements included in the devices upon whose performance data the analysis is based may be corrupted, and they may therefore not provide the needed linkage between relevant manufacturing data and relevant in-field device performance data for the elements and devices of the analysis, possibly leading to erroneous or meaningless analysis results. As another example, if the elements included in devices are in fact counterfeit, they may produce bogus identifier data which may not provide the basis for a useable link between manufacturing data and in-field device performance data, therefore also possibly leading to erroneous or meaningless analysis results.

In some embodiments, the analysis such as described in 1), 2), or 3) may be performed for multiple collections of devices containing the given elements to determine if there is a variation between different collections of devices. As above, the output of such analysis may be a report referenced say by a manufacturer, to assess and act on potential device reliability issues, although in such an embodiment the risk assessment may be prepared so as to include analysis of multiple differing device-level applications of the given element, summarized in aggregate, individually, or both.

In some embodiments, the analysis such as described in 1), 2), or 3) may be performed using groups of elements. For example, when determining a relationship by way of correlating data, in-field data may be correlated with a combination of manufacturing data for the groups. As another example, performance of devices may relate to interactions between groups of elements, rather than to individual elements, within devices. Elements of a given group may be of the same type; for example, a given group of elements may be comprised of a particular memory component product type, while another group may be comprised of a particular microprocessor product type. In such embodiments, a given group may be comprised of an element type that is of the same or of a different type than the elements comprising another of the groups included in device construction. In some of these embodiments, the usage of the elements of the groups within each device of a device population may not necessarily be related, while in some other of these embodiments the usage of the elements of the groups within each device of a device population may be similar. In various embodiments where the elements of a given group may or may not be placed and used within each device of a device population similarly, there may not be a direct or indirect electrical connection to elements of a different group with which they may have an interaction. For example, there may be an interaction involving electromagnetic interference (EMI) between elements of different groups within a device, causing device performance problems, without the elements necessarily being directly or indirectly connected to one another through circuitry. For example, elements in proximity with one another may create an EMI-related device performance problem independent of any electrical connections that may exist between them, which may in turn relate to the particular set(s) of manufacturing conditions of the elements. In such cases, the elements involved in the EMI interaction may be of entirely different types, for example involving EMI interaction between components to modules, components to sub-modules, or sub-modules to modules, or alternatively may be of the same type. In some embodiments, the electromagnetic interference between different groups of elements within devices may not necessarily involve interference due to electromagnetic radiation, but may involve instead inductively or capacitively coupled “noise” between elements whose circuit wiring may be in close proximity, possibly resulting in transient inductive or capacitive interference in the signals or power supplies of a first element upon transitions or assertions of signal or power supply voltages in a second element (e.g., cross-talk).

In some embodiments involving similar usage of elements of any given group within devices of a device population, each element of a given group may be placed and electrically connected within each device in the same way, per the nominal specifications of device construction. In some cases, the various elements of several different groups may be placed and electrically connected within devices, each per the nominal specifications of device construction, such that the electrical and/or mechanical interaction between the elements of the various groups within the devices using them may be expected to be similar. In embodiments for which populations of devices are distinguished at least by device performance, elements from two or more such groups included in each device of a given population may be considered in analysis, and correlation between a known device-level performance anomaly in the field and the manufacturing conditions of the elements of such groups may be identified. In some embodiments with groups, a device-level performance anomaly may correlate to a particular set of manufacturing condition(s) associated with the manufacturing data of elements of an individual group contained in the devices of a population. Additionally or alternatively, a device-level performance anomaly may correlate to a set that is a combination of subsets of manufacturing conditions of elements of more than one group contained in the devices of a population. In some of such embodiments, an association comprising a combination of associations of manufacturing data of two or more groups of elements with a given subset of manufacturing condition(s) for each, may indicate a correlation between a device-level performance anomaly and a combination of subsets of manufacturing conditions of the elements of the various groups, possibly due to an interaction between the elements within the devices using them. As above, the output of such analysis may be a report referenced say by a manufacturer, to assess and act on potential device reliability issues, although in embodiments with groups, the risk assessment may be prepared so as to include analysis relating to the various groups.

As an illustrative example of embodiments with element groups, a scenario is offered in which a slow transmitter paired with a fast receiver may cause latched data passed between components connected as a transmitter-receiver pair on a PC board within an in-field device to become corrupted if data from upstream logic arrives at the subsequent stage too late to be latched. By contrast, if the two paired components were both fast or were both slow, the problem with latching incorrect data would be less likely. Manufacturing conditions of the transmitter component may affect its time-to-valid-data timing differently than the set-up and hold timing of the receiver component, or may in fact involve conditions not even applicable to the manufacturing of the receiver component, for example if the transmitter and receiver components were based on different fabrication process technologies. Thus, the characteristic time-to-valid-data of the transmitter may be dependent on one subset of manufacturing condition(s), while the characteristic set-up and hold time of the receiver may be dependent on another, totally unrelated subset of manufacturing condition(s). In such a scenario, an observed performance problem within a given population of in-field end-user devices may partially depend on the particular pairing of the transmitter-receiver components. If pairing is random, a related performance problem may be observed on some end-user devices, and not on others. By first analyzing in-field performance data to establish one or more device populations by a failure rate, and then analyzing correlation of pairs of subsets of manufacturing conditions corresponding to the paired transmitter-receiver components within each distinguished device population, a correlation may or may not be confirmed to certain combinations of the manufacturing conditions of the paired components. Although the example offered here is for simplicity's sake limited to the scenario of the interaction of pairs of elements within devices, the subject matter is not limited by this, and the analysis described may be applied for any number of groups of elements of interest included within the devices of a population.

Optionally, the types of analysis that may be performed by Data Analysis Engine 14 may be configured by individual operators to suit their own needs, and/or by an administrator of Data Analysis Engine 14.

Data Analysis may be of varied types, and are not necessarily restricted in nature to the analyses described above with reference to 1), 2) or 3).

For example, analysis by data analysis engine 14 may involve any combination of element manufacturing data and/or in-field data. In various embodiments element manufacturing data that are analyzed may include parametric data, functional data and/or attribute data, such as those described above. In some embodiments in addition to or instead of received manufacturing data the analysis may use data computed based on received manufacturing data. The data may be computed in any manner, for example a mathematical or logical combination of two or more data points, or for another example, a measured shift in value of manufacturing data across two or more manufacturing operations performed. In some embodiments, analysis may be made of a statistical metric (e.g. mean, median, standard deviation) summarizing one or more of the listed items for a population of similarly processed or similarly behaving elements from the sub-assembly manufacturing line.

In various embodiments, in-field data that are analyzed may include parametric data, functional data, and/or attribute data such as those described above. In some embodiments in addition to or instead of received in-field data, the analysis may use data computed based on received in-field data. The data may be computed in any manner, for example a mathematical or logical combination of two or more various types of parametric and/or functional data, or for another example, a measured shift in value of parametric and/or change in functional data across two or more device events or across a usage time period or across different modes of operation. In some embodiments, analysis may be made of a statistical metric summarizing one or more of the listed items for a population of similar conditions, for example a set of measurements made in conjunction with occurrence of multiple similar events, or made across an extended usage time period.

In some embodiments, correlation between an identified set of manufacturing condition(s) of interest and the in-field performance may be indirect, involving two or more levels of correlation. For example, correlation may first be established between a device-error being produced and a particular test program that was used to manufacture the problem devices, to be potentially followed by correlation to a change previously made to a particular test in the given test program used.

Additionally or alternatively, data analysis may take into account device manufacturing data and/or out of service data, e.g. to assist in the analysis of the in-field data and/or element manufacturing data. For instance, the data analysis engine 14 may detect a correlation between device manufacturing condition(s) and in-field performance.

The subject matter is not bound by examples of data analysis described herein.

In some embodiments, the analysis and reporting of Data Analysis Engine 14 may be semi-automatic, e.g. instigated and/or at least partially directed by operators, controlling Data Analysis Engine 14 by means of Clients X and/or Clients Y, 11x and 11y respectively (collectively “Clients 11”). The operators in this case may be users that may use clients 11x, 11y. Although clients 11 are shown in FIG. 2 as being remote from box 6, this is not necessarily always true, and it is possible that clients may be at the same location as box 6 in some examples. As true for any of the boxes in FIG. 2, clients 11x, and 11y may be made up of any combination of software, hardware and/or firmware, depending on the embodiment. In some embodiments clients 11 may be desktop software, enabling operators using clients 11 to log onto (e.g. the server(s) of) box 6 by means of a username and password, to access Operator Application Services 13, which in some embodiments may provide (among other functions) a user interface to interact with and to partially control Data Analysis Engine 14, e.g., to specify the details of the analysis and reporting desired, to provide feedback, etc., thereby allowing Data Analysis Engine 14 to perform semi-automatic analysis in addition to or instead of automatic data analysis. In some embodiments, any client 11 may additionally or alternatively include one or more processors.

For simplicity's sake boxes 11x and 11y are referred to as clients herein. However, in some embodiments, boxes 11x and/or 11y may additionally or alternatively be representative of input/output interfaces for box 6, which may perform similar functions as described herein for allowing operator inputted data to be received by box 6, and/or data from box 6 to be provided to an operator, mutatis mutandis.

In some embodiments, box 13 and/or 11x, 11y, may be omitted or minimized. For instance, the analysis may be completely automatic and therefore the operator may not need to instigate the analysis and details of the analysis may not need to be specified by an operator (or may only need to be specified at an initial setup but not after that). Additionally or alternatively for instance, reporting to an operator may not be required. Continuing with this instance, the results of the analysis may be automatically fed back to the manufacturing environment, in order to improve, if necessary, the manufacturing. Additionally or alternatively, even if reporting to the operator occurs, feedback from an operator on the results may not be allowed, despite the fact that such feedback may potentially allow the mode of operation to change over time and perhaps improve the data analysis, albeit while making the analysis less automatic.

Operator Access Administrator 12 may be configured to provide security and/or limit access to the data of database 10 according the permissions associated with the user-group to which a given operator is assigned. After operator login and user-group affiliation have been confirmed by Operator Access Administrator 12, this information may be passed to Operator Application Services 13, which may thereafter limit options and data presented to the logged in operator when running applications to those appropriate to his/her user-group affiliation (e.g. affiliation to a certain manufacturer). In some embodiments, Operator Access Administrator 12 and Operator Application services 13 may be combined. In some embodiments, Operator Access Administrator 12 may be omitted, for instance if operator access to box 6 is not required.

In some embodiments, database 10 may be designed as a data “clearing house” involving multiple element manufacturers and multiple device manufacturers, thus allowing operators affiliated with manufacturers to access all of the data appropriate to their needs. The advantage, and also the complexity, is in constructing a robust Operator Application Services 13 for managing permissions and priorities (perhaps based on system policies) to allow operators affiliated with manufacturers to access all relevant data to their area of interest while restricting them from accessing data that they lack permissions for. Further, in such an environment, analysis tools may make the operator's work easier by automatically preparing an analysis menu appropriate to a particular operator's need, populating the analysis parameters automatically based on the scope of the relevant elements and/or devices.

In the example of FIG. 1, there may actually be more than one manufacturer of the NAND components that are at times used for any one of the three applications shown. In total, in this example, there may therefore be as many as five different user-groups interested in using a data “clearing house” (two component related user-groups and three device related user-groups). It may be designed that one component manufacturer may never see data related to the components of the other component manufacturer. Also, if a certain device manufacturer sometimes uses a component of one component manufacturer and sometimes a component of the other component manufacturer, then there would be interest in comparing in-field for the two sources. However, if a first device manufacturer and a specific device manufacturer, only use components of a third component manufacturer and a fourth component manufacturer, respectively, then the in-field data of interest to each device manufacturer may be filtered accordingly. In another example, a given component manufacturer may be willing to share component manufacturing data with one device manufacturer using those manufactured components, but may not be willing to share it with another device manufacturer using those manufactured components.

In the illustrated embodiments of FIG. 2 there may be multiple instances of operators belonging to either user-group X or user-group Y (shown for illustrative purposes where user-group X may be associated with clients 11x and user-group Y may be associated with clients 11Y). However, the subject matter is not bound by two user-groups and there may be fewer or more. In fact, the number of user-groups that may be defined may in some cases be unlimited. User-groups may be defined, e.g. by Access Administrator 12, according to any suitable criteria. For example, user-groups X and Y may be differentiated according to the company for which an operator works. In such an example, the company differentiation may be by the manufacturer of various elements and/or devices, for example, responsible for the component, module, or device manufacturing shown in boxes 1, 2, and/or 3 respectively. User-groups may be further subdivided for a given employer according to their area of interest or according to the particular analysis features they may require.

In some embodiments, operators affiliated with the variously defined user-groups may be simultaneously logged on and may be simultaneously using Data Analysis Engine 14, each bound by the limitations of their user-group permissions. For example, two operators employed by different companies/user-groups X and Y that each manufacture a particular element of a device may be simultaneously logged on and performing analysis. Companies X and Y may, for example, be manufacturers of disk drives for a large server company that at times installs drives (elements) from either of the two companies within the same model server (device). Since these two hypothetical operators work for competing companies, presumably with independent manufacturing lines, it may be undesirable for them to view each other's data. Therefore, there may be a need to limit their view of the manufacturing data for the device disk drives only to that of their own company, and also a need to limit their view of the relevant in-field data only to specific devices in the field that were constructed with their company's elements. Thus, data traceability of element data and of in-field data to the appropriate “owner” of the data may be needed so that Access Administrator 12 may properly allow data access to operators with group membership X or Y. Access for operators with user-group membership assigned according to affiliation with various device manufacturers whose in-field data are databased may be similarly controlled, as these operators may have no interest in each other's data, or in fact, may actually be competitors and have an undesirable interest. Thus, as explained above, the structure of the database of manufacturing data and in-field data may need to support its use as a data “clearing house” for multiple operators with various user-group affiliations, including data from multiple different element manufacturers and/or from multiple different device manufacturers.

To manage operator data access appropriately, each record in the database may include at least one record-field whose value may be used directly or indirectly to determine which of the user-groups may have access to the data of the record. In the example of the two disk drive manufacturers given above, each data record of in-field data from the server company may include a record-field indicating the model, serial number, or disk drive manufacturer of the disk drive contained in the server from which the data record was generated, and that record-field may be used to appropriately restrict access to the data record to operators affiliated with either of the two companies providing disk drives to the server manufacturer. Operators affiliated with each company may be able to analyze in-field data for devices containing their own disk drives, but may not have access to data derived from devices containing the competitor's disk drives. In contrast, continuing with the example, an operator affiliated with the server manufacturer may require access to all such data records, regardless of which of the two disk drives is contained in a given server's data record, and may therefore not be limited in data access by the disk drive model, serial number, or manufacturer record-field. Thus, an operator with server manufacturer group affiliation may be able to compare and contrast in-field data for groups of servers built with each of the two types of disk drives. Note that in some embodiments a given device may contain multiple elements including elements from competing manufacturers, for example a server containing disk drives from each of the two exemplary manufacturers within the same device. In such an embodiment, data access policies may permit access to in-field data to operators affiliated with either disk drive company however, optionally censoring specific record-fields containing information regarding the competitor's product, such as the specific manufacturer, model number, or serial number of the competitor's disk drive contained in a given device. Ideally, such data access policies may be highly configurable, permitting flexibility in determining which data records and which record-fields may be accessed by each user-group. The implemented policies may be based on business concerns of the various user-groups, for example, based on the desire of an element manufacturer that a competitor be forbidden from having access to the manufacturer's data, or having access to the in-field data generated by devices containing the manufacturer's elements. In another example, a device manufacturer may desire that a first element manufacturer be forbidden from accessing a second element manufacturer's data, for example, if those data reveal proprietary information of a technical or commercial nature such as a particular technical collaboration or business relationship between the device manufacturer and second element manufacturer.

Returning to FIG. 2, an optional in-field query mechanism will now be described. As described above, in some embodiments collection of in-field data may be triggered by a query from outside the device and/or by non-query events. With regard to non-query triggers or queries not targeting specific devices, the in-field data collection schema may be independent of the analysis performed in box 6, and/or of a review of the analysis results by humans, if occurring (optionally accompanied by feedback via clients 11) and/or may be independent of explicit requests regarding querying made by operators via clients 11.

In some embodiments, however, the review of data, feedback, explicit requests, and/or the analysis being performed in box 6 may cause queries to be generated and transmitted to devices 4a and 4b for additional or particular types of in-field data that may otherwise not be provided. Possibly, the queries may include instructions transmitted to devices 4a and 4b to alter their default data collection schema causing different data to be generated, and/or altering data generation triggers (e.g. generation of data under different conditions and/or at a different rate than would otherwise occur). The usefulness of such a feature may be apparent when potential applications are considered, including the following:

1) The confidence level in a correlation found between in-field performance and a set of manufacturing condition(s) may be enhanced by increasing in-field data samples above default levels. The observation may thus be confirmed or refuted, or may be better quantified, for example to estimate the ppm level of an observed device reliability problem.

2) Similar to the above, additional in-field data collection across a broader range of types of devices or of device operating conditions than provided by initial default sampling levels may provide better insight into the scope and/or the nature of problems identified by correlation to a set of manufacturing condition(s).

3) An observation of an inconsistency in the manufacturing data of elements may warrant in-field data collection from the specific devices that have been constructed with the elements that were processed under abnormal manufacturing conditions and therefore may potentially be marginal or prone to glitches. Such focused in-field data device data collection may better exhibit correlation to a problematic set of manufacturing condition(s) than the random data collection of the default schema. For instance these devices may be queried periodically to check e.g. for degradation, margin to failure and/or glitch frequency.

4) Enhanced in-field data collection, for example to expand the amount of data collected or the measurement resolution of data (e.g. in the case of parametric data) may be desired to improve understanding of a correlation, although may be impractical in the default data collection schema. In this case, individual devices or groups of devices, meeting specific manually defined criteria and/or automatically defined criteria, may be targeted for enhanced data collection.

5) Observation of in-field data points of particular concern from certain devices may be re-checked for frequency of occurrence or repeatability of measurement results by forcing repeated collection of the data of interest from those devices, as needed. The consistency of resulting data may be a factor in determining appropriate responses to problems observed.

6) Ad hoc adjustments to the original data collection conditions or to the data set sampled may be desired after review of the data from the original default data collection schema. Such adjustments may be desired, for example, to address unintended errors in the default data collection schema, or for another example, to respond to an incidental problem observed in data analysis by building an enhanced reference relationship (e.g. enhanced baseline) based on nominal in-field data. A reference relationship may be enhanced, for instance, by increasing sample size or sampling frequency, or by receiving more samples from potentially problematic devices (e.g. with lower performance than other devices).

The subject matter is not bound by these applications.

In some embodiments, a device in the field may only generate additional or different data than the default data collection schema provides if the device design provides some means for accepting and processing transmitted queries or instructions for data collection modification in the field. An example of a similar feature is the commonplace mechanisms employed for performing operating system and application updates on today's Internet-connected personal machines, such as PC's, laptops, tablet computers, mobile phones, and set-top boxes. Upon boot-up, or during user operation, a remote server communicates with the machine in the field to determine what version of operating system or application is installed on the machine, and then automatically downloads any necessary updates to the machine for optional installation by the machine's user. A similar process may be described for the current subject matter, in which a device in the field (FIG. 2, 4a or 4b) is sent a request by a remote system (e.g. FIG. 2, box 6), for instance by the Internet, to modify device behavior (e.g. to change in-field data collection conditions). The query may be sent to all devices in the field or to fewer than all devices in the field.

For embodiments in which the identity of the in-field device is known (or may be ascertained through device polling), and also a mechanism for addressing the particular device exists, the remote system may limit its query for additional data (or request for a change in the default data collection schema) to a specific target device. The identifier may be, for example, the device serial number. In some embodiments, in addition to or instead of a device identity, there may exist an identifier indicating the type of device and/or device manufacturer that may serve as the means for sending queries to a group of similar devices, but not to dissimilar devices. The device type identifier may be, for example, the device model number. Any mechanism for addressing an in-field device uniquely, or for addressing a device as a member of a group of devices (distinguishable from other devices that are not members of the group) may be used as the basis for transmitting queries for data collection less than all end-user devices in the field. In some embodiments the identifiers used to address the devices(s) of interest may be known in advance of formulating the query. In some embodiments the identifiers may only be known after polling a device for its unique identity or group identity, and then if the device is determined to be of interest, the query to request enhanced data collection may be made.

As shown in FIG. 2, a query may be formulated with optional In-Field Device Data Query Generator 16. The input to this generator, specifying the kind of in-field data desired and specifying which devices(s) must provide those data, may come from Operator Application Services 13 or Data Analysis Engine 14. Requests coming from Operator Application Services 13 may include those resulting from explicit requests made by operators of clients, for example, when their review of existing data has led them to recognize that additional or different data are needed for their work. Requests coming from Data Analysis Engine 14 may include those made in conjunction with execution of analysis being performed, for example, when a correlation between in-field performance and set of manufacturing condition(s) has been identified using a certain dataset, but additional data points may be needed to reach the desired confidence level for the correlation to be accepted as true.

In the illustrated embodiments of FIG. 2, whether initiated as a result of a manual explicit request made via Operator Application Services 13, or as a result of the logic of an algorithm being run under Data Analysis Engine 14 (which may be automatic, or semi-automatic), after Device Data Query Generator 16 has formatted the series of machine-readable commands for the query, the query data may be sent to In-Field device Data Query Transmitter 17. In-Field device Data Query Transmitter 17 may then transmit the query (e.g. across the Internet) to the targeted devices from among all In-Field End-User devices 4a and all In-Field End-User devices 4b. Recall that in the embodiments of FIG. 2, In-Field End-User devices 4a and 4b are intended to represent different collections of devices that may or may not have elements in common with each other. As mentioned above, queries transmitted to various devices in the field in communication with In-Field device Data Query Transmitter 17 may be addressed only to devices 4a or only to devices 4b, or to both devices 4a and 4b, or to any sub-collection of devices within the collections represented by devices 4a and/or 4b. In some embodiments, in-field device data query generator 16 and in-field device query transmitter 17 may be combined. Optionally, in some embodiments, local aggregators of in-field data queries 18a and 18b may be present, serving to buffer queries that have arrived (e.g. over the Internet) for In-Field End-User devices 4a and 4b. When present, 18a and 18b may receive, consolidate and schedule transmission of queries to devices 4a and 4b. In some embodiments, 18a and 18b may be combined into a single aggregator to serve a variety of devices in the field, for example, a single local aggregator of in-field data queries to serve both devices 4a and 4b, closer to the transmitting end (box 6) and/or closer to the receiving end (boxes 4a, 4b). An example of an embodiment that would benefit from inclusion of elements 18a/b would be one in which devices 4a/4b are not Internet-connected, for example, a set of devices within an factory floor that are controlled by a single Internet-connected server, for example a server used as a factory floor repository of configurations and/or computer programs for devices on the factory floor that for control and security reasons are not Internet-connected. In such an embodiment queries for those devices may first be aggregated by the factory floor server before being forwarded via LAN or local wireless network, for example, to the non-Internet-connected devices. Another example of an embodiment that may benefit from elements 18a/b would be one in which Devices 4a/b are not easily reconfigured, for example those in mission-critical applications whose software is difficult to modify, for example when software releases are under strict change-control.

The protocol and format of the query are not bound by the subject matter. However for the sake of further illustration to the reader, some examples are now provided. For example, the query may use any standard protocol and format (e.g. HTTP, RESTful, Web Service, XML, JSON) or any proprietary format as defined by the device manufacturer.

Although the example of transmission via the Internet was given for the querying described above, the subject matter does not limit the transmission means, protocols or frequency used for querying. For instance, for a particular query the means of transmission may include: the Internet or any other wide area network(s), local area network(s) (wired and/or wireless), cellular tower(s), microwave transmitter tower(s), satellite communication(s), automotive telemetry technologies, etc. The protocols used for transferring the query may be any appropriate protocol for the means of transmission. For instance, transmission of queries between 18a/b and devices 4 a/b may be by means of a local area network, rather than by Internet, particularly when 18a/b and 4 a/b are physically close to one another.

Data analysis engine 14 may be configured to perform and/or to trigger various actions automatically, or semi-automatically in conjunction with operator feedback (where feedback may be, for example, operator input and/or operator created rules provided via clients 11x, 11y). For instance, at the end of an analysis it may be concluded that there is a correlation between in-field performance and a set of one or more manufacturing conditions. In another instance, at the end of an analysis, it may be concluded that data are inconsistent. Data analysis engine 14 may automatically or semi-automatically determine whether or not such a correlation is spurious or not spurious. A relationship inferred from a given correlation may be classified by operator and/or by machine as being spurious if it has no meaning or relevancy, for example when the events or variables in the relationship inferred from the correlation have no plausible causal connection, as when the apparent relationship is actually due to an incidental factor influencing the correlated events or variables systematically and simultaneously (rather than being due to a direct causal relationship between the correlated events or variables). Such an incidental factor is commonly referred to in statistics as a “common response variable,” “confounding factor,” or “lurking variable”. For example, it may be found that a population of laptop computers distinguished by erratic CPU performance are correlated to CPUs derived from wafers that underwent augmented testing at the wafer sort operation, compared to a population of laptop computers including CPUs without performance problems that did not include CPUs derived from wafers that underwent augmented testing at wafer sort. The relationship implied by the observed correlation is that augmented wafer sort testing in CPU manufacturing causes CPU performance problems in laptop computers in the field. However, if it is known that the CPU manufacturer's policy is to execute augmented wafer sort testing only on wafers that are found to be low-yielding, then the relationship implied by the correlation may be classified as spurious. In the example given, low-yielding CPU wafers result in both augmented wafer sort testing (by manufacturing policy), and also tend to produce CPUs with performance problems.

Determination by data engine 14 of whether or not a correlation is spurious or not spurious may be based on current input (e.g. inputted by one or more operators via one or more clients 11, after the conclusion was reported) and/or based on historical data (e.g. past conclusions, previously created rules, and/or past input e.g. inputted via one or more clients 11, etc.), etc. Additionally or alternatively to data analysis engine 14 making such a determination, one or more operators, for instance who received a report of the conclusion, may make a determination of whether or not such a correlation is spurious or not spurious. Optionally, a determination made by an operator may be inputted to data analysis engine via a client 11. Consequent to a determination by data analysis engine 14 and/or by one or more operators, data analysis engine 14 and/or one or more operators may create one or more rules. If operator-created, a rule may subsequently be received by data analysis engine 14 (e.g. via a client 11). For instance, rules may pertain to any of the numbered examples below, any function described herein with reference to system 200 and/or with reference to any box included in system 200, any embodiment described herein, etc. Creation and execution of rules may enable system 200 to vary the mode of operation of system 200 over time, perhaps enabling system 200 to become more efficient over time.

Subsequent to the conclusion, determination regarding spuriousness, and/or rule creation, analysis engine 14 may possibly perform and/or trigger any combination of actions, including any of the following: generating a report, feeding back to the element or device manufacturing environments a change to improve manufacturing, feeding back to the device manufacturer or device end-users a change to device configuration of in-field devices to improve device performance, feeding back to the element or device manufacturer a change to the amount or type of data being automatically received from manufacturing and/or in-field end-user devices, generating a query to one or more in-field devices to receive additional or different data, feeding back to an element or device manufacturer a reliability assessment of elements or devices, feeding back to an element or device manufacturer the identities of particular elements or devices that should be recalled from the field, feeding back to an element or device manufacturer the identities of particular elements or devices that may be suspected for being counterfeit or tampered with, repeating the analysis under a different set of manufacturing condition(s), repeating the analysis periodically on at least the same devices and elements as the original analysis, repeating the analysis one or more times on different devices and elements than sampled in the original correlation, repeating the analysis on different type(s) of device(s) than analyzed originally, repeating the analysis for different device manufacturer(s) than analyzed originally, or storing results and parameters of an analysis in a database to be optionally retrieved and used subsequently as reference in determining and applying events for execution of a follow-up analysis.

In some embodiments, the various exemplary actions listed here may be initiated by data analysis engine 14 automatically and conditionally, dependent on results of a correlation and/or inconsistency analysis whose execution is defined to depend upon occurrence of specified events within the environment of Box 6. In some embodiments, the definition of the analysis to be performed, the specified events to cause an analysis to occur, and the actions to be conditionally initiated based on analysis results, are enabled using one or more configurable rules. In some such embodiments, rules are configured to perform correlation analysis of received data relating to manufacturing of electronic elements and in-field data for end-user devices and that include the elements whose data are being correlated, including the various forms of correlation analysis described in the preceding embodiments of the subject matter. Events that may be detected within the environment of Box 6 may cause such a rule to execute, including for example, arrival of additional received data, addition of data to database 10, receiving a particular type of additional data, exceeding a required minimum quantity of data for one or more particular types of data within database 10, exceeding a threshold for a maximum time interval between successive rule executions, arrival of a particular time or passing of a time interval of particular duration, arrival of additional data from data queries transmitted by in-field system data query transmitter 17, requests for one or more executions made by clients 11, and any other detectable event within the environment of Box 6. The conditional logic of the rule may be configured to initiate an action based on any particular result of the analysis, including for example an indication that there is or is not a spurious correlation result, or for example an indication that there is or is not an inconsistency in the result of the analysis, compared to the expected result of the analysis. The initial configuration of the rules described here, or of reconfiguration of previously configured rules, may be in some embodiments be by human input, or by input from a combination of human input and input by machine algorithms, or purely by input from machine algorithms. In some embodiments multiple rules of differing configuration may be prepared for activation and may then be activated and simultaneously supported on data analysis engine 14.

Herein, when discussing human input or equivalently operator input, the subject matter does not limit how the input may be provided by the human. For instance, input may be by way of selection (e.g. from menu), pointing, typing in, confirmation of a presented choice, etc.

In some examples, system 200 may include fewer, more and/or different boxes than shown in FIG. 2. For example, there may be one or more system(s) 200, each including one or more of the boxes shown in FIG. 2 and optionally other box(es). If there are two or more systems 200, different systems may or may not include at least some of the same box(es). Additionally or alternatively in some examples, the functionality of system 200 may be divided differently among the boxes illustrated in FIG. 1. Therefore any function attributed to a certain box in an example herein may in some other examples be additionally or alternatively be performed by other box(es). Additionally or alternatively in some examples, the functionality of system 200 may be divided among fewer, more and/or different boxes than shown in FIG. 2. Additionally or alternatively in some examples, system 200 may include additional, less, and/or different functionality relating to and/or not relating to electronics.

Some examples are now provided of methods that may be performed by system 200.

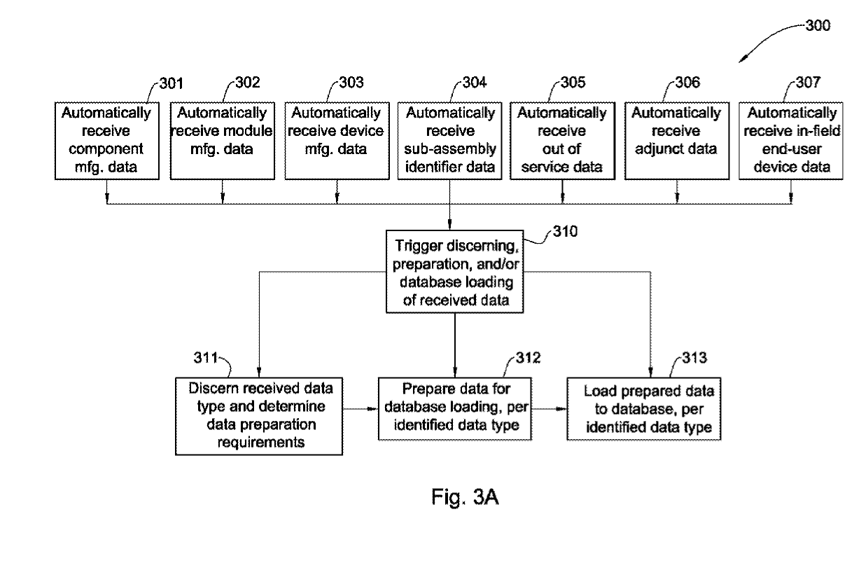

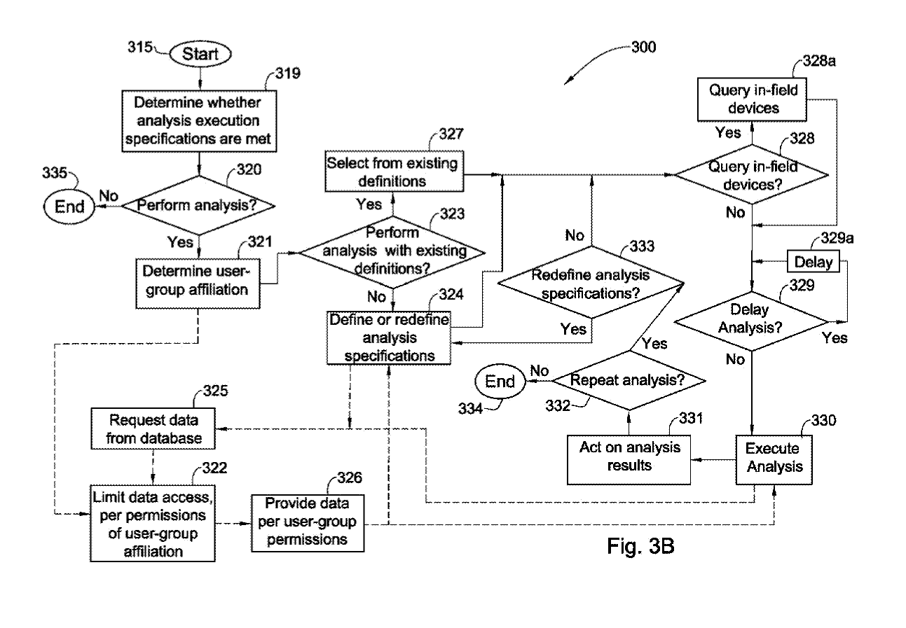

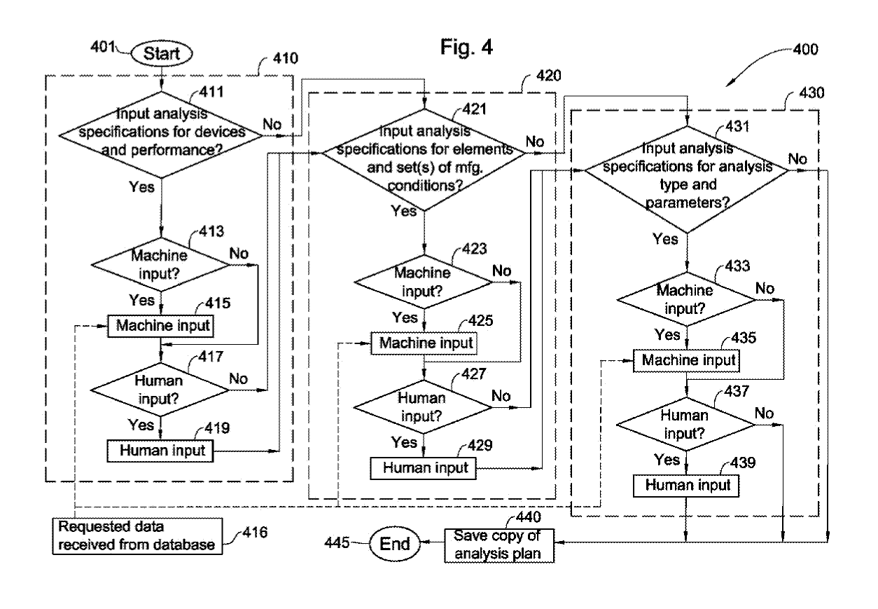

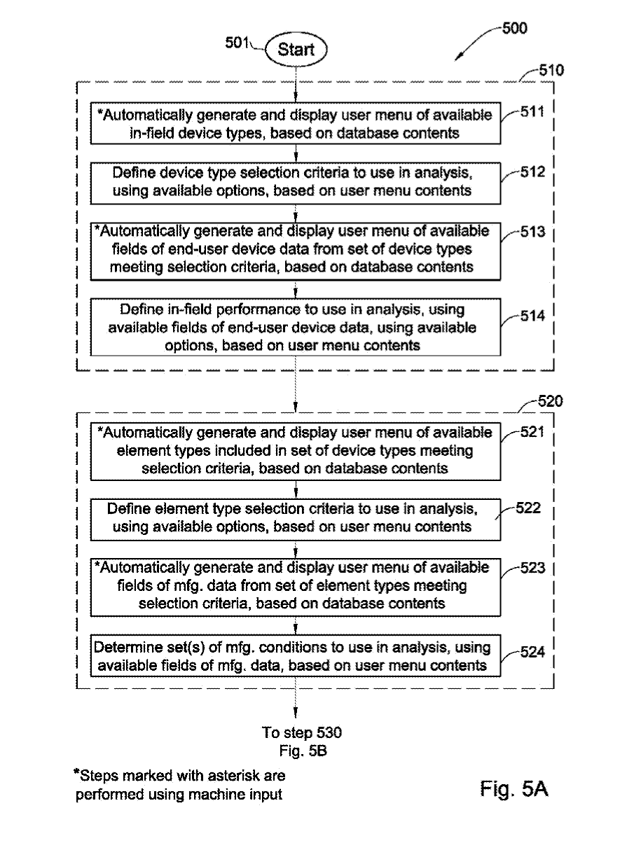

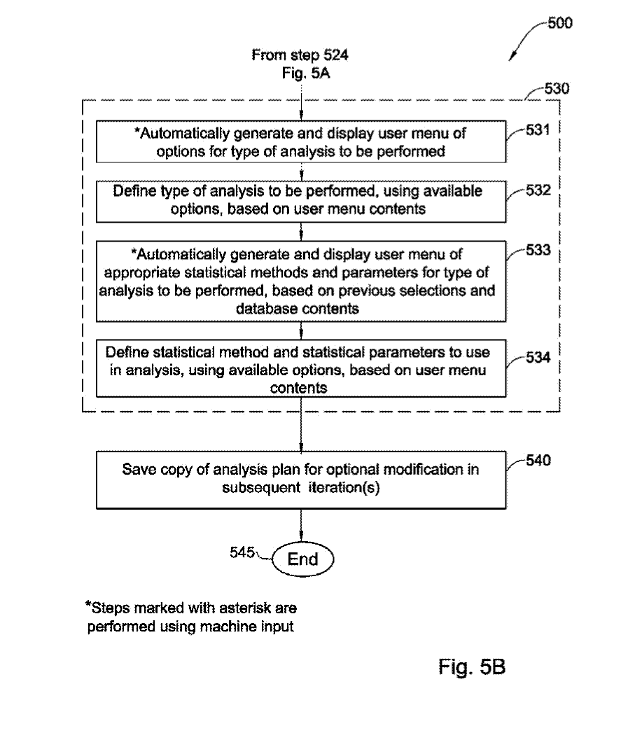

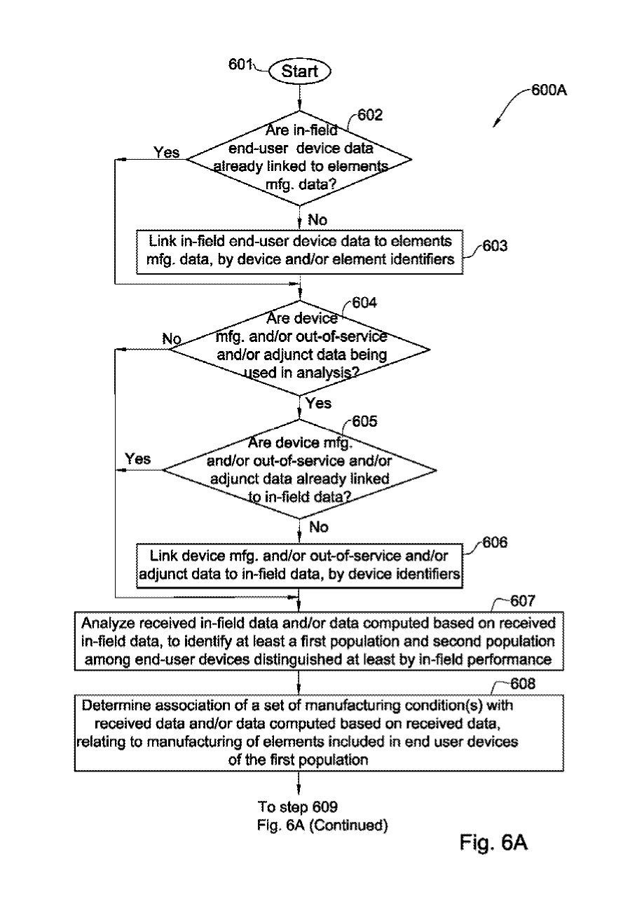

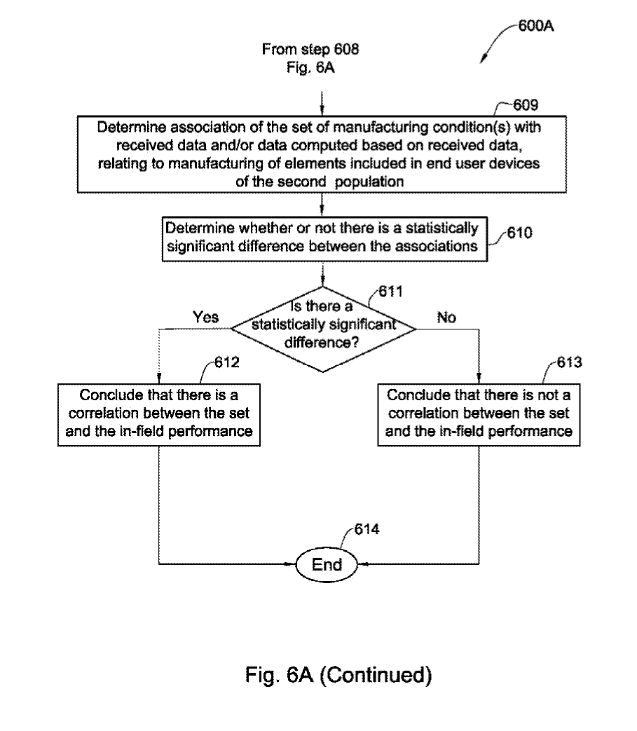

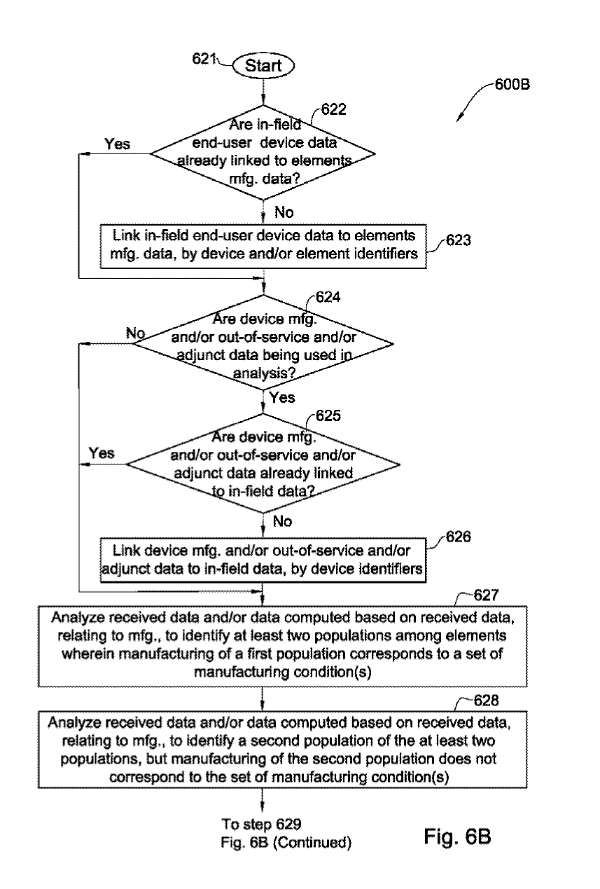

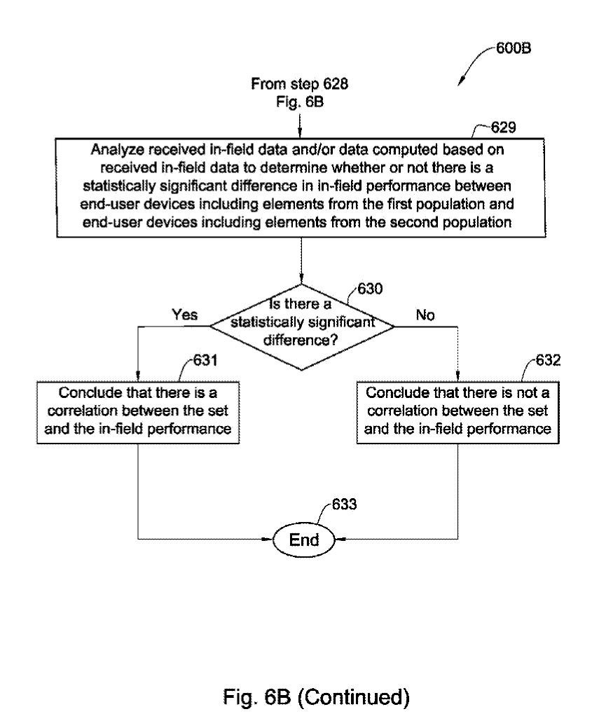

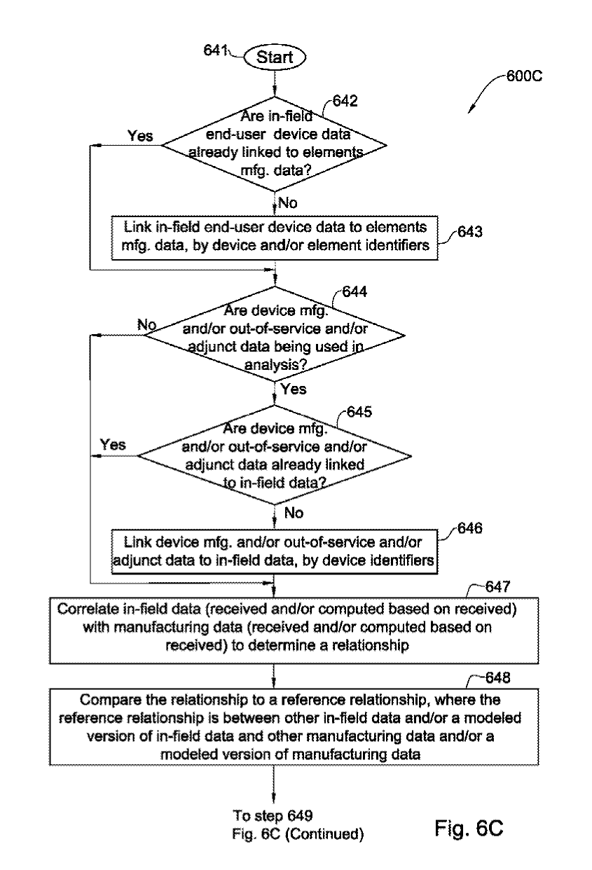

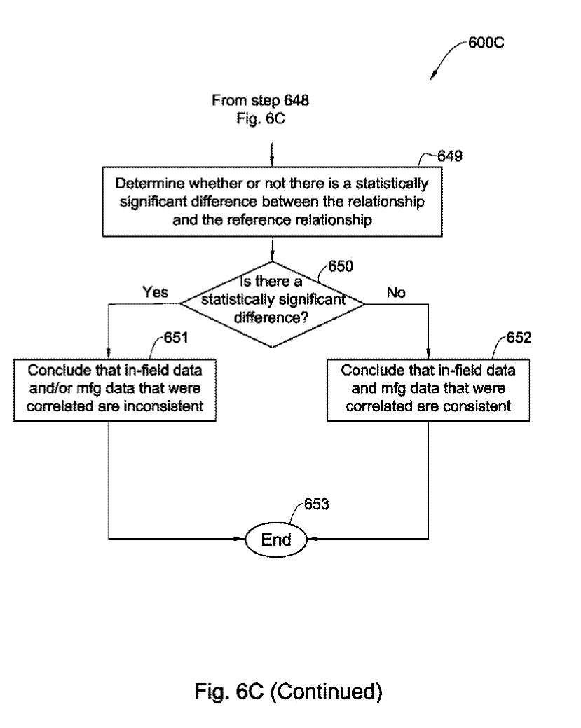

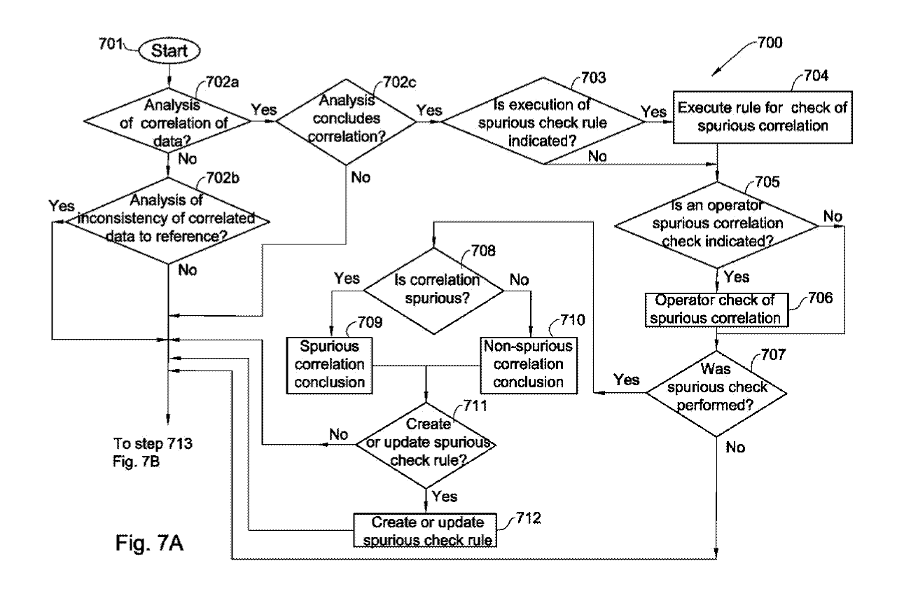

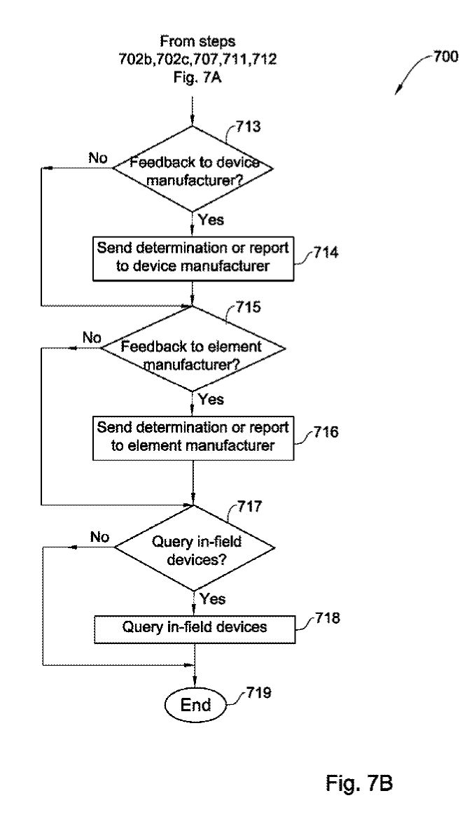

Referring now to the embodiment of FIG. 3, FIG. 3 is a flowchart of a method 300, in accordance with some embodiments of the presently disclosed subject matter. More detail will be provided in FIGS. 4 and 5, which show exemplary embodiments of box 324, and also in FIGS. 6a/b/c and FIG. 7, showing exemplary embodiments of boxes 330 and 331, respectively.

FIG. 3 includes a flow represented by boxes 301 through 313 which includes stages for automatically receiving data, and stages for discerning, preparing, and databasing received data, at least some of which in some embodiments may also be automated. In some embodiments, when flow 301-313 is enabled it may remain continuously active, operating without human intervention and independently of the flow represented by boxes 315 through 335, which includes stages for defining and executing analysis of received data, and for acting based on analysis results. In the embodiment illustrated in FIG. 3, although the flow of boxes 301 through 313 appears to be independent of the flow of boxes 315 through 335, a query sent to in-field devices at stage 328a may lead to in-field data being received at stage 307. In some embodiments the stages of the flow of boxes 315-335 may be executed simultaneously with the stages of the flow of boxes 301-313, although simultaneous execution is not required.

The flow of boxes 301 through 313 will now be discussed. The data sources of stages 301, 302, 303, 304, 305, 306 and/or 307 may correspond to the data source boxes 1, 2, 3, 9, 8, 20 and/or 4/5 respectively, shown in FIG. 2. In some embodiments, stages 301 through 307 may be performed by box 6 (e.g. Database Loading Services 7) of FIG. 2. The data of any or all of the data sources shown in boxes 301 through 307 may be automatically received, and may arrive at box 6 at various times, asynchronously and independently of data received from the other sources. In some other embodiments, however, there may be some synchronization in receipt of the data in stages 301 through 307. An example of such an embodiment may include an in-field end-user device whose ambient operating conditions are monitored by environmental sensors located external to the device, and for which data transmission is scheduled such that in-field end-user device data transmission from the device (box 4/5) may occur at the same time as transmission of adjunct environmental data from the sensors (box 20). A possible reason for synchronizing may be to ensure that the in-field device data received have been generated at approximately the same time as the particular environmental data received, so that the two sets of data may correspond to one another. In other embodiments this reason may not apply, and data may be synchronized for other reasons, or data may not be deliberately synchronized. Another such example may be an embodiment in which a device manufacturer schedules transmission of device manufacturing data (box 3 of FIG. 2) at the same time as the transmission of data identifying sub-assembly elements of the manufactured device (box 9 of FIG. 2). Similarly, module manufacturing data (box 2 of FIG. 2) or component manufacturing data (box 1 of FIG. 2) may in some embodiments be transmitted at the same time as data identifying sub-assembly elements (box 9 of FIG. 2). In such embodiments, by design, data files of different data sources may be received at approximately the same time.

After data are received, the data type discerning stage 311 may serve to parse attributes of the arriving data streams/files such as file type, file name, data header and metadata information, etc., to determine what kind of data are contained in the received stream/file. The arriving data may be any of the data received at FIG. 2 box 6, so data type discerning may be needed in order to know how to prepare the received stream/file. Prepared data may then be loaded to a database in final stage 313. In some embodiments Database Loading Services 7 may be used for performing the triggering, discerning, preparation, and database loading stages 310, 311, 312, and 313, respectively.

The arrival of data received may trigger in stage 310 any or all of the stages of boxes 311, 312, and 313 including discerning the type of data received, determination of data preparation requirements of type of data received, preparation of data received according to requirements of the particular data type, and loading the prepared data to a database, such as database 10 within box 6 of FIG. 2. Although the sequence of the stages of boxes 311, 312, and 313 may be invariant, the trigger to cause each of these stages to occur may originate in various ways. As mentioned, the receipt of new data may serve as a trigger. As another example, the trigger may be based on a particular point in time, or passage of a specified time interval. As another example, triggering may only occur after a specified minimum quantity of data of a particular data type has been received. As another example, triggering may be gated by availability of adequate computer resources to complete processing of a given stage. As another example, in some cases the trigger may be manually initiated by a human operator, for example after an operator of database administrator 15 (FIG. 2) has completed configuration of database 10 to prepare it for data loading. As triggering may be event-driven, and since the sequence of the stages of boxes 311, 312, and 313 may be invariant, processing of received data at a given stage may be completed, and then the subsequent stage may be delayed until a trigger for the subsequent stage has been received. In some embodiments, each of stages 311, 312, and 313 may have a separate trigger. In some embodiments, a single trigger may cause more than one stage to be executed in sequence, for example, a trigger generated at box 310 as the result of receipt of new data may cause automatic execution of stage 311, followed immediately by execution of stage 312, which may then be followed immediately by execution of stage 313. In some embodiments, if some received data are to be linked prior to database loading, one or more triggers may depend on arrival of all of the data to be linked, serving to gate the data preparation stage of box 312 until all required data have arrived. For example, if in-field end-user device data of box 307 are received and are to be linked with a list of identified sub-assembly elements used in the construction of the device that has generated the arriving data, which may be contained in a set of sub-assembly identifier data of box 9 (FIG. 2), then the availability of both sets of data may produce a trigger for execution of preparation stage 312. As illustrated in this example, and as may occur in some other embodiments, a combination of events may be required to trigger one or more of stages 311, 312, and 313. As another such example, a trigger may be produced in stage 310 for execution of data type discerning stage 311 by receipt of data in conjunction with manual initiation by a human operator.

Continuing now to the flow of stages 315 through 335, it is necessary to explain the intended meaning of the dashed arrow connectors at the bottom of FIG. 3. Since during flow execution at various times database operations may be repeated (for example during definition/redefinition of analysis specifications in stage 324 and during execution/re-execution of analysis in stage 330), the boxes of flow stages involving database access (stages 322, 325 and 326) are shown using dashed arrow connectors to distinguish them from the other stages which are typically only performed once per flow execution, beginning at stage 315 and ending at either stage 334 or stage 335. This will be explained further in the following.

After starting the flow at stage 315, at stage 319 it may be determined by box 6 (e.g. data analysis engine 14) whether analysis execution specifications are met and on that basis decision 320 may be made (e.g. by data analysis engine 14) to either perform an analysis of data, or not. For embodiments in which the analysis flow execution is conditional, the answer may be “no” and the flow may immediately end at box 335. Conditions that may potentially gate execution include availability of necessary data, completion of a previously executed analysis iteration, or availability of defined analysis specifications for use in analysis execution, to name a few examples. A scenario for the last example given may involve an embodiment for which an analysis flow is initiated by an operator at a first location, while analysis related input is to be provided by an operator at a second location, or additionally or alternatively, is to be provided by a machine, and the operator at the first location may not know whether or not analysis specifications have been provided and may attempt to execute data analysis prior to their availability. In some embodiments the flow beginning at stage 315 may be triggered to initiate with an event, for example, with arrival of necessary data, or with completion of a previously executed analysis iteration. In some embodiments the flow beginning at stage 315 may be triggered to initiate by human input, while in some other embodiments the trigger may be by machine input.

If the decision at 320 is “yes”, then in stage 321 the user-group affiliation of the operator (instigating and/or at least partially directing flow 315 to 335) may be determined (e.g. using FIG. 2 Operator Access Administrator 12) and may be referred to, as needed, throughout the remainder of the flow. For example, the system login profile of each potential operator may include the user-group affiliation of the operator, and at stage 321 the data access permissions associated with that user-group may be stored for reference in subsequent flow stages. FIG. 3 shows a dashed arrow between stage 321 and stage 322, indicating the transfer (e.g. by Operator Access Administrator 12) of data access permissions for appropriately limiting data access (e.g. using Operator Application Services 13 or Data Analysis Engine 14, or using the two in combination) whenever requests for data from a database are made. Stages 321 and 322 of FIG. 3, and related processes controlling limiting data access per permissions of the user-group affiliation of the operator may be particular to the embodiment shown, and therefore may be omitted in other embodiments.

A decision may then be made at 323 by Data Analysis Engine 14 on whether to perform analysis with an existing set of defined analysis specifications, or not, possibly based on input from an operator of FIG. 2 via client(s) 11. For instance Operator Application Services 13, may provide (among other functions) an interface to interact with and to partially control Data Analysis Engine 14. If the decision at 323 is “no”, a set of analysis specifications may be defined or redefined in box 324. Optionally, in some embodiments, the method of defining or redefining analysis specifications (e.g. by Data Analysis Engine 14, optionally with operator input provided via client(s) 11) may involve the use of data in a database, and therefore, dashed arrows are shown connecting stage 324 to stage 325 and stage 325 to stage 322, for requests being made to the database for data, and also from stage 322 to stage 326 and stage 326 to stage 324, for data provided per user-group permissions resulting from data requests. Stages 322, 325, and 326 may be performed by data analysis engine 14 and/or operator application services 13. Further details on some embodiments of box 324 will be provided below in the descriptions of FIGS. 4 and 5. If the decision at 323 is instead “yes”, input may be received at stage 327, for example from data analysis engine 14 and/or for example from an operator using client(s) 11, to select the analysis specifications to use from available existing analysis specifications which were previously defined and saved. Analysis specifications (existing or currently defined/redefined) may include any specification relating to what the analysis will entail, such as analysis type to be performed, various other details of how to perform the analysis in stage 330, various details on what actions to take in stage 331 based on the outcome of the analysis. For example, in some embodiments, in addition to specifying the type and other details of stage 330 analysis execution, input within stage 324 may include specification of the actions to be performed at stage 331, if any, following completion of analysis execution at stage 330.

Such analysis specifications of other details of how to perform the analysis may include specifications relating to devices, for example, criteria relating to device in-field performance including which in-field device data, or data computed based on in-field data, to use for distinguishing performance, and also criteria that may be used for determining which devices may provide data for performing an analysis, including any of the following: device manufacturer(s), device type(s) or their product/model number(s), device configuration(s), date(s) of in-field device data generation, device usage history, indicators of device end-user satisfaction, device out-of-service history, device operating environment, device manufacturing facilities, source(s) of device manufacturing equipment and/or materials, date(s)/time(s) of manufacturing of one or more device manufacturing steps, type, configuration and identity of device manufacturing equipment used, device manufacturing recipes and/or processes used, device manufacturing history, device sub-assembly content, device manufacturing data produced (for example, measurements of manufacturing environmental conditions, test/monitor data from measurements made on devices during manufacturing, and test/monitor data from measurements made on the device manufacturing processes), and so on.

Additionally or alternatively, similarly detailed analysis specifications may be included for the data to be used in analysis related to the electronic elements included in devices. For example, the analysis specifications relating to elements may include element manufacturer(s), or specification of the function(s) of an element included within a given type of device. For another example, analysis specifications relating to elements may additionally or alternatively include a set of one or more manufacturing conditions such as, element type(s) specified by product/model number(s), element configuration(s), element manufacturing facilities, source(s) of element manufacturing equipment and/or materials, date(s)/time(s) of manufacturing of one or more element manufacturing steps, type, configuration and identity of element manufacturing equipment used, element manufacturing recipes and/or processes used, element manufacturing history, element sub-assembly content, element manufacturing data produced (for example, measurements of manufacturing environmental conditions, test/monitor data from measurements made on elements during manufacturing, and test/monitor data from measurements made on the element manufacturing processes), classification and disposition data (including scrap disposition), and so on.

Note that in some embodiments specification of any of the above types of data may optionally be accompanied by specification of a range of valid values or of statistical characteristics of data points acceptable for use in analysis, for example, to serve as a filter for elimination of “outlier” data points from the analysis.

Analysis specifications relating to other details of how to perform the analysis may additionally or alternatively include definition of an indexed identifier field to use for linking data for correlation purposes, for example, linking in-field end-user device performance data of a collection of devices to the manufacturing data of individual elements included in the devices, identified by unique element identifiers, to assess correlation between the two sets of data. In another example, in-field end-user device performance data of a collection of devices may be linked to wafer-level manufacturing data of components included in the devices, according to component wafer of origin, to assess correlation between the two sets of data, for example, between a device performance metric and a set of wafer-level manufacturing conditions. Analysis specifications may also or instead include constructs specifying how any of the various types of data are to be combined and used during analysis, for example in the form of mathematical or logical expressions of a combination of data for use as an in-field end-user device performance metric, or for use as one of the conditions within a set of element manufacturing conditions. Analysis specifications may also or instead include details used to direct the flow at any of FIG. 3 flow decision points 332, 333, 328, and 329. For example, it may be specified at stage 324 that analysis should include N periodic repetitions without redefining analysis specifications (N passes of “yes” to decision 332 followed each time by “no” to decision 333, and in each of the N repetitions, applying a “yes” to decision 329). In such an example, the duration of delay 329a may also be specified, such that each of the N repetitions of stage 330 occur after a particular fixed time interval has passed. In some embodiments, rather than specifying only fixed conditions for directing flow decision points 332, 333, 328, and 329 and/or for specifying the duration of delay 329a, the operator may provide instead, or in addition, specifications that depend on some of the results of preceding analysis repetitions. For example, it may be specified that if two successive analysis iterations produce a change of less than 5% in the statistical significance of a correlation that the duration of delay 329a in the subsequent iteration be set to twice what was used in the preceding iteration, and in addition, that delay 329a be limited to a maximum duration of two weeks (regardless of analysis results).

Analysis specifications may additionally or alternatively include specifications on how to relate to the outcome of the analysis. For instance, the specifications may specify which results may be considered spurious, etc.

Following either stage 324 or stage 327, a decision 328 may be made (e.g. by data analysis engine 14) on whether to query in-field devices for data prior to executing the analysis, or not. Queries for data may optionally be made prior to performing analysis in some embodiments in order to ensure that the desired in-field end-user device data are available in the database before performing analysis. For example, if the set of default data automatically received at stage 307 does not include a particular parameter required for a device performance metric that has been defined in the pending analysis, data for the missing parameter may be received from in-field devices by initiating data collection on an ad-hoc basis via a query in stage 328a, after a “yes” response to decision 328. In some embodiments FIG. 2 boxes 16, 17, and possibly 18a/18b may be used to convey the query to in-field devices, as previously described. Devices responding to the query generated in stage 328a may transmit the required data, which may then be automatically received in an iteration of stage 307. In some other embodiments data received in stage 307 may be the result of in-field end-user device queries generated at points within different flows than that shown in the exemplary flow of FIG. 3, for example, the query shown in the flow of FIG. 7 which may optionally occur after data analysis has been completed (to be described below).

Following query decision 328, decision 329 (e.g. by data analysis engine 14) may determine whether to delay the analysis execution, or not. For clarity and convenience, the delay of the flow chart is shown as an optional loop of an unspecified number of repetitions through delay box 329a (of an unspecified delay duration), to achieve a total delay of arbitrary duration, although the invention need not be limited by a delay implemented as shown in the flow of FIG. 3. After passage of a cumulative delay sufficient for analysis requirements, if delay is applied, the answer to the “Delay Analysis?” question of decision 329 may change from “yes” to “no” and analysis execution is allowed to proceed. Delays may optionally be made prior to performing analysis in some embodiments for various reasons. For instance, in some embodiments the same analysis may be periodically repeated at various times following fixed or varying time intervals, for example to determine whether or not correlation between in-field device performance data and a set of manufacturing conditions of device elements is varying through time with respect to a reference relationship for a fixed set of in-field devices and elements within those devices. In such an example the introduction of delay between analysis iterations may be set to detect degradation of device performance over usage/time-in-field, sometimes referred to as performance “drift”. In some embodiments a drift metric (i.e., a measure of drift) may be calculated from a repetition of measurements of a given device performance metric over time, to quantify device performance degradation over the set of measurements made. For example, if the minimum power supply voltage under which a component remains functional (Vddmin) may be measured both in a component manufacturing test operation and also in the field when the component has been included as an element of an end-user device, the “time zero” Vddmin value (from component manufacturing) may be compared to Vddmin values generated at various times while a device including the component is in use in the field. If the Vddmin value increases through use, constituting a degradation in Vddmin performance, the rate of degradation, for example, may be computed (e.g. by data analysis engine 14) and used as a drift metric. In some embodiments in-field device performance can be measured by a drift metric, since such degradation may be viewed as a performance problem (often relating to poor device reliability performance). For example, continuing with the example of Vddmin degradation, a set of Vddmin measurements generated in-field at various points of time for devices in use in the field may be used to perform a linear regression data analysis to determine for each device a best-fit line to its set of measurements, using Vddmin as an dependent Y variable and time of data generation (or alternatively, cumulative device usage hours up to the point of data generation) as an independent X variable. Continuing with the example, the slope of the best-fit line may be computed for each device, and a criterion based on the slope may be defined as a drift metric by which the performance of each device may be measured, in which devices with a higher value (more positive slope/increasing Vddmin values over time) are of greater reliability concern than devices with a lower value (less positive slope, or zero slope/unchanging Vddmin values over time). In-field device performance can optionally be measured by a drift metric in any of the various embodiments described above, when suitable device data are available to detect the presence or absence of drift. For example, in embodiments of the above methods that optionally utilize in-field device performance, a drift metric may be used to measure device performance. In these embodiments, it may be concluded whether or not there is a correlation between certain manufacturing conditions and a drift metric, for instance by determining if there is a statistically significant difference between an association of certain manufacturing conditions with devices in one population and an association of certain manufacturing conditions with devices in a second population, where the two device populations are distinguished by one or more criteria depending on drift metric values, or if there is a statistically significant difference in drift metric values between devices whose manufacturing corresponds to certain manufacturing conditions and devices whose manufacturing does not correspond to certain manufacturing conditions. Additionally or alternatively in these embodiments, it may be concluded whether or not drift metric values are consistent to manufacturing data by determining if there is a statistically significant difference between a relationship (from correlating drift metric values and manufacturing data) and a reference relationship (between other drift metric values/drift metric modeled version and other manufacturing data/manufacturing data modeled version).

Continuing with discussion of various embodiments that may include delays prior to performing analysis, another example will now be provided. Analysis iterations may be performed in some embodiments at multiple points in time in order to sample data from differing collections of in-field devices and elements within devices, providing insight into variation to a reference relationship which may relate to variation in the element or device manufacturing processes. In another example, a delay may be introduced in order to allow time for additional data to be received and databased, to build up a population of devices and/or elements for the analysis of adequate size to allow conclusions on correlation statistical significance, or to provide time for in-field device data requested in query 328a to be received at 307 and databased at 313, before continuing to stage 330. In some embodiments, in addition to or instead of delays introduced between analysis iterations, the Delay Analysis 329 decision may depend on arrival of particular data required to complete analysis, such that the “yes” branch is followed when the required data are not yet available and the “no” branch is followed after the required data have become available.

Continuing with stage 330, the analysis may be executed (e.g. by data analysis engine 14) under the currently defined/redefined or existing analysis specifications. Various types of analysis may be possible at this stage, and each may be performed under a variety of possible conditions. Embodiments of various possible types of analysis for this stage are provided as examples in FIGS. 6a, 6b, and 6c, which are described below. For any of these, various analysis specifications may be altered, for example, by changing in-field device types selected, changing element types selected, altering sets of manufacturing conditions, altering date range of received data to specify the timeframe of data to include in analysis, changing performance parameters/metrics, changing statistical models selected, altering statistical significance thresholds etc. Continuing, in stage 331 one or more actions may optionally occur based on the outcome of the analysis of box 330. A decision may then be made at 332 (e.g. by data analysis engine 14) as to whether to repeat the analysis in some form, or not. If “no”, then the flow may end at box 334. If “yes”, then a second decision may be made at 333 as to whether to redefine the analysis specifications before repeating analysis, or not. As described in some of the examples provided above related to the delay analysis decision 329, there may be embodiments for which no changes to analysis specifications are desired before repeating analysis (other than delaying the next iteration by a given interval). For example, such repeating may be performed for different data received over time from the same in-field end-user devices, to determine whether or not a previous determination of a statistically significant difference remains stable. Continuing with this example, if a first analysis iteration concludes that a statistically significant difference in correlation to a set of element manufacturing conditions exists between populations of devices distinguished by in-field performance, another analysis iteration may be executed at a later time using in-field performance data from the same populations of devices to determine whether that conclusion continues to hold. Similarly, if a first analysis iteration concludes that there is not a statistically significant difference in a relationship between data received from in-field end-user devices and manufacturing data of elements included in the devices and a corresponding reference relationship, in some embodiments another analysis iteration may be executed at a later time using in-field end-user data from a different collection of devices, and different manufacturing data of elements included in the devices, to determine whether the observed absence of a statistically significant difference continues to hold. For such embodiments, the “no” path from decision 333 may permit analysis to be repeated under unchanged specifications (with method 300 continuing to stage 330).

If the “yes” path is chosen, the flow returns to the “define or redefine analysis specifications” stage at box 324, where the type of analysis or any/all conditions of the current analysis type may be changed before repeating analysis execution. In some embodiments the changes made in successive analysis iterations may be made purely under human direction, while in other embodiments the changes made in successive analysis iterations may be made purely under machine direction. Under some other embodiments the changes made in successive analysis iterations may be made under a combination of human and machine direction. (It is noted that these same options may also apply when defining analysis specifications at box 324 for an analysis that will be run only once.) Under some embodiments, the changes made in successive iterations may vary so that depending on the iteration, the changes may be made under human direction, under machine direction, or under both human and machine direction. There may be many embodiments for which a repetition of analysis under varied specifications may be desired. For example, if analysis has indicated a correlation between a set of manufacturing conditions of a population of elements and in-field end-user device performance data of devices including this element population, it may be desired to explore an alternate set of manufacturing conditions to identify different element populations in a subsequent analysis than identified previously. Say, for example, one may change analysis specifications to apply a subset of the original set of manufacturing conditions to determine whether an observed statistically significant difference is strengthened or weakened under the subset of conditions. For another example, an alternate statistical metric or statistical model may be used in a subsequent analysis iteration in order to determine whether the statistical significance is strengthened or weakened under the alternate statistical treatment, for example repeating analysis after setting a different minimum difference for statistical significance than was set in a previous analysis iteration. For another example, an alternate device performance metric may be defined for use in a subsequent analysis iteration in order to identify different device populations for a subsequent analysis than identified previously to determine whether a previously observed statistically significant difference is strengthened or weakened with the change, for example, examining several similar performance metrics that differ only by the device operating temperatures under which data are generated to gauge an observed correlation as a function of temperature. For another example, if it is not known a-priori what set of element manufacturing conditions may correlate to a given device performance population, it may be desired to iterate through analysis multiple times, automatically evaluating a different set of element manufacturing conditions in each iteration. In such an embodiment a given analysis method may be repeated one or more times, each time using a different set of manufacturing conditions where none of the conditions of successive iterations is exactly identical to the sets of manufacturing conditions used in preceding analysis iterations. For example, if an operator wishes to explore correlation of in-field device performance data to each of the various testers used in testing elements included in devices during element manufacturing, an analysis sequence may be executed varying a set of manufacturing condition(s) such that a different tester may be specified in each iteration, and the correlations of the set of manufacturing condition(s) for resulting populations of elements to in-field device performance may be analyzed to determine whether or not there is a statistically significant difference in performance for populations of devices including only elements tested using each given tester (relative to populations using other testers). Although analysis redefinition in the successive analysis iterations described in this example may in some embodiments be manageable by a human operator, in some such embodiments it may be necessary to evaluate thousands or perhaps millions of sets of candidate element manufacturing conditions in various combinations, which, to be practical, may require machine-assisted analysis redefinition in successive iterations.

FIG. 4 is a flowchart of a method 400 for defining or redefining analysis specifications, in accordance with some embodiments of the presently disclosed subject matter. Method 400 is an example of stage 324 of FIG. 3. In some embodiments, method 400 may be performed by data analysis engine 14. In FIG. 4, flow execution is sequential, through three similarly structured sub-flows 410, 420, and 430 which are each surrounded by a dashed box. Starting at FIG. 4 box 401, decision 411 of sub-flow 410 determines whether or not there is a need to input analysis specifications related to devices and device performance, for example which device types to include, what timeframe of received data to include, what performance metric to apply, and so on. If such analysis specifications have been previously provided and there is no need for altering them, a “no” decision is made and the flow may continue to decision 421 of sub-flow 420. Note that method 400 may include input by human (e.g. provided via client(s) 11), input by machine (e.g. generated by data analysis engine 14), or input by machine and human, separately (e.g. with some input by machine and some input by human) or collaboratively. Therefore, subsequent to a “yes” decision at 411, the illustrated embodiment shown in FIG. 4 may include a decision 413 to determine whether or not machine input will be provided and also a decision 417 to determine whether or not human input will be provided. After a “yes” at decision 413, machine input may be provided at box 415, possibly incorporating received database data from box 416 in the formulation of the defined or redefined analysis specifications related to devices and device performance. The dashed arrow connecting box 416 to box 415 is intended to indicate this flow for an embodiment that incorporates database data in machine input. In the embodiments shown, stage 416 may receive data for input to stage 415, for example, from Database 10 of FIG. 2. Following either stage 413 or stage 415, decision 417 may determine whether or not human input will be provided. After a “yes” at decision 417, human input may be provided at box 419. Although not shown in FIG. 2, data for input at stage 419 may be provided, for example, from Database 10 of FIG. 2. Depending on the embodiment, each of machine input and human input may or may not incorporate database data. Following either stage 417 or stage 419 (or a “no” in stage 411 as discussed above) the flow continues to sub-flow 420 and then to sub-flow 430, which are each similar in structure to sub-flow 410. In the embodiment of FIG. 4, decision 421 determines whether or not there is a need to input analysis specifications related to elements and set(s) of manufacturing conditions, and decision 431 of sub-flow 430 determines whether or not there is a need to input analysis specifications related to analysis type and associated parameters. For example, decision 421 may be dependent on which element types to include, what element manufacturers to include, what manufacturing steps and sets of manufacturing conditions to include, and so on. In some embodiments decision 421 may be dependent at least partly on a preceding analysis execution result, for example one resulting in a correlation conclusion, or alternatively, one not resulting in a correlation conclusion. If based on such a result the analysis is to be repeated under modified conditions, for example, under one or more sets of manufacturing conditions such that at least one set of manufacturing conditions is different than that specified in the previous analysis execution (upon which a decision to repeat analysis has been based), then the “yes” path may be followed to input the modified specifications. In some embodiments at 431, the decision may depend on which statistical method to apply in evaluating the relationship between in-field device data and element manufacturing data, what limits to apply for accepting data for use in the analysis, what statistical significance to apply to draw analysis conclusions, and so on. For example, choices made in subflows 410 and/or 420 may bear on decision 431, for instance when the kinds of data to be analyzed may influence the specification of the statistical method appropriate to performing an analysis. Continuing with this example, if an in-field end-user device performance metric such as power consumption has been specified at stage 413 or stage 417, a comparison of power consumption means of populations may suitably be performed using Student's t Distribution statistics, while if the performance metric instead has been specified as the frequency of random soft failure events of populations, then Poisson statistics may more suitably be used. Following the “yes” branch from 431 in this case, the statistical treatment best suited to the kind of data being analyzed may be specified at stage 435 or stage 439. In some embodiments decision 431 may be dependent at least partly on choices made for preceding analysis specification items. For example, if in some embodiments a different minimum difference for statistical significance than was set in a previous execution of a given analysis type is to be input, based at least partly on an analysis result from the previous execution, then the “yes” path may be followed to input the modified specification. In some embodiments the analysis type selected at subflow 430 may influence the options for specifying analysis parameters, since parameters that may be relevant for one analysis type may be irrelevant for another analysis type. For instance, if the analysis type selected is one to conclude whether or not a statistically significant difference exists between a relationship determined based on data received from in-field end-user devices with data related to manufacturing of elements included in the given collection of devices, and a reference relationship, then a reference relationship must be specified. In such an instance, the specification may be provided, for example, by a statistical description of a reference relationship, or for another example, by selecting a set of data from which a reference relationship may be derived (for example, a historical reference data set). However, if the analysis type selected is not one that requires a reference relationship, then in subflow 430 no reference relationship specifications may be needed. On the other hand, in some embodiments, some analysis specification options may be applicable and available for input regardless of the analysis specification choices already made, for example, an option for specification of date range of source data to use for requesting data from a database for use in analysis. Continuing with another example, a limit defining the minimum number of data points required in order to execute analysis with a statistically meaningful conclusion may be generally applicable, and may be defined for any data type and any type of analysis.

As in subflow 410, if input is provided in sub-flow 420 and/or 430, the input may be machine input and/or human input. Following sub-flow 430 all input that may have been provided in sub-flows 410, 420, and 430 may be saved in the stage of box 440, to be retrieved and used for analysis execution (stage 330 of FIG. 3) immediately or at a later time, and/or to be retrieved and modified at a later time. In view of the fact that a complete definition of analysis type and analysis specifications may involve dozens of specifications, the reader should understand that FIG. 4 is exemplary and is not meant to convey all possible specifications that may be necessary to define all analyses that may be executed in stage 330 of FIG. 3.

FIG. 5 is a flowchart of a method 500 of analysis definition or redefinition that includes input that is provided through collaboration of machine and human, in accordance with some embodiments of the presently disclosed subject matter. In some embodiments, method 400 may be performed by data analysis engine 14. Sub-flow 510 may be an example of stages 413-419 of FIG. 4, sub-flow 520 may be an example of stages 423-429 of FIG. 4, and subflow 530 may be an example of stages 433-439 of FIG. 4. In method 500, a series of computer-generated operator menus may be created (e.g. by data analysis engine 14) based on the content of a database, such as database 10 of FIG. 2. At interleaving stages, a human operator may provide input (e.g. via client(s) 11) from menu options presented to indicate an analysis desired from a series of selections, and consequently the analysis may be defined or redefined (e.g. by data analysis engine 14) accordingly. In this exemplary embodiment, machine input based on database content may occur at stages marked with an asterisk, including stages 511, 513, 521, 523, 531, and 533. Human input based on the resulting menus presented from machine input may include stages 512, 514, 522, 524, 532, and 534. In the embodiment shown, a simple machine intelligence may be applied, as the menus presented to an operator for input selection are limited only to options that are consistent with previous selections. For example, at stage 512, if presented with a menu of all available device types that are contained in the database, a human operator may input device type selection criteria to limit analysis to a single device type (for example, by inputting that only a particular device manufacturer and device model number are to be included), and also to limit analysis to a particular timeframe (for example, by inputting that only the last thirty days are to be included) of in-field end-user data received for the specified device type, and thus the analysis may be defined or redefined accordingly. Continuing with this example, at stage 513, based on the operator selection criteria input at stage 512, a computer-generated menu including only relevant in-field end-user data fields may be prepared (i.e., those that are present in the database for the selected device type and timeframe specified), and all data fields not meeting the previously provided operator criteria may be suppressed. At stage 514, after being presented with the computer-generated menu of stage 513, the human operator may input a performance metric for the device type and timeframe of interest, based on the available data, and thus the analysis may be defined or redefined accordingly.

Although the simple human-machine collaborative method of FIG. 5 is offered as an example here, it does not limit the generality of method 400 of FIG. 4. In some other embodiments of method 400, the definition and redefinition may be performed using solely human input. In some other embodiments of method 400 the definition and redefinition of analysis specifications (also referred to as criteria) may be entirely performed by machine (without human input), for example, using an algorithm to automatically search for statistically significant relationships between populations of devices distinguished by in-field end-user device performance data and sets of manufacturing conditions of elements included within those devices. In some embodiments of method 400, there may be other types of collaborative input. For instance, such an algorithm to automatically search for statistically significant relationships may be executed collaboratively with human input on some of the algorithm specifications, for example, providing during the definition and redefinition stage a computer-generated statistical summary of data in the database for review by a human operator and allowing the operator to increase analysis efficiency by guiding machine searches for such relationships to favor those judged by the human operator to be most likely to be statistically significant and useful, based on review of the statistical summary of data.

FIGS. 6A, 6B, and 6C are flowcharts of three methods 600A, 600B, and 600C respectively, of analyzing at least in-field data for end-user devices and data relating to manufacturing of elements included in the devices, in accordance with some embodiments of the presently disclosed subject matter. In the preceding description and in what follows, the term “analysis type” is used to refer to any such method, including but not limited to any of the three exemplary methods. In some embodiments such methods may be executed at stage 330 of FIG. 3, for example after specifying one of these methods when defining or redefining analysis type at stage 324 of FIG. 3. In some embodiments, the execution at stage 330 of the specified method may be performed by Data Analysis Engine of box 14 of FIG. 2. Some embodiments of the methods of the invention are shown for convenience as a sequence of related stages spanning several of the provided figures, but may in some cases represent a cohesive sequence of stages of a single method, or in some cases may represent stages of several related methods that may be executed in sequence, or may be executed in sequence with methods other than those provided in the figures. The invention is not limited by the manner of representation of the methods disclosed. Although methods 600A, 600B, and 600C (corresponding to FIGS. 6A, 6B, and 6C) are described in what follows, the subject matter is not limited by these embodiments. Any computer implemented method suitable to determining if there is a correlation between a set of one or more manufacturing conditions and performance of in-field end-user devices, or suitable to determining if there is an inconsistency in at least one of in-field end-user devices data or manufacturing data of electronic elements included in the end-user devices, may be applicable to the subject matter.

The flow of method 600A of FIG. 6A will now be described. Method 600a may be performed by Data Analysis Engine of box 14 of FIG. 2. Starting at stage 601, decision 602 may determine whether or not in-field end-user device data of devices are already linked to manufacturing data of elements included in the devices, per the specifications of the analysis being performed. In an embodiment executing method 600a within stage 330 of FIG. 3, input data for determining decision 602 may require requesting data at FIG. 3 stage 325, and receiving the requested data via stages 322 and 326. Several stages of method 600A requiring data may involve such a sub-flow, such as any of stages 603, 605, 606, or 607. If specified data are already linked, preferably by a field identifying records of in-field end-user device data with corresponding records of manufacturing data of elements included within the devices, the “yes” path may bypass stage 603. If received data are not already linked, the “no” path to stage 603 may be followed to appropriately link in-field end-user device data to manufacturing data of corresponding elements, per the specifications of the analysis being performed. As previously described, in some embodiments data fields upon which this linking may be based may already be included in the records of in-field device data, and/or in the records of element manufacturing data, while in some embodiments the association between devices and elements included in devices may be received separately (for example, at FIG. 3 stage 303 or stage 304) and thus may also be required to complete this linking Continuing to decision 604, embodiments of the method requiring additional device data, for example device manufacturing data, out-of-service data, and/or adjunct data may follow the “yes” path to decision 605, while those not requiring additional device data may follow the “no” path to stage 607. At decision 605, if any required additional device manufacturing, out-of-service or adjunct data are not already linked to in-field end-user device data by a field identifying records of in-field end-user device data with corresponding records of additional device data, the “no” path may be followed to stage 606 where corresponding data records are linked, per the specifications of the analysis being performed. If a “yes” is determined at decision 605, stage 606 may be bypassed. The order in which corresponding records may be linked in stages 602-606 is not limited to that shown in the embodiment of FIG. 6a. Other embodiments of the presently disclosed subject matter may link corresponding records in a different order than the order of linking of FIG. 6A, and/or may link corresponding records at stages external to those shown in FIG. 6A, such as at stage 312 of FIG. 3.

At stage 607 received in-field data and/or data computed based on received in-field data may be analyzed to identify at least a first population and second population among end-user devices distinguished at least by in-field performance. For example, the received in-field data or data computed based on received in-field data may be analyzed according to analysis specifications.

At stage 608, association of a set of manufacturing condition(s) with received data and/or data computed based on received data, relating to manufacturing of elements included in end user devices of the first population, may be determined. For example, association may be determined according to analysis specifications.

At stage 609, association of this set of manufacturing condition(s) with received data and/or data computed based on received data, relating to manufacturing of elements included in end user devices of the second population, may be determined. For example, association may be determined according to analysis specifications.

At stage 610, it may be determined whether or not there is a statistically significant difference between the associations determined in stages 608 and 609. For example, it may be determined whether or not there is a statistically significant difference between the association of the set of manufacturing condition(s) of elements included in end-user devices of the first population to in-field performance of the first device population, and the association of the set of manufacturing condition(s) of elements included in end-user devices of the second population to in-field performance of the second device population. At decision 611, if a statistically significant difference between the associations has been determined at stage 610, the “yes” path may be followed to stage 612 where it may be concluded that a correlation exists between the set of manufacturing condition(s) and the in-field performance. For example, it may be concluded that a correlation exists between device populations and the set of manufacturing condition(s) of elements included in end-user devices of device populations, for the defined (or redefined) analysis specifications. If a statistically significant difference has not been determined at stage 610, the “no” path from decision 611 may be followed to stage 613, where it may be concluded that no correlation exists between the set of manufacturing condition(s) and the in-field performance. For example, it may be concluded that no correlation exists between device populations and the set of manufacturing condition(s) of elements included in end-user devices of device populations, for the defined (or redefined) analysis specifications.

Continuing now with FIG. 6B, starting at box 621, decisions and stages 622 through 626 may be identical in function to those described above for the corresponding FIG. 6a decisions and stages 602 through 606, and for the sake of expediency will not be described again here.

At stage 627 received data and/or data computed based on received data relating to manufacturing of electronic elements may be analyzed to identify at least two populations among elements, where manufacturing of a first population corresponding to a set of one or more manufacturing conditions may be identified. For example, manufacturing of the first population may be identified as corresponding to a set of one or more manufacturing conditions that may be determined according to analysis specifications.

At stage 628 received data and/or data computed based on received data relating to manufacturing of electronic elements may be analyzed to identify a second population of the at least two populations, but where manufacturing of the second population does not correspond to the set of one or more manufacturing conditions. For example, the second population may be identified as corresponding to a set of one or more manufacturing conditions that may be determined according to analysis specifications, and are not identical to the set of one or more manufacturing conditions.

At stage 629 received in-field data and/or data computed based on received in-field data may be analyzed in order to determine whether or not there is a statistically significant difference in in-field performance between end-user devices including elements from the first population and end-user devices including elements from the second population. At decision 630, if a statistically significant difference in the in-field performance between end-user devices including elements from the first population and end-user devices including elements from the second population has been determined at stage 629, the “yes” path may be followed to stage 631 where it may be concluded that a correlation exists between the set of manufacturing condition(s) and the in-field performance. For example, it may be concluded that a correlation exists between device populations and the set of manufacturing condition(s) of elements included in end-user devices of device populations, for the defined (or redefined) analysis specifications. If a statistically significant difference has not been determined at stage 629, the “no” path from decision 630 may be followed to stage 632, where it may be concluded that no correlation exists between the set of manufacturing condition(s) and the in-field performance. For example, it may be concluded that no correlation exists between device populations and the set of manufacturing condition(s) of elements included in end-user devices of device populations, for the defined (or redefined) analysis specifications.

Continuing now with FIG. 6C, starting at box 641, decisions and stages 642 through 646 may be identical in function to those described above for the corresponding FIG. 6a decisions and stages 602 through 606, and for the sake of expediency will not be described again here.

At stage 647 in-field data such as received in-field data and/or data computed based on received in-field data for end-user devices may be correlated with manufacturing data such as received data relating to manufacturing, and/or data computed based on received data relating to manufacturing, of elements included in the devices in order to determine a relationship.

At stage 648 the relationship may be compared to a reference relationship, where the reference relationship may be between other in-field data and/or a modeled version of in-field data and other manufacturing data and/or a modeled version of manufacturing data.

At stage 649 it may be determined whether or not there is a statistically significant difference between the relationship and the reference relationship. At decision 650, if a statistically significant difference between the relationship and the reference relationship has been determined at stage 649, the “yes” path may be followed to stage 651 where it may be concluded that the in-field data that were correlated are inconsistent, and/or the manufacturing data that were correlated are inconsistent. For example, it may be concluded that an inconsistency exists in the in-field data and/or the manufacturing data, for the defined (or redefined) analysis specifications. If a statistically significant difference has not been determined at stage 649, the “no” path from decision 650 may be followed to stage 652, where it may be concluded that the in-field data that were correlated are consistent, and that the manufacturing data that were correlated are consistent. For example, it may be concluded that in-field data and manufacturing data are consistent, for the defined (or redefined) analysis specifications.

Optionally, for method 600A of FIG. 6A, stages 608 and 609 may consider a plurality of sets of manufacturing conditions rather than one set, and determine the association for the plurality of sets in each of stages 608 and 609. In this case, the determination in stage 610 of whether or not there is a statistically significant difference and the conclusion in stages 612 and 613 may also relate to the plurality of sets rather than to just one set. Similarly, for method 600B of FIG. 6B stages 627 and 628 may consider a plurality of sets of manufacturing conditions for the first population and the second population, rather than one set. In this case, the determination in stage 629 of whether or not there is a statistically significant difference and the conclusion in stages 631 and 632 may also relate to the plurality of sets rather than to just one set. Similarly, for method 600C of FIG. 6c stage 647 may consider a plurality of manufacturing data fields of elements included in the devices, rather than a single data field, to determine a relationship between in-field end-user device data and manufacturing data of elements included in the devices, and may compare the relationship of stage 647 to a reference relationship in stage 648, where the reference relationship is also based on a plurality of manufacturing data fields and/or a plurality of fields of modeled versions of manufacturing data. In this case, the determination in stage 649 of whether or not there is a statistically significant difference between the relationship and the reference relationship may also relate to the plurality of manufacturing data fields rather than to just one data field.

In embodiments of the above methods that optionally utilize device manufacturing data, out-of-service data, and/or adjunct data (i.e., those following the “yes” path at decision 604/624/644), an in-field performance metric may be based on one or more types of in-field end-user device data (as received or as computed based on the received data) in mathematical and/or logical combination with some of the additional types of device data listed (as received or as computed based on the received data), and therefore may be a function of these various types of data. Such an in-field performance metric may, for example, be used in stage 607 of method 600A to distinguish a first and a second population among end-user devices; may be used in stage 629 of method 600B to determine whether or not there is a statistically significant difference in in-field performance between devices including a first population of elements and devices including a second population of elements; and/or may be used in stages 647 and/or 648 of method 600c in forming the relationship and/or reference relationship being compared so as to determine at stage 649 whether or not a statistically significant difference exists between the relationship and reference relationship. In other embodiments of the above method that do not utilize these additional types of device data (i.e., those following the “no” path at decision 604/624/644), an in-field performance metric used in e.g. stage 607/629/647/648 may be based on one or more types of in-field end-user device data (as received or as computed based on the received data), without any use of the additional types of device data listed.

Additionally or alternatively, in embodiments of the above methods that optionally utilize device manufacturing data, manufacturing data relating to a given device may be used to supplement the data relating to manufacturing of elements included in the given device. In these embodiments, it may be concluded whether or not there is a correlation between certain device manufacturing conditions and in-field performance, for instance by determining if there is a statistically significant difference between an association of certain device manufacturing conditions with devices in one population and an association of certain device manufacturing conditions with devices in a second population, or if there is a statistically significant difference in performance between devices whose manufacturing corresponds to certain device manufacturing conditions and devices whose manufacturing does not correspond to certain device manufacturing conditions. Additionally or alternatively in these embodiments, it may be concluded whether or not in-field data are consistent to device manufacturing data by determining if there is a statistically significant difference between a relationship (from correlating in-field data and device manufacturing data) and a reference relationship (between other in-field data/in-field data modeled version and other device manufacturing data/device manufacturing data modeled version).

FIG. 7 is a flowchart of a method 700 for acting on the results of an analysis, in accordance with some embodiments of the presently disclosed subject matter. Method 700 is an example of stage 331 of FIG. 3. In some embodiments method 700 may be performed by FIG. 3 Data Analysis Engine 14, configured to perform and/or to trigger the various actions of the exemplary embodiment automatically after stage 330 analysis execution has been completed. Variations of the flow of FIG. 7 may be possible, with features that may depend on the analysis type and requirements of the method operator. The exemplary embodiment includes stages 703-712 for optionally classifying a correlation conclusion as spurious or non-spurious, stages 713-716 for optionally sending feedback to device and/or element manufacturers, and stages 717-718 for optionally querying in-field devices for additional in-field end-user device data.

Starting at box 701, decision 702a may determine whether the analysis performed (for example, at stage 330 of FIG. 3) has concluded whether or not a correlation exists between a set of one or more manufacturing conditions of elements and performance of in-field end-user devices including the elements, such as may occur in methods 600a or 600b. If the analysis has not concluded whether or not such a correlation exists, the “no” path may be followed to decision 702b to determine whether the analysis performed has concluded whether or not there is an inconsistency in at least one of in-field end-user devices data or manufacturing data of electronic elements included in the end-user devices, such as may be the result of method 600c. For the embodiment of FIG. 7, the flow is such that either a “yes” or “no” at 702b result leads to stage 713, in both cases bypassing stages 702c-712. In some embodiments, alternatively, the “no” path from 702b may lead directly to the end of the flow, box 719, such that none of the conditional actions included in method 700 may be performed. Returning to the “yes” path from 702a, if followed, decision 702c may determine whether or not a preceding analysis was completed with a conclusion of correlation, such as may result from methods 600a or 600b. If so, the “yes” path may be followed to decision 703, while if a preceding analysis such as methods 600a or 600b were completed with a conclusion that no correlation exists, the “no” path may be followed to decision 713. In some embodiments, alternatively, the “no” path from 702c may lead directly to the end of the flow, box 719, such that none of the conditional actions included in method 700 may be performed.

As previously described, conclusions relating to correlations may sometimes be classified as spurious, and as such may be of no interest (e.g. to an operator of the method of FIG. 3). Provisions for accordingly classifying a correlation conclusion as spurious or non-spurious are provided in stages 703-712. Some embodiments may include an automated spurious check rule that may be executed at stage 704 to determine whether the type of correlated data of a present analysis result have previously been classified as being spuriously related. In such embodiments a “spurious check rule” may have been established prior to executing an analysis, including one or more sets of potentially correlated types of data that have been classified as spuriously related, to be referenced when determining whether or not a correlation being checked by the rule is spurious, or not. An indication that a particular spurious check rule is to be executed in conjunction with a given analysis may, for example, have been provided as part of the definition or redefinition of analysis specifications, for example, at stage 324 of FIG. 3. Continuing with this example, in some embodiments, any or all of the flow options of method 700 may have been provided as part of the definition or redefinition of analysis specifications at stage 324 of FIG. 3, including for example, decisions 703, 705, 711, 713, 715, and 717.

If spurious check rule execution is indicated at decision 703, the “yes” path from 703 may be followed to 704, where it may be determined whether a correlation conclusion from an analysis is classified as spurious or non-spurious. Stage 704 may be bypassed by the “no” path from decision 703. Some embodiments may include, instead or in addition, an operator spurious check for such correlation classification, which may be performed at stage 706. Stage 706 may be bypassed by the “no” path from decision 705. Arriving at decision 707 it may be determined whether or not a spurious check was performed, at either stage 704 or stage 706, or at both stages. If “no”, the flow may continue to decision 713 without any spurious check being performed on the present correlation. If the “yes” path is followed to decision 708, it may be determined whether or not the check(s) of the present correlation indicated a spurious classification. The logic of decision 708 may in some embodiments be configurable to produce a “yes” result (to stage 709 for a spurious conclusion of correlation), or a “no” result (to stage 710 for a non-spurious conclusion of correlation) depending on the various possible outcomes of stages 704 and 706. For cases in which both stages 704 and 706 have been executed there may be four binary combinations of outcomes possible: 1-1, 1-0, 0-1, and 0-0, where ‘1’ represents a spurious classification and ‘0’ represents a non-spurious classification from each of stage 704 and stage 706 respectively. In particular, the 1-0 case and the 0-1 case are ambiguous and each of these two cases may lead either to the “yes” branch or to the “no” branch, depending on the logic provided for decision 708 in a given embodiment. Arriving at decision 711, an option may exist to create or update a spurious check rule based on the conclusion 709 or 710. After execution of stage 706 has led to a spurious correlation conclusion at stage 709 it may be desired to update an existing spurious rule check (at stage 712, via the “yes” path from 711) to improve the coverage/efficiency of an existing embodiment of method 700, for example, if an ambiguous outcome as described above has produced a 1-0 or a 0-1 rule check result, then an existing spurious rule check may be updated to make it coherent with an operator spurious check result. If no existing or applicable spurious check rule exists, at stage 712 a new spurious check rule may alternatively be created. If, at decision 711, the “no” path is followed, stage 712 is bypassed and there will be no creation or updates to spurious check rules.

Arriving at sub-flow 713-716, determinations and/or reports related to the current analysis, optionally including the results of spurious checks and spurious check rule updates that may have been performed in sub-flow 703-712, may be sent to either a device manufacturer or to an element manufacturer, or to both. In some embodiments such determinations and/or reports may instead or in addition be sent to an operator (e.g. who uses client 11) of method 300, which may include method 700. In some embodiments such determinations and/or reports may instead or in addition be sent to a third party, such as an employee of the provider of the system of box 6 of FIG. 2, for example, to an administrator of the system of box 6. Examples of what information may be sent may include any of the following: the specifications of the defined analysis executed, a statistical summary of the data and of the results related to the analysis, a detailed list of identified end-user devices and/or elements corresponding to a correlation or to an inconsistency, a high level description of a grouping of elements whose manufacturing corresponds with the set of manufacturing condition(s) (e.g. elements from a certain lot), a high level description of a grouping of devices at risk (e.g. devices including elements from a particular manufacturer), the results of spurious checks performed, etc. In some embodiments, determinations and/or reports from the current analysis may be supplemented by cumulative information from preceding analysis iterations related to the current analysis, and may be presented in a manner to highlight trends in the results of the successive iterations. In some embodiments, determinations and/or information appearing in reports may alternatively or additionally be stored as data in a database (e.g. database 10) that may be accessible, depending on data access group affiliation, to employees of a device manufacturer or to employees of an element manufacturer, or to an employee of a third party, such as an employee of the provider of the system of box 6 of FIG. 2. In some embodiments, such databased data may be referenced in successive iterations of analysis to determine improvements to analysis results in each iteration, for example, by algorithms implemented and executed automatically to define successive analysis iterations. In some embodiments, data analysis engine 14 within box 6 of FIG. 2 may create any of the various above determinations and/or reports, and may send them, for example, to operators of clients 11 using operator application services 13 of box 6. In some embodiments data analysis engine 14 may alternatively or additionally prepare and store determinations, reports and/or any other information from analysis execution in a database, for example, in database 10 of box 6.

Following sub-flow 713-716, at decision 717, it may be determined whether or not a query of in-field devices will be executed. In some embodiments, for example, the decision may depend on the result of the present analysis in conjunction with logic included in the analysis definition, provided as part of the definition or redefinition of analysis specifications, for example, at stage 324 of FIG. 3. For example, if the default data collection of in-field end-user data supporting a given embodiment of analysis method 600c includes data from only 10% of end-user devices in the field of a given device type, analysis may be defined to increase the fraction of end-user devices providing data to 20% if analysis determines that there is a statistically significant difference between a relationship of correlated in-field device performance data and manufacturing data of elements included in the devices and a reference relationship, and it is concluded that correlated in-field data are inconsistent, and/or that correlated manufacturing data are inconsistent. In this example, an increase in the sampling level to increase confidence in the initial conclusion may be performed by following the “yes” path from decision 717 to stage 718 to query in-field devices. In some embodiments, the decision to query in-field devices at stage 718 may additionally or alternatively be to acquire a different type of in-field end-user device data than may be obtained under default conditions at box 307 of FIG. 3. For example, if in-field data of a given dual band wireless router device model is by default limited to providing performance data in the 2.4 Ghz spectrum, and an analysis of these data concludes that correlated in-field device data are inconsistent or that correlated element manufacturing data are inconsistent, with respect to a reference relationship, then it may be desired to further characterize the inconsistency by repeating the analysis using performance data in the 5 Ghz spectrum. In this example it is given that 5 Ghz performance data may not be generated and/or received by default, and so a query may be executed at stage 718 to cause these additional data to be received. In some embodiments, data analysis engine 14 within box 6 of FIG. 2 may initiate an in-field end-user device query, for example, in conjunction with box 6 in-field device data query generator 16 and in-field device data query transmitter 17.

Other actions which may additionally or alternatively be performed as part of stage 331 subsequent to a conclusion relating to correlations, non-correlations consistencies and/or inconsistencies are described elsewhere herein.

In some embodiments, stages which are shown as being executed sequentially in any of FIGS. 3, 4, 5, 6a, 6b, 6c, and/or 7 may be executed in parallel, and/or stages shown as being executed in parallel in any of FIGS. 3, 4, 5, 6a, 6b, 6c, and/or 7 may be executed sequentially. In some examples, stages may be executed in a different order than illustrated in any of FIGS. 3, 4, 5, 6a, 6b, 6c, and/or 7. In some examples, any of methods 300, 400, 500, 600a, 600b, 600c, and/or 700 may include more, fewer and/or different stages than illustrated in any of respective FIGS. 3, 4, 5, 6a, 6b, 6c, and/or 7.

### Numbered Examples

1. A method of concluding whether or not there is a correlation between a set of one or more manufacturing conditions and performance of in-field end-user devices, comprising:

receiving data relating to manufacturing of electronic elements;

receiving in-field data for end-user devices that include said elements;

analyzing at least one of received in-field data, or data computed based on received in-field data, in order to identify at least a first population and a second population among said end-user devices that are distinguished at least by in-field performance;

determining whether or not there is a statistically significant difference between an association of a set of one or more manufacturing conditions with at least one of received data, or data computed based on received data, relating to manufacturing of elements included in end-user devices of said first population, and an association of said set with at least one of received data, or data computed based on received data, relating to manufacturing of elements included in end-user devices of said second population; and

concluding that there is a correlation between said set and said in-field performance when it is determined that there is a statistically significant difference, or concluding that there is not a correlation between said set and said in-field performance when it is determined that there is not a statistically significant difference.

2. A method of concluding whether or not there is a correlation between a set of one or more manufacturing conditions and performance of in-field end-user devices, comprising:

receiving data relating to manufacturing of electronic elements;

receiving in-field data for end-user devices that include said elements;

analyzing at least one of received data, or data computed based on received data, relating to manufacturing, in order to identify at least two populations among said elements, wherein manufacturing of a first population of said at least two populations corresponds to a set of one or more manufacturing conditions, but manufacturing of a second population of said at least two populations does not correspond to said set;

analyzing at least one of received in-field data, or data computed based on received in-field data, in order to determine whether or not there is a statistically significant difference in in-field performance between end-user devices including elements from said first population and end-user devices including elements from said second population; and

concluding that there is a correlation between said set and said in-field performance when it is determined that there is a statistically significant difference, or concluding that there is not a correlation between said set and said in-field performance when it is determined that there is not a statistically significant difference.

3. A method of concluding whether or not there is an inconsistency in at least one of in-field end-user devices data or manufacturing data associated with electronic elements included in the end-user devices, comprising:

receiving data relating to manufacturing of electronic elements;

receiving in-field data for end-user devices that include said elements;

correlating in-field data including at least one of received in-field data, or data computed based on received in-field data, with manufacturing data including at least one of received data relating to manufacturing, or data computed based on received data relating to manufacturing, in order to determine a relationship;

determining whether or not there is a statistically significant difference between said relationship and a reference relationship, wherein said reference relationship is between at least one of other in-field data or an in-field data modeled version and at least one of other manufacturing data or a manufacturing data modeled version; and

concluding that said in-field data that were correlated are consistent, and said manufacturing data that were correlated are consistent, when it is determined that there is not a statistically significant difference, or concluding at least one of: said in-field data that were correlated are inconsistent, or said manufacturing data that were correlated are inconsistent, when it is determined that there is a statistically significant difference.

4. The method of example 3, wherein if it is concluded that at least one of said in-field data that were correlated are inconsistent, or said manufacturing data that were correlated are inconsistent, the method further comprises: generating a report including a list of at least end-user devices or at least elements corresponding to said relationship.
5. The method of example 1 or 2, wherein said in-field performance includes in-field reliability.
6. The method of example 5, further comprising: predicting a reliability risk for end-user devices that include elements manufactured under one or more manufacturing conditions that would correspond to said set.
7. The method of example 2, wherein at least one of said populations includes elements whose analyzed data relating to manufacturing are similarly abnormal.
8. The method of any of examples 1 to 3, wherein said received data relating to manufacturing of electronic elements include at least data relating to manufacturing of electronic components.
9. The method of any of examples 1 to 3, wherein said received data relating to manufacturing of electronic elements include at least data relating to manufacturing of electronic modules.
10. The method of example 3, wherein at least one parameter, function, or attribute in manufacturing data, is correlated with the same parameter, function, or attribute in in-field data.
11. The method of example 3, wherein at least one parameter, function, or attribute in manufacturing data is correlated with at least one different parameter, function, or attribute in in-field data, respectively.
12. The method of example 10 or 11, wherein a parameter that is correlated in in-field data is a drift metric.
13. The method of example 1 or 2, further comprising: determining said set.
14. The method of example 13, wherein said determining said set is based on at least one criterion for determining said set inputted by an operator, the method further comprising: receiving said at least one criterion for determining said set.
15. The method of example 13, wherein said determining said set is performed without first receiving any criterion inputted by an operator for determining said set.
16. The method of example 1 or 2, wherein if it is concluded that there is a correlation, said method further comprises: generating a report including at least one selected from a group comprising: said set, a high level description of a grouping of end-user devices including elements manufactured under one or more conditions corresponding to said set, a high level description of a grouping of elements manufactured under one or more conditions corresponding to said set, a list of end-user devices that include elements manufactured under one or more conditions corresponding to said set, a list of elements manufactured under one or more conditions corresponding to said set, a high level description of said first population, a list of end-user devices or elements in said first population.
17. The method of any of examples 1 to 3, further comprising: querying said in-field end-user devices for data.
18. The method of example 17, wherein said queried end-user devices are selected from a group comprising: end-user devices whose in-field data suggest poor performance, end-user devices that include elements manufactured under one or more conditions found to be correlated to poor in-field performance, end-user devices including elements manufactured under one or more abnormal conditions, end-user devices for which in-field data that were correlated are inconsistent, end-user devices including elements whose manufacturing data that were correlated are inconsistent, end-user devices from which in-field data were not previously received in addition to or instead of those from which in-field data were previously received, end-user devices from which in-field data were previously received, end-user devices meeting client-provided criteria, or all in-field end-user devices.
19. The method of example 17, further comprising:

using in-field data received from said queried end-user devices, or computed based on data received from said queried end-user devices to enhance a previously calculated relationship.

20. The method of example 17, wherein said querying is directed to specified end-user devices, to less than all in-field end-user devices, or to all in-field end-user devices.
21. The method of any of examples 1 to 3, further comprising:

receiving identifier data along with at least one of received manufacturing data or received in-field data;

if said received identifier data need to be prepared for storage, preparing said received identifier data for storage; and

storing said at least one of received manufacturing data or in-field data, indexed to at least one of said received or prepared identifier data.

22. The method of any of examples 1 to 3, further comprising:

receiving identifier data, including at least one identifier of an end-user device in association with at least one identifier of at least one element that is included in the end-user device, or including at least one identifier of a first element in association with at least one identifier of at least one other element included in the first element;

if said received identifier data need to be prepared for storage, preparing said received identifier data for storage; and

storing at least associations between identifier data.

23. The method of any of examples 1 to 3, further comprising:
receiving data relating to manufacturing of the end-user devices; and linking received in-field data to received end-user device manufacturing data.
   24. The method of example 23, further comprising:

receiving device identifier data along with received device manufacturing data;

if said received device data identifier data need to be prepared for storage, preparing said received device identifier data for storage; and

storing said device manufacturing data, indexed to at least one of said received or prepared identifier data.

25. The method of any of examples 21, 22, or 24, wherein said preparing includes at least one selected from a group comprising: unencrypting data, classifying data according to metadata attributes, error checking data for integrity and completeness, merging data, parsing and organizing data according to desired content of a database, formatting data to meet data input file specifications required for database loading, decoding data at least for human readability or at least for compliance with standards, or reformatting data at least for human readability or at least for compliance with standards.
26. The method of any of examples 1 to 3, further comprising:
for each of one or more of said end-user devices, linking received in-field data for the end-user device with received data relating to manufacturing of elements included in the end-user device,
wherein at least one of said analyzing, determining, or correlating uses linked data.
27. The method of any of examples 1 to 3, further comprising:
for each of one or more of said end-user devices, linking in-field data received from the end-user device with received data relating to manufacturing of elements included in the end-user device,
wherein at least one of said analyzing, determining, or correlating is performed prior to said linking.
28. The method of example 26 or 27, wherein said at least one of said analyzing, determining or correlating occurs substantially immediately after said linking or substantially immediately after said receiving of said in-field data.
29. The method of any of examples 1 to 3, further comprising:

for at least one element which includes at least one other element, linking received data relating to manufacturing of the element with received data relating to manufacturing of the at least one other element.

30. The method of any of examples 1 to 3, wherein
said data relating to manufacturing of said elements includes at least one of: data from manufacturing equipment of one or more element manufacturers or data from one or more manufacturing execution database of said one or more element manufacturers or data from a factory information system of said one or more element manufacturers.
31. The method of example 3, wherein said method is part of at least one of an expanded validation process for at least one of newly introduced devices, newly introduced elements, changes to existing devices, changes to existing elements, or changes to the processes used to manufacture at least one of existing devices or elements, or an extended validation process for at least one of newly introduced devices, newly introduced elements, changes to existing devices, changes to existing elements, or changes to the processes used to manufacture at least one of existing devices or elements.
32. The method of example 3, wherein if it is determined that at least one of: said in-field data that were correlated are inconsistent, or said manufacturing data that were correlated are inconsistent, the method further comprises:
determining whether said inconsistency is or is not part of a trend; and
if it is determined that said inconsistency is part of a trend, then reporting that said inconsistency is part of a trend.
33. The method of example 1 or 2, wherein said set relates to a single manufacturer.
34. The method of any of examples 1 to 3, further comprising: receiving a request for in-field data, for an operator affiliated with a manufacturer of elements; and
providing in response, received in-field data for end-user devices that include elements manufactured by said manufacturer, but not providing received in-field data for end-user devices that do not include elements manufactured by said manufacturer.
35. The method of any of examples 1 to 3, further comprising: receiving a request for data relating to element manufacturing, for by an operator that is affiliated with a manufacturer of end-user devices; and
providing in response received data relating to manufacturing of elements included in end-user devices manufactured by said manufacturer but not providing received data relating to manufacturing of elements not included in end-user devices manufactured by said manufacturer.
36. The method of example 1, further comprising: receiving at least one criterion, inputted by an operator, relating to in-field performance, wherein said at least one of received in-field data, or data computed based on received in-field data are analyzed with reference to said at least one criterion, in order to identify said at least first population and second population among said end-user devices.
37. The method of example 36, wherein at least one other criterion not relating to in-field performance is also received, and wherein said at least one of received in-field data, or data computed based on received in-field data are analyzed also with reference to said at least one other criterion, in order to identify said at least first population and second population among said end-user devices.
38. The method of example 1 or 2, further comprising:
repeating said method for in-field data received over time for the same in-field end-user devices, and determining whether or not a determination of whether or not there is a statistically significant difference continues to hold.
39. The method of any of examples 1 to 3, further comprising:

receiving at least one criterion inputted by an operator for at least one of analyzing, correlating or determining; and

performing said at least one of analyzing, correlating or determining at least partly in accordance with said at least one criterion.

40. The method of example 1 or 2, further comprising:
repeating said method with at least one other population substituting for at least one of said first population or second population.
41. The method of example 1 or 2, further comprising:
repeating said method, setting a different minimum difference for statistical significance than was set in a previous execution of said method.
42. The method of example 38, 40 or 41, wherein said repeating occurs if it was previously determined that there was a statistically significant difference.
43. The method of example 1 or 2, further comprising: repeating said method for at least one other set of one or more manufacturing conditions each, wherein none of said at least one other set includes exactly identical one or more manufacturing conditions as said set nor as any other of said at least one other set.
44. The method of example 43, further comprising: reporting a ranked list of statistically significant correlations between various sets of manufacturing conditions and in-field performance.
45. The method of example 1 or 2, wherein a metric of said in-field performance is a drift metric, and an end-user device with an excessive drift from a baseline is characterized as poorly performing.
46. The method of any of examples 1 to 3, further comprising:

receiving out of service data for end-user devices that include said elements; and

using received out of service data when performing any of said analyzing, correlating or determining.

47. The method of example 46, further comprising: for each of one or more of end-user devices, linking received out-of-service data from the end-user device with received data relating to manufacturing of elements included in the end-user device.
48. The method of example 46, wherein said out of service data includes at least one of maintenance data, repair data, or return data.
49. The method of example 1 or 2, wherein said one or more manufacturing conditions includes at least one of: plant, manufacturing testing equipment, manufacturing fabrication equipment, time of manufacture, batch data, type of element, manufacturing operational specifications, processing flow and conditions, monitor data, manufacturing fabrication process revision, manufacturing equipment maintenance history, classification and disposition data, configuration data, construction data, design revision, software revision, manufacturing test or fabrication parametric data characteristics, manufacturing event history, operations personnel, other fabrication data, test data, physical placement data within substrates packages or wafer, manufacturing temperature, or any other manufacturing condition.
50. The method of claim 49, wherein said one or more manufacturing conditions includes scrap disposition, indicative of elements targeted for scrapping during manufacturing.
51. The method of example 1 or 2, wherein said set includes at least one improper manufacturing condition.
52. The method of example 1 or 2, wherein said set includes at least one manufacturing condition which is different than a nominal manufacturing condition.
53. The method of example 1, wherein for each of said first and second populations, elements included in devices of said population are grouped into two or more groups of elements, and wherein said set is a combination of at least two subsets of one or more manufacturing conditions each, and wherein for each of said first and second populations, said association comprises a combination of associations between each one of said subsets and received data, or data computed based on received data, relating to manufacturing of at least one of said groups.
54. The method of example 2, wherein for each of said first and second populations, elements included in said population are grouped into two or more groups of elements, and wherein said set is a combination of at least two subsets of one or more manufacturing conditions each, and wherein each one of the subsets corresponds to manufacturing of at least one of said groups included in said first population, but at least one of the subsets does not correspond to manufacturing of any group included in said second population.
55. The method of example 53 or 54, wherein for each subset, said one or more conditions in said subset includes at least one of: plant, manufacturing testing equipment, manufacturing fabrication equipment, time of manufacture, batch data, type of element, manufacturing operational specifications, processing flow and conditions, monitor data, manufacturing fabrication process revision, manufacturing equipment maintenance history, classification and disposition data, configuration data, construction data, design revision, software revision, manufacturing test or fabrication parametric data characteristics, manufacturing event history, operations personnel, other fabrication data, test data, physical placement data within substrates packages or wafer, manufacturing temperature, or any other manufacturing condition.
56. The method of example 53 or 54, wherein for at least one of said groups, at least some of the elements included in said group have similar usage in end-user devices.
57. The method of any of examples 1 to 3, wherein said devices include a plurality of device types.
58. The method of any of examples 1 to 3, wherein said devices are manufactured by a plurality of manufacturers.
59. The method of any of examples 1 to 3, wherein said devices include a single device type.
60. The method of any of examples 1 to 3, wherein said devices include a single manufacturer.
61. The method of example 1 or 2, wherein said concluding includes concluding that there is a correlation between said set and poor in-field performance, the method further comprising: outputting a determination of at least one action selected from a group comprising: to remove from use elements manufactured under one or more conditions corresponding to said set, or to remove from use or reconfigure end-user devices that include elements manufactured under one or more conditions corresponding to said set.
62. The method of example 1 or 2, wherein said concluding includes concluding that there is a correlation between said set and poor in-field performance, said method further comprising:
outputting a determination of at least one action to potentially improve in-field performance, based on said concluding, said at least one action including at least one selected from a group comprising: to avoid at least one manufacturing condition included in said set, or to avoid combining groups of elements where a combination of manufacturing conditions of the groups results in said set.
63. The method of example 3, wherein said concluding includes concluding that said data are inconsistent, the method further comprising:

outputting a determination of at least one action including at least one selected from a group comprising: to remove from use elements associated with the relationship, to remove from use or reconfigure end-user devices associated with the relationship, or to improve manufacturing so that there will not be a statistically significant difference between a subsequently determined relationship and said reference relationship.

64. The method of example 3, further comprising: determining a new reference relationship in response to there being a statistically significant difference.
65. The method of example 1, wherein at least some of the elements included in the devices of said first population and at least some of the elements included in the devices of said second population have similar usage in the devices.
66. The method of example 2, wherein at least some of the elements included in said first population and at least some of the elements included in said second population have similar usage in end-user devices.
67. The method of example 3, wherein said elements are grouped into two or more groups of elements, and wherein said correlating includes correlating in-field data with a combination of manufacturing data for said groups, in order to determine a relationship.
68. The method of any of examples 1 to 3, further comprising at least one selected from a group comprising: feeding back to at least one manufacturing environment of at least an element or a device a change to improve manufacturing, feeding back to at least one of device manufacturer or device end-users a change to device configuration of in-field devices to improve device performance, feeding back to at least one of element manufacturer or device manufacturer a change to at least one of amount or type of data being received from at least one of manufacturing or in-field end-user devices, generating a query to one or more in-field devices to receive at least one of additional or different data, feeding back to at least one of element manufacturer or device manufacturer a reliability assessment of at least one of elements or devices, feeding back to at least one of element manufacturer or device manufacturer identities of at least one of particular elements or devices that should be recalled from the field, feeding back to at least one of an element manufacturer or device manufacturer identities of at least one of particular elements or devices that may be suspected for being counterfeit or tampered with, performing a determination of whether or not there is a statistically significant difference for a different set of one or more manufacturing conditions than said set, performing a determination of whether or not there is a statistically significant difference periodically for at least the same devices and elements as in said determining, performing a determination of whether or not there is a statistically significant difference one or more times for different devices and elements than in said determining, performing a determination of whether or not there is a statistically significant difference for a different one or more types of device than in said determining, performing a determination of whether or not there is a statistically significant difference for a different one or more device manufacturers than in said determining, or storing at least one of results or parameters relating to said method, to be optionally retrieved and used subsequently in a subsequent performance of a determination of whether or not there is a statistically significant difference.
69. The method of any of examples 1 to 3, further comprising: receiving or creating one or more rules.
70. The method of example 69, wherein said one or more rules is received or created after a determination that said correlation is spurious.
71. The method of example 70, wherein said determination is made by an operator, or made automatically or semi-automatically.
72. The method of example 70, wherein said determination is made based on historical data.
73. The method of any of examples 69 to 72, wherein at least one of said one or more rules is triggered by at least one event selected from a group comprising: receiving additional data, loading additional received data to a database, receiving a particular type of additional data, exceeding a required minimum quantity of data for one or more particular types of data within a database, exceeding a threshold for a maximum time interval between successive rule executions, arrival of a particular time, passing of a time interval of particular duration, arrival of additional data in response to transmitted data queries, receipt of requests for rule executions provided by one or more clients, or any other event.
74. The method of example 1 or 3, further comprising: receiving an indication that said correlation is spurious.
75. The method of any of examples 1 to 3, further comprising:

receiving adjunct data; and

using said adjunct data when performing any of said analyzing, correlating or determining.

76. The method of any of examples 1 to 3, wherein said receiving includes at least one of collecting or aggregating.
77. The method of example 76, wherein said receiving data relating to manufacturing of electronic elements, includes at least one of collecting or aggregating said data relating to manufacturing of electronic elements.
78. The method of example 76, wherein said receiving in-field data includes aggregating said in-field data.
79. The method of any of examples 1 to 3, wherein at least one of: said data relating to manufacturing of electronic elements or said in-field data are received automatically.
80. The method of any of examples 1 to 3, wherein said in-field data are received from said end-user devices.
The subject matter is not bound by any of these numbered method examples.

In some embodiments, system 200 may be configured to perform any of the numbered method examples listed above. For instance, the processor(s) included in the server(s) of box 6, may be configured to perform any of the numbered method examples, with the optional assistance of other boxes in system 200, such as boxes 1-2, (e.g., numbered method example 30, 76, 77), boxes 11x-11y (e.g. numbered method examples 14, 15, 34, 35, 36, 39, 71), boxes 18a, 18b (e.g., numbered method examples 17, 18, 20), etc.

It will be understood that the subject matter contemplates, for example, a computer program being readable by a computer for executing any method or any part of any method disclosed herein, such as any of the method examples listed above. Further contemplated by the subject matter, for example, is a computer-readable medium tangibly embodying program code readable by a computer for executing any method or any part of any method disclosed herein. See above regarding construction of the term computer.

While examples of the subject matter have been shown and described, the subject matter is not thus limited. Numerous modifications, changes and improvements within the scope of the subject matter will now occur to the reader.

1. A system for concluding whether or not there is a correlation between a set of one or more manufacturing conditions and performance of in-field end-user devices, the system comprising at least one processor configured to:
receive data relating to manufacturing of electronic elements;
receive in-field data for end-user devices that include said elements;
analyze at least one of received data, or data computed based on received data, relating to manufacturing of electronic elements, in order to identify at least two populations among said elements, wherein manufacturing of a first population of said at least two populations corresponds to a set of one or more manufacturing conditions, but manufacturing of a second population of said at least two populations does not correspond to said set;
analyze at least one of received in-field data, or data computed based on received in-field data, in order to determine whether or not there is a statistically significant difference in in-field performance between end-user devices including elements from said first population and end-user devices including elements from said second population; and
conclude that there is a correlation between said set and said in-field performance when it is determined that there is a statistically significant difference, or concluding that there is not a correlation between said set and said in-field performance when it is determined that there is not a statistically significant difference.

2. The system of claim 1, wherein said in-field performance includes in-field reliability.

3. The system of claim 1, wherein at least one of said populations includes elements whose analyzed data relating to manufacturing are similarly abnormal.

4. The system of claim 1, wherein said received data relating to manufacturing of electronic elements include at least data relating to manufacturing of electronic components.

5. The system of claim 1, wherein said received data relating to manufacturing of electronic elements include at least data relating to manufacturing of electronic modules.

6. The system of claim 1, wherein said at least one processor is further configured to: determine said set.

7. The system of claim 6, further comprising: a client configured to provide at least one criterion, inputted by an operator, for determining said set.

8. The system of claim 1, wherein said at least one processor is further configured to generate a report.

9. The system of claim 1, wherein said at least one processor is further configured to generate and transmit a query for data for said in-field end-user devices.

10. The system of claim 9, further comprising: an aggregator configured to aggregate queries from said at least one processor.

11. The system of claim 1, further comprising:
at least one collector configured to collect data relating to manufacturing of one or more of said elements at least from manufacturing equipment of one or more element manufacturers or at least from one or more manufacturing execution databases of said one or more element manufacturers or at least from one or more factory information systems of said one or more element manufacturers.

12. The system of claim 1, further comprising: a client that is used by an operator affiliated with a manufacturer of elements, configured to:
provide a request for in-field data; and
obtain in response, received in-field data for end-user devices that include elements manufactured by said manufacturer, but not obtain received in-field data for end-user devices that do not include elements manufactured by said manufacturer.

13. The system of claim 1, further comprising: a client that is used by an operator affiliated with a manufacturer of end-user devices, configured to:
provide a request for data relating to element manufacturing; and
obtain in response received data relating to manufacturing of elements included in end-user devices manufactured by said manufacturer but not obtain received data relating to manufacturing of elements not included in end-user devices manufactured by said manufacturer.

14. The system of claim 1, wherein a metric of said in-field performance is a drift metric.

15. The system of claim 1, further comprising a client configured to:
provide at least one criterion for any of said analyzing, inputted by an operator, thereby enabling said at least one processor to analyze at least partly in accordance with said at least one criterion.

16. The system of claim 1, wherein said set includes at least one manufacturing condition which is different than a nominal manufacturing condition.

17. The system of claim 1, wherein for each of said first and second populations, elements included in said population are grouped into two or more groups of elements, and wherein said set is a combination of at least two subsets of one or more manufacturing conditions each, and wherein each one of the subsets corresponds to manufacturing of at least one of said groups included in said first population, but at least one of the subsets does not correspond to manufacturing of any group included in said second population.

18. The system of claim 1, wherein at least some of the elements included in said first population and at least some of the elements included in said second population have similar usage in end-user devices.

19. The system of claim 1, wherein said at least one processor is further configured to: receive or create one or more rules.

20. The system of claim 1, further comprising: a client configured to receive from an operator input indicative that said correlation is determined to be spurious and to provide indication that said correlation is determined to be spurious to said at least one processor.

21. A system for enabling a conclusion of whether or not there is a correlation between a set of one or more manufacturing conditions and performance of in-field end-user devices, the system comprising at least one processor configured to:
receive from one or more operators at least one criterion including at least one analysis specification relating to a set of one or more manufacturing conditions; and
provide said at least one criterion to at least one other processor, thereby enabling said at least one other processor to:
analyze at least one of received data, or data computed based on received data, relating to manufacturing of electronic elements, in order to identify at least two populations among said elements, wherein manufacturing of a first population of said at least two populations corresponds to said set, but manufacturing of a second population of said at least two populations does not correspond to said set,
analyze at least one of received in-field data for end-user devices that include said elements, or data computed based on received in-field data, in order to determine whether or not there is a statistically significant difference in in-field performance between end-user devices including elements from said first population and end-user devices including elements from said second population, and
conclude that there is a correlation between said set and said in-field performance when it is determined that there is a statistically significant difference, or conclude that there is not a correlation between said set and said in-field performance when it is determined that there is not a statistically significant difference.

22. The system of claim 21, wherein said at least one criterion includes at least one other analysis specification.

23. The system of claim 21, wherein said at least one processor is further configured to receive from said one or more operators input indicative that said correlation is determined to be spurious and to provide indication that said correlation is determined to be spurious to said at least one other processor.

24. The system of claim 21, wherein at least one of said one or more operators is affiliated with a manufacturer of elements, and one or more of said at least one processor which is used by said at least one operator is further configured to:
provide a request for in-field data; and
obtain in response, in-field data received from end-user devices that include elements manufactured by said manufacturer, but not obtain in-field data received from end-user devices that do not include elements manufactured by said manufacturer.

25. The system of claim 21, wherein at least one of said one or more operators is affiliated with a manufacturer of end-user devices, and one or more of said at least one processor which is used by said at least one operator is further configured to:
provide a request for data relating to element manufacturing; and
obtain in response received data relating to manufacturing of elements included in end-user devices manufactured by said manufacturer but not obtain received data relating to manufacturing of elements not included in end-user devices manufactured by said manufacturer.

26. A system for enabling a conclusion of whether or not there is a correlation between a set of one or more manufacturing conditions and performance of in-field end-user devices, the system comprising at least one processor configured to:
collect data relating to manufacturing of electronic elements at least from manufacturing equipment of one or more element manufacturers or at least from one or more manufacturing execution databases of said one or more element manufacturers or at least from one or more factory information systems of said one or more element manufacturers; and
provide said data relating to manufacturing of electronic elements to at least one other processor, thereby enabling said at least one other processor to:
analyze at least one of provided data, or data computed based on provided data, relating to manufacturing of said electronic elements, in order to identify at least two populations among said elements, wherein manufacturing of a first population of said at least two populations corresponds to a set of one or more manufacturing conditions, but manufacturing of a second population of said at least two populations does not correspond to said set,
analyze at least one of received in-field data received for end-user devices that include said elements, or data computed based on received in-field data, in order to determine whether or not there is a statistically significant difference in in-field performance between end-user devices including elements from said first population and end-user devices including elements from said second population, and
conclude that there is a correlation between said set and said in-field performance when it is determined that there is a statistically significant difference, or conclude that there is not a correlation between said set and said in-field performance when it is determined that there is not a statistically significant difference.

27. The system of claim 26, wherein said at least one processor is further configured to aggregate said data relating to manufacturing prior to providing said data relating to manufacturing to said at least one other processor.

28. A method of concluding whether or not there is a correlation between a set of one or more manufacturing conditions and performance of in-field end-user devices, comprising:
receiving data relating to manufacturing of electronic elements;
receiving in-field data from for end-user devices that include said elements;
analyzing at least one of received data, or data computed based on received data, relating to manufacturing of electronic elements, in order to identify at least two populations among said elements, wherein manufacturing of a first population of said at least two populations corresponds to a set of one or more manufacturing conditions, but manufacturing of a second population of said at least two populations does not correspond to said set;
analyzing at least one of received in-field data, or data computed based on received in-field data, in order to determine whether or not there is a statistically significant difference in in-field performance between end-user devices including elements from said first population and end-user devices including elements from said second population; and
concluding that there is a correlation between said set and said in-field performance when it is determined that there is a statistically significant difference, or concluding that there is not a correlation between said set and said in-field performance when it is determined that there is not a statistically significant difference.

29. The method of claim 28, further comprising:
receiving identifier data along with at least one of received manufacturing data or received in-field data;
if said received identifier data need to be prepared for storage, preparing said received identifier data for storage; and
storing said at least one of received manufacturing data or in-field data, indexed to at least one of said received or prepared identifier data.

30. The method of claim 28, further comprising:
receiving identifier data, including at least one identifier of an end-user device in association with at least one identifier of at least one element that is included in the end-user device, or including at least one identifier of a first element in association with at least one identifier of at least one other element included in the first element;
if said received identifier data need to be prepared for storage, preparing said received identifier data for storage; and
storing at least associations between identifier data.

31. The method of claim 28, further comprising:
receiving data relating to manufacturing of the end-user devices; and
linking received in-field data to received end-user device manufacturing data.

32. The method of claim 28, further comprising:
for each of one or more of said end-user devices, linking received in-field data for the end-user device with received data relating to manufacturing of elements included in the end-user device.

33. The method of claim 32, wherein at least one of said analyzing uses linked data, or wherein at least one of said analyzing is performed prior to said linking.

34. The method of claim 28, further comprising:
for at least one element which includes at least one other element, linking received data relating to manufacturing of the element with received data relating to manufacturing of the at least one other element.

35. The method of claim 28, further comprising:
repeating for in-field data received over time for the same in-field end-user devices, and determining whether or not a determination of whether or not there is a statistically significant difference continues to hold.

36. The method of claim 28, further comprising:
repeating, with at least one other population substituting for at least one of said first population or second population.

37. The method of claim 28, further comprising:
repeating for at least one other set of one or more manufacturing conditions each, wherein none of said at least one other set includes exactly identical one or more manufacturing conditions as said set nor as any other of said at least one other set.

38. The method of claim 28, further comprising:
receiving out of service data for end-user devices that include said elements; and
using received out of service data when performing any of said analyzing.

39. The method of claim 28, further comprising:
receiving adjunct data; and
using said adjunct data when performing any of said analyzing.

40. The method of claim 28, wherein said receiving includes at least one of collecting or aggregating.

41. The method of claim 28, further comprising: receiving at least one analysis specification relating to said set, inputted by an operator.

42. A method of enabling a conclusion of whether or not there is a correlation between a set of one or more manufacturing conditions and performance of in-field end-user devices, comprising:
receiving from one or more operators at least one criterion including at least one analysis specification relating to a set of one or more manufacturing conditions; and
providing said at least one criterion, thereby enabling:
analyzing at least one of received data, or data computed based on received data, relating to manufacturing of electronic elements, in order to identify at least two populations among said elements, wherein manufacturing of a first population of said at least two populations corresponds to said set, but manufacturing of a second population of said at least two populations does not correspond to said set,
analyzing at least one of received in-field data for end-user devices that include said elements, or data computed based on received in-field data, in order to determine whether or not there is a statistically significant difference in in-field performance between end-user devices including elements from said first population and end-user devices including elements from said second population, and
concluding that there is a correlation between said set and said in-field performance when it is determined that there is a statistically significant difference, or conclude that there is not a correlation between said set and said in-field performance when it is determined that there is not a statistically significant difference.

43. A method of enabling a conclusion of whether or not there is a correlation between a set of one or more manufacturing conditions and performance of in-field end-user devices, comprising:
collecting data relating to manufacturing of electronic elements at least from manufacturing equipment of one or more element manufacturers or at least from one or more manufacturing execution databases of said one or more element manufacturers, or at least from one or more factory information systems of said one or more element manufacturers; and
providing said data relating to manufacturing of electronic elements, thereby enabling:
analyzing at least one of provided data, or data computed based on provided data, relating to manufacturing of said electronic elements, in order to identify at least two populations among said elements, wherein manufacturing of a first population of said at least two populations corresponds to a set of one or more manufacturing conditions, but manufacturing of a second population of said at least two populations does not correspond to said set,
analyzing at least one of received in-field data received for end-user devices that include said elements, or data computed based on received in-field data, in order to determine whether or not there is a statistically significant difference in in-field performance between end-user devices including elements from said first population and end-user devices including elements from said second population, and
concluding that there is a correlation between said set and said in-field performance when it is determined that there is a statistically significant difference, or conclude that there is not a correlation between said set and said in-field performance when it is determined that there is not a statistically significant difference.

44. A computer program product comprising a computer useable medium having computer readable program code embodied therein for concluding whether or not there is a correlation between a set of one or more manufacturing conditions and performance of in-field end-user devices, the computer program product comprising:
computer readable program code for causing a computer to receive data relating to manufacturing of electronic elements;
computer readable program code for causing the computer to receive in-field data from for end-user devices that include said elements;
computer readable program code for causing the computer to analyze at least one of received data, or data computed based on received data, relating to manufacturing of electronic elements, in order to identify at least two populations among said elements, wherein manufacturing of a first population of said at least two populations corresponds to a set of one or more manufacturing conditions, but manufacturing of a second population of said at least two populations does not correspond to said set;
computer readable program code for causing a computer to analyze at least one of received in-field data, or data computed based on received in-field data, in order to determine whether or not there is a statistically significant difference in in-field performance between end-user devices including elements from said first population and end-user devices including elements from said second population; and
computer readable program code for causing the computer to conclude that there is a correlation between said set and said in-field performance when it is determined that there is a statistically significant difference, or concluding that there is not a correlation between said set and said in-field performance when it is determined that there is not a statistically significant difference.

45. A computer program product comprising a computer useable medium having computer readable program code embodied therein for enabling a conclusion of whether or not there is a correlation between a set of one or more manufacturing conditions and performance of in-field end-user devices, the computer program product comprising:
computer readable program code for causing a computer to receive from one or more operators at least one criterion including at least one analysis specification relating to a set of one or more manufacturing conditions; and
computer readable program code for causing the computer to provide said at least one criterion, thereby enabling:
analyzing at least one of received data, or data computed based on received data, relating to manufacturing of electronic elements, in order to identify at least two populations among said elements, wherein manufacturing of a first population of said at least two populations corresponds to said set, but manufacturing of a second population of said at least two populations does not correspond to said set,
analyzing at least one of received in-field data for end-user devices that include said elements, or data computed based on received in-field data, in order to determine whether or not there is a statistically significant difference in in-field performance between end-user devices including elements from said first population and end-user devices including elements from said second population, and
concluding that there is a correlation between said set and said in-field performance when it is determined that there is a statistically significant difference, or conclude that there is not a correlation between said set and said in-field performance when it is determined that there is not a statistically significant difference.

46. A computer program product comprising a computer useable medium having computer readable program code embodied therein of enabling a conclusion of whether or not there is a correlation between a set of one or more manufacturing conditions and performance of in-field end-user devices, the computer program product comprising:
computer readable program code for causing a computer to collect data relating to manufacturing of electronic elements at least from manufacturing equipment of one or more element manufacturers or at least from one or more manufacturing execution databases of said one or more element manufacturers, or at least from one or more factory information systems of said one or more element manufacturers; and
computer readable program code for causing the computer to provide said data relating to manufacturing of electronic elements, thereby enabling:
analyzing at least one of provided data, or data computed based on provided data, relating to manufacturing of said electronic elements, in order to identify at least two populations among said elements, wherein manufacturing of a first population of said at least two populations corresponds to a set of one or more manufacturing conditions, but manufacturing of a second population of said at least two populations does not correspond to said set,
analyzing at least one of received in-field data received for end-user devices that include said elements, or data computed based on received in-field data, in order to determine whether or not there is a statistically significant difference in in-field performance between end-user devices including elements from said first population and end-user devices including elements from said second population, and
concluding that there is a correlation between said set and said in-field performance when it is determined that there is a statistically significant difference, or conclude that there is not a correlation between said set and said in-field performance when it is determined that there is not a statistically significant difference.
